(19) United States
(12) Patent Application Publication
(10) Pub. No.: US 2026/0016582 A1
(43) Pub. Date: Jan. 15, 2026

(54) CALIBRATION EXECUTION DEVICE, CALIBRATION SYSTEM, METHOD, AND PROGRAM

(71) Applicant: SONY GROUP CORPORATION, TOKYO (JP)

(72) Inventor: YOSHIAKI SATO, TOKYO (JP)

(21) Appl. No.: 18/881,917

(22) PCT Filed: Jun. 21, 2023
(86) PCT No.: PCT/JP2023/022872

§ 371 Date: Jan. 7, 2025

(30) Foreign Application Priority Data
Jul. 8, 2022 (JP) 2022-110233

(51) Int. Cl. G01S 7/497; G01S 7/51; G01S 17/931; G06T 7/80

(52) U.S. Cl. CPC G01S 7/4972; G01S 7/51; G01S 17/931; G06T 7/80; G06T 2207/10028; G06T 2207/20048; G06T 2207/30252

(57) ABSTRACT

An image capable of visually confirming whether or not a coordinate transformation matrix calculated in sensor calibration is correct is generated and displayed. A calibration execution unit that executes calibration of a sensor, and a display information generation unit that generates image data capable of confirming whether or not calibration processing in the calibration execution unit has succeeded are included. The calibration execution unit calculates a coordinate transformation for transforming a sensor coordinate system corresponding to the sensor into another second coordinate system, and the display information generation unit generates and displays image data capable of visually confirming whether or not the calculated coordinate transformation matrix is a correct coordinate transformation matrix, for example, image data in which an origin and coordinate axes constituting the sensor coordinate system are displayed in a superimposed manner on a three-dimensional image of the sensor.

### TECHNICAL FIELD

The present disclosure relates to a calibration execution device, a calibration system, a method, and a program. More specifically, the present invention relates to a calibration execution device, a calibration system, a method, and a program for performing calibration processing of a sensor such as a camera mounted on a mobile device such as a robot and evaluation processing of a calibration result.

### BACKGROUND ART

In a case where a mobile device such as a robot or an automated driving vehicle autonomously travels, it is necessary to grasp a surrounding situation such as a position of a surrounding obstacle.

In order for a mobile device to autonomously travel safely to a destination without hitting an obstacle, it is necessary to accurately grasp the position and direction of the obstacle, and for this processing, a sensor such as a camera is mounted to a mobile device such as a robot or an automated driving vehicle.

Many mobile devices such as robots are equipped with a plurality of sensors and integrate and process measurement data from the plurality of sensors to achieve highly accurate analysis of the surrounding environment.

Examples of the sensor mounted on the mobile device include, in addition to a camera, a depth camera capable of capturing a distance image in which a distance is stored in each pixel, Light Detection and Ranging (LiDAR) which is a sensor for measuring a distance to an obstacle by laser light, and the like.

Each of these sensors individually measures a distance and a direction to a surrounding environment, for example, an obstacle. The position and direction of the obstacle are measured using a coordinate system unique to each sensor.

That is, the camera obtains the coordinate position of the obstacle using, for example, a camera coordinate system with the lens position of the camera as the origin.

In addition, the LiDAR obtains the coordinate position of the obstacle using, for example, a LiDAR coordinate system with the laser light output position in the LiDAR as the origin.

Furthermore, the robot itself also has its own robot coordinate system.

As the robot coordinate system, for example, a coordinate system or the like with the center position or the like of the robot as the origin is used. In order for the robot to travel safely, it is necessary to accurately calculate the obstacle position on the robot coordinate system.

For example, it is necessary to perform coordinate transformation processing of transforming the position (depth camera coordinate position (x_{D}, y_{D}, z_{D})) of an obstacle P in the depth camera coordinate system (Ep) calculated using the captured image of the depth camera, the position (LiDAR coordinate position (x_{L}, y_{L}, z_{L})) of the obstacle P in the LiDAR coordinate system (Σ_{L}) calculated by LiDAR, and the like into the position (robot coordinate position (x_{R}, y_{R}, z_{R})) of the obstacle P in the robot coordinate system (Σ_{R}).

Note that, in the present specification, (Σ) is used as a symbol indicating the coordinate system. (Σ_{A}) means a coordinate system of a device A.

In the coordinate transformation processing, a coordinate transformation matrix (T) is used.

For example, a coordinate transformation matrix ^{R}T_{C} is used in coordinate transformation processing of transforming a coordinate position (x_{C}, y_{C}, z_{C}) of a certain point P in the space in the camera coordinate system (Σ_{C}) into a coordinate position (x_{R}, y_{R}, z_{R}) of the robot coordinate system (Σ_{R}).

Similarly, a coordinate transformation matrix ^{L}T_{C} is used for the coordinate transformation processing of transforming the coordinate position (x_{L}, y_{L}, z_{L}) of the point P in the LiDAR coordinate system (Σ_{L}) into the coordinate position (x_{R}, y_{R}, z_{R}) of the robot coordinate system (Σ_{R}).

Note that a coordinate transformation matrix ^{A}T_{B} is a matrix applied to processing of transforming ^{B}P=(x_{B}, y_{B}, z_{B}), which is the position coordinates of the point P on the coordinate system (Σ_{B}), into ^{A}P=(x_{A}, y_{A}, z_{A}), which is the position coordinates of the point P on the coordinate system (Σ_{A}).

Here, ^{A}P represents position coordinates (x_{A}, y_{A}, z_{A}) of the point P in the coordinate system A, and BP represents position coordinates (x_{B}, y_{B}, z_{B}) of the point P in the coordinate system B.

However, for example, in the case of manufacturing a large number of robots, there are machining accuracy of components of each manufacturing robot, assembly accuracy at the time of assembly, individual differences unique to sensors, and the like. Therefore, it is necessary to calculate a coordinate transformation matrix unique to each robot for the coordinate transformation matrix corresponding to each sensor.

That is, it is necessary to determine a unique coordinate transformation matrix for each robot in units of sensors mounted to the robot.

By calculating such a unique coordinate transformation matrix corresponding to the combination of the robot and the sensor, it is possible to perform highly accurate surrounding situation analysis based on sensor detection information, for example, analysis of the distance and direction from the robot to the obstacle.

The processing of calculating the unique coordinate transformation matrix corresponding to the combination of the robot and the sensor is performed as so-called calibration processing of a sensor.

Note that the sensor calibration processing includes various types of processing executed as calibration processing and adjustment processing of sensor detection data. For example, processing such as adjustment of the attaching position and angle of the sensor and adjustment of the sensor-corresponding parameter is also the calibration processing.

As calibration of a camera, processing performed using a captured image of a chessboard including a black-and-white pattern is known. This processing is described, for example, in Non-Patent Document 1 (Zhang Zhengyou. A flexible new technique for camera calibration. IEEE Transactions on pattern analysis and machine intelligence 22.11,2000.) as a method of zhang.

As described above, the processing of calculating the unique coordinate transformation matrix corresponding to the combination of the robot and the sensor is also performed as one of the calibration processing of the sensor.

In a case where calculation processing of a coordinate transformation matrix for transforming a camera coordinate system into the robot coordinate system is performed, it is necessary to perform calibration success/failure determination for confirming whether or not calibration has succeeded, that is, whether or not a correct coordinate transformation matrix has been calculated.

However, many of the conventional success/failure determination processing of a coordinate transformation matrix are executed as, for example, processing of calculating numerical data indicating an error of coordinates obtained by applying the coordinate transformation matrix and comparing the calculated numerical value with a prescribed threshold value.

In processing using numerical data indicating such an error, success or failure of calibration is determined depending on the setting of the threshold, and erroneous determination due to erroneous threshold setting may occur. In addition, there is a problem that it is difficult to derive a factor causing an error and an improvement measure for eliminating the error.

### CITATION LIST

### Non-Patent Document

Non-Patent Document 1: Zhang Zhengyou. A flexible new technique for camera calibration. IEEE Transactions on pattern analysis and machine intelligence 22.11,2000.
Non-Patent Document 2: Dhall et al. Ankit, LiDAR-camera calibration using 3D-3D point correspondences. arXiv preprint arXiv: 1705.09785, 2017.
Non-Patent Document 3: Banerjee et al. Koyel, Online camera lidar fusion and object detection on hybrid data for autonomous driving. 2018 IEEE Intelligent Vehicles Symposium (IV). IEEE, 2018.
Non-Patent Document 4: PusztaiIvn Eichhardt, and Levente Hajder. Zoltn, Accurate calibration of multi-lidar-multi-camera systems. Proceedings of the IEEE International Conference on Computer Vision Workshops., 2017.
Non-Patent Document 5: Irene Fassi Legnani Giovanni. Hand to sensor calibration: A geometrical interpretation of the matrix equation AX=XB. Journal of Robotic Systems, 2005.
Non-Patent Document 6: Legnani Giovanni. Optimization of hand-to-camera calibration using geometrical interpretation of matrix equation AX=XB. International Journal of Robotics and Automation, 2018.
Non-Patent Document 7: KamRyeol, et al. Hyeong. Rviz: a toolkit for real domain data visualization. Telecommunication Systems 60.2, 2015.
Non-Patent Document 8: Trevor J B, et al. Alexander. Efficient organized point cloud segmentation with connected components. Semantic Perception Mapping and Exploration (SPME), 2012

### SUMMARY OF THE INVENTION

### Problems to be Solved by the Invention

The present disclosure has been made in view of the above problems, for example, and an object of the present disclosure is to provide a calibration execution device, a calibration system, a method, and a program capable of visually determining whether or not calibration has succeeded by generating visualized data enabling determination as to whether or not a correct coordinate transformation matrix has been calculated and displaying the visualized data on a display unit in calculation processing of a coordinate transformation matrix executed as calibration processing of a sensor such as a camera mounted on a mobile device such as a robot or an automated driving vehicle, and capable of easily grasping an error occurrence level.

### Solutions to Problems

A first aspect of the present disclosure is a calibration execution device including:
a calibration execution unit that executes calibration processing of a sensor; and
a display information generation unit that generates image data capable of confirming whether or not the calibration processing in the calibration execution unit has succeeded, in which
the calibration execution unit executes, as the calibration processing, processing of calculating a coordinate transformation matrix for transforming a sensor coordinate system corresponding to a sensor into another second coordinate system, and
the display information generation unit generates image data capable of visually confirming whether or not the coordinate transformation matrix calculated by the calibration execution unit is a correct coordinate transformation matrix.

Furthermore, a second aspect of the present disclosure is a calibration system including: a mobile device equipped with a sensor; and a calibration execution device, in which
the calibration execution device inputs sensor detection information from the mobile device, calculates a coordinate transformation matrix for transforming a sensor coordinate system corresponding to a sensor into another second coordinate system, and outputs the calculated coordinate transformation matrix to the mobile device,
the mobile device executes autonomous movement to which the coordinate transformation matrix input from the calibration execution device is applied, and
the calibration execution device further includes a display information generation unit that generates image data capable of confirming whether or not the coordinate transformation matrix has been correctly calculated.

Furthermore, a third aspect of the present disclosure is a calibration execution method executed by a calibration execution device, the calibration execution method including: a calibration execution step of calculating, by a calibration execution unit, a coordinate transformation matrix that inputs detection information of a sensor and transforms a sensor coordinate system corresponding to the sensor into another second coordinate system; and an image data generation step of generating, by a display information generation unit, image data that enables visual confirmation as to whether or not the coordinate transformation matrix calculated in the calibration execution step is a correct coordinate transformation matrix.

Furthermore, a fourth aspect of the present disclosure is a calibration execution method executed in a calibration system including a mobile device equipped with a sensor and a calibration execution device, in which
the calibration execution device executes a coordinate transformation matrix generation step of inputting sensor detection information from the mobile device, calculating a coordinate transformation matrix for transforming a sensor coordinate system corresponding to the sensor into another second coordinate system, and outputting the calculated coordinate transformation matrix to the mobile device,
the mobile device executes an autonomous movement execution step of executing autonomous movement to which the coordinate transformation matrix input from the calibration execution device is applied, and
the calibration execution device further executes a display information generation step of generating image data capable of confirming whether or not the coordinate transformation matrix has been correctly calculated in the coordinate transformation matrix generation step.

Furthermore, a fifth aspect of the present disclosure is a program for causing a calibration execution device to execute calibration, the program causing:
a calibration execution unit to execute calibration processing for inputting detection information of a sensor and calculating a coordinate transformation matrix for transforming a sensor coordinate system corresponding to the sensor into another second coordinate system; and
a display information generation unit to generate image data capable of visually confirming whether or not the coordinate transformation matrix is a correct coordinate transformation matrix.

Note that the program of the present disclosure is, for example, a program that can be provided by a storage medium or a communication medium that provides a variety of program codes in a computer-readable format, to an information processing device or a computer system that can execute the program codes. By providing such a program in a computer-readable format, processing according to the program is performed in an information processing device or a computer system.

Other objects, features, and advantages of the present disclosure will become apparent from a more detailed description based on embodiments of the present disclosure described later and the accompanying drawings. Note that, in the present specification, a system is a logical set configuration of a plurality of devices, and is not limited to one in which devices of individual configurations are in the same housing.

According to a configuration of an embodiment of the present disclosure, a configuration is realized in which an image capable of visually confirming whether or not a coordinate transformation matrix calculated in sensor calibration is correct is generated and displayed.

Specifically, for example, a calibration execution unit that executes calibration of a sensor, and a display information generation unit that generates image data capable of confirming whether or not calibration processing in the calibration execution unit has succeeded are included. The calibration execution unit calculates a coordinate transformation for transforming a sensor coordinate system corresponding to the sensor into another second coordinate system, and the display information generation unit generates and displays image data capable of visually confirming whether or not the calculated coordinate transformation matrix is a correct coordinate transformation matrix, for example, image data in which an origin and coordinate axes constituting the sensor coordinate system are displayed in a superimposed manner on a three-dimensional image of the sensor.

With this configuration, the configuration is realized in which an image capable of visually confirming whether or not a coordinate transformation matrix calculated in sensor calibration is correct is generated and displayed.

Note that the effects described herein are merely examples and are not limited, and additional effects may also be provided.

### BRIEF DESCRIPTION OF DRAWINGS

FIG. 1 is a diagram for explaining a configuration example of a robot which is an example of a mobile device of the present disclosure.

FIG. 2 is a diagram for explaining a coordinate system of a sensor mounted on the robot and a robot coordinate system.

FIG. 3 is a diagram for explaining a coordinate transformation matrix for performing coordinate transformation between different coordinate systems.

FIG. 4 is a diagram for explaining a coordinate transformation matrix for performing coordinate transformation between different coordinate systems.

FIG. 5 is a diagram for explaining an example of an individual difference of a manufacturing robot.

FIG. 6 is a diagram for explaining a problem in a case where processing using a coordinate transformation matrix calculated on the basis of a designed sensor mounting position and posture is performed in a case where the sensor is attached at a position and posture different from the design.

FIG. 7 is a diagram showing a robot coordinate system (Σ_{R}), a LiDAR coordinate system (Σ_{L1}), and a LiDAR coordinate system (Σ_{L2}) of a robot a together.

FIG. 8 is a diagram for explaining a reason why calibration processing for calculating a unique coordinate transformation matrix in units of sensors mounted to one robot is required for each robot.

FIG. 9 is a diagram for explaining a configuration example of a calibration system including a calibration execution device of the present disclosure.

FIG. 10 is a diagram for explaining a configuration example of a calibration system including the calibration execution device of the present disclosure.

FIG. 11 is a diagram for explaining a sensor coordinate system which is a coordinate system of each sensor mounted to the robot, a robot coordinate system, and a scanner coordinate system.

FIG. 12 is a diagram for explaining a detailed configuration of the calibration execution device.

FIG. 13 is a diagram for explaining an example of a point cloud (^{L}P_{L}) detected by LiDAR in a case where the robot is traveling in a room having a rectangular wall.

FIG. 14 is a diagram for explaining calculation processing of a coordinate transformation matrix (^{R}T_{X}) for transforming a coordinate system of each sensor into a robot coordinate system and meanings of matrix elements of the coordinate transformation matrix (^{R}T_{X}).

FIG. 15 is a diagram showing a part of the point cloud (^{L}P_{L}) detected by LiDAR and a part of a point cloud (^{S}P_{S}) detected by a 3D scanner in a case where the robot is traveling in a room having a rectangular wall.

FIG. 16 is a diagram for explaining a specific example of processing executed by a relative position calculation unit.

FIG. 17 is a diagram showing an example of display data generated by a display information generation unit (visualized data generation unit) and output to a display unit.

FIG. 18 is a diagram showing an example of display data generated by the display information generation unit (visualized data generation unit) and output to the display unit.

FIG. 19 is a diagram for explaining an example of a display image on the display unit in a case where a viewpoint position is changed.

FIG. 20 is an explanatory diagram of a configuration example of an online calibration system including a calibration execution device of a second embodiment.

FIG. 21 is an explanatory diagram of a configuration example of the online calibration system including the calibration execution device of the second embodiment.

FIG. 22 is a diagram for explaining a sensor coordinate system which is a coordinate system of each sensor mounted to the robot, a robot coordinate system, a fixed depth camera coordinate system, a chessboard coordinate system, and a map coordinate system.

FIG. 23 is a diagram for explaining an example of a relationship between a coordinate system and a coordinate transformation matrix used in the second embodiment.

FIG. 24 is a diagram for explaining a detailed configuration of the calibration execution device of the second embodiment.

FIG. 25 is a diagram for explaining a configuration example of an online calibration system including a calibration execution device of a third embodiment.

FIG. 26 is a diagram for explaining a configuration example of the online calibration system including the calibration execution device of the third embodiment.

FIG. 27 is a diagram for explaining a sensor coordinate system which is a coordinate system of each sensor mounted to a robot B, a robot B coordinate system, and a map coordinate system.

FIG. 28 is a diagram for explaining an example of a relationship between a coordinate system and a coordinate transformation matrix used in the third embodiment.

FIG. 29 is a diagram for explaining an example of the relationship between the coordinate system and the coordinate transformation matrix used in the third embodiment.

FIG. 30 is a diagram for explaining a detailed configuration and processing of the calibration execution device of the third embodiment.

FIG. 31 is a diagram for explaining a detailed configuration and processing of the calibration execution device of the third embodiment.

FIG. 32 is a diagram for explaining calibration processing of a fourth embodiment.

FIG. 33 is a diagram for explaining a configuration example of a calibration system including the calibration execution device of the fourth embodiment.

FIG. 34 is a diagram for explaining a detailed configuration and processing of the calibration execution device of the fourth embodiment.

FIG. 35 is a diagram showing an example of display data generated by a display information generation unit (visualized data generation unit) and output to a display unit.

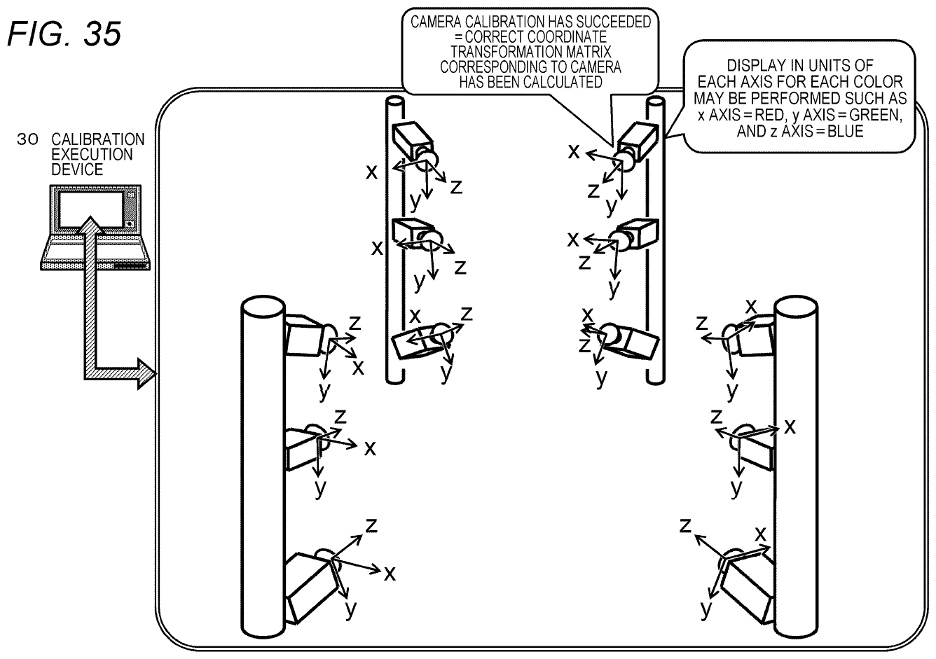

FIG. 36 is a diagram showing an example of display data generated by the display information generation unit (visualized data generation unit) and output to the display unit.

FIG. 37 is a diagram for explaining a hardware configuration example of the calibration execution device of the present disclosure.

### MODE FOR CARRYING OUT THE INVENTION

Hereinafter, details of a calibration execution device, a calibration system, a method, and a program according to the present disclosure will be described with reference to the drawings. Note that the description will be made in accordance with the following items.
1. Outline and Problems of Calibration Processing of Sensor
2. (First Embodiment) Configuration and Processing of Calibration Execution Device
3. (Second Embodiment) Configuration and Processing of Calibration Execution Device that Executes Online Calibration
4. (Third Embodiment) Configuration and Processing of Calibration Execution Device that Executes Online Calibration Using Observation Information of Another Mobile Device
5. (Fourth Embodiment) Embodiment of Executing Calibration of Plurality of Fixed Cameras
6. Hardware Configuration Example of Calibration Execution Device
7. Summary of Configurations of Present Disclosure

### 1. Outline and Problems of Calibration Processing of Sensor

First, an outline and a problem of calibration processing of a sensor will be described.

As described above, in order for a mobile device such as a robot or an automated driving vehicle to travel safely to a destination without colliding with an obstacle, it is necessary to accurately grasp the position and direction of the obstacle.

For this safe traveling, many autonomous mobile devices are equipped with a plurality of sensors, and highly accurate analysis of the surrounding environment is realized by integration processing of measurement data of the plurality of sensors.

Examples of the sensor mounted on a mobile device such as a robot or an automated driving vehicle include a camera and light detection and ranging (LiDAR) which is a sensor for measuring a distance to an obstacle by laser light.

As described above, each of the plurality of sensors individually measures a distance and a direction to a surrounding environment, for example, an obstacle. The position and direction of the obstacle are measured using a coordinate system unique to each sensor. The camera obtains the coordinate position of the obstacle using, for example, a camera coordinate system with a lens position of the camera as an origin, and the LiDAR obtains the coordinate position of the obstacle using, for example, a LiDAR coordinate system with a laser light output position in the LiDAR as an origin.

Furthermore, the robot itself also has a robot specific robot coordinate system.

As the robot coordinate system, for example, a coordinate system or the like with the center position or the like of the robot as the origin is used. Alternatively, a coordinate system or the like in which an intersection of a certain point on the robot ground contact surface, for example, a perpendicular line from the center position of the robot and the robot ground contact surface is set as an origin is used. In order for the robot to travel safely, it is necessary to accurately calculate the position information of the obstacle in the robot coordinate system.

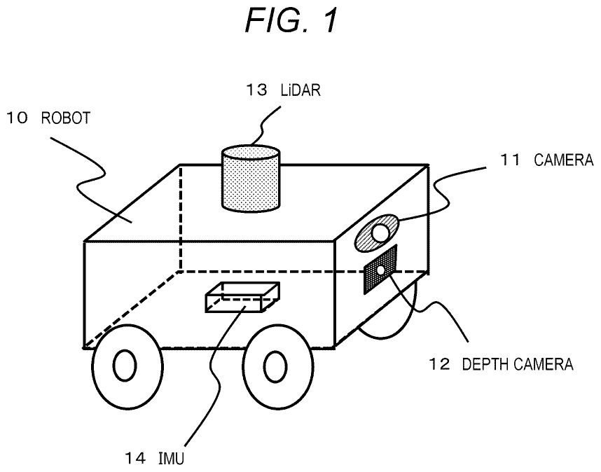

FIG. 1 shows an example of a robot 10 which is an example of a mobile device of the present disclosure.

The robot 10 shown in FIG. 1 is a robot that analyzes a surrounding environment on the basis of sensor detection information and autonomously moves.

As shown in FIG. 1, a plurality of different sensors 11 to 14 is mounted to the robot 10. That is, a camera 11, a depth camera 12, a LiDAR 13, an IMU 14, and these sensors are mounted.

Note that the depth camera 12 is a camera that detects an object distance, such as a stereo camera. The LiDAR 13 is a sensor that measures a distance to an obstacle by laser light. The IMU is an inertial measurement unit, and is a sensor that detects acceleration, angular velocity, and the like of the robot 10.

Each of these sensors 11 to 14 calculates a sensor detection value based on a coordinate system unique to the sensor, for example, a coordinate position of an obstacle on the basis of the coordinate system unique to the sensor.

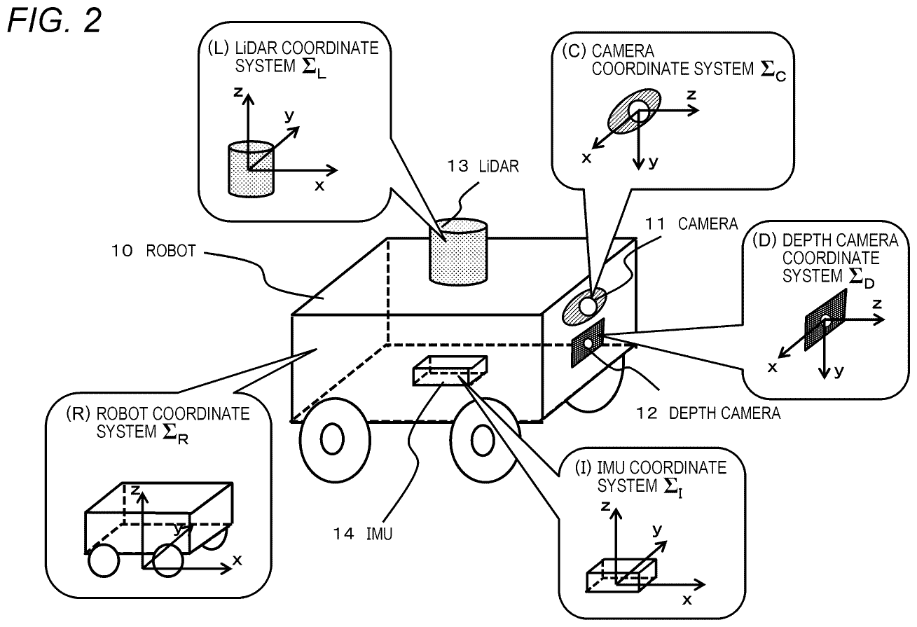

FIG. 2 shows an example of a coordinate system corresponding to each of the sensors 11 to 14 and a robot coordinate system. FIG. 2 shown the following coordinate systems.
(R) Robot coordinate system (Σ_{R})
(C) Camera coordinate system (Σ_{C})
(D) Depth camera coordinate system (Σ_{D})
(L) LiDAR coordinate system (Σ_{L})
(I) IMU coordinate system (Σ_{I})

Note that, as described above, in the present specification, (Σ) is used as a symbol indicating the coordinate system. (Σ_{A}) means a coordinate system of a device A.

(R) The robot coordinate system (Σ_{R}) is, for example, a coordinate system in which an intersection point between a perpendicular line from a center position of the robot 10 and a robot ground contact surface is set as an origin, a front side of the robot 10 is set as an X axis, a left side surface direction is set as a Y axis, and an upper direction is set as a Z axis.

(C) The camera coordinate system (Σ_{C}) is, for example, a coordinate system in which a lens position of the camera 11 is set as an origin, a front optical axis direction of the camera 11 is set as a Z axis, a lower side surface direction is set as a Y axis, and a right direction is set as an X axis.

(D) The depth camera coordinate system (Σ_{D}) is, for example, a coordinate system in which a gravity center position of the depth camera 12 is set as an origin, a front optical axis direction of the depth camera 12 is set as a Z axis, a lower side direction is a Y axis, and a right direction is set as an X axis.

(L) The LiDAR coordinate system (Σ_{L}) is, for example, a coordinate system in which a gravity center position of the LIDAR 13 is set as an origin, a front side of the LiDAR10 is set as an X axis, a left side surface direction is set as a Y axis, and an upper direction is set as a Z axis.

(I) The IMU coordinate system (Er) is, for example, a coordinate system in which a gravity center position of the IMU 14 is set as an origin, a front side of the IMU10 is set as an X axis, a left side surface direction is set as a Y axis, and an upper direction is set as a Z axis.

Note that the setting of the origin position and the coordinate axis direction of each coordinate system of the robot and the sensor shown in FIG. 2 is an example, and various settings can be made without being limited to the setting of the coordinate system shown in FIG. 2.

As described above, the robot coordinate system of the robot 10 and the coordinate system of each sensor are different from each other, and for example, the sensor such as the depth camera 12 calculates the coordinate position of the obstacle in the depth camera coordinate system (Σ_{D}) as the position of the obstacle.

The robot 10 performs control to calculate a coordinate position of the obstacle in the robot coordinate system (Σ_{R}) on the basis of the coordinate position of the obstacle in the depth camera coordinate system (Σ_{D}), acquire a distance and a direction from the robot 10 to the obstacle, and select and travel a travel route on which the robot 10 does not come into contact with the obstacle.

That is, for example, it is necessary to perform coordinate transformation processing of transforming the position (camera coordinate position (x_{D}, y_{D}, z_{D})) of the obstacle P in the camera coordinate system (Σ_{D}) calculated using the captured image of the depth camera 12 or the position (LiDAR coordinate position (x_{L}, y_{L}, z_{L})) of the obstacle P in the LiDAR coordinate system (Σ_{L}) calculated by the LiDAR 13 into the position (robot coordinate position (x_{R}, y_{R}, z_{R})) of the obstacle P in the robot coordinate system (Σ_{R}).

The coordinate transformation matrix (T) is used for the coordinate transformation processing.

For example, a coordinate transformation matrix (^{R}T_{D}) is used in a coordinate transformation processing of transforming the coordinate position (x_{D}, y_{D}, z_{D}) of a certain point P in the depth camera coordinate system (Σ_{D}) in the space into the coordinate position (x_{R}, y_{R}, z_{R}) in the robot coordinate system (Σ_{R}).

Similarly, a coordinate transformation matrix (^{L}T_{C}) is used for the coordinate transformation processing of transforming the coordinate position (x_{L}, y_{L}, z_{L}) of the point P in the LiDAR coordinate system (Σ_{L}) into the coordinate position (x_{R}, y_{R}, z_{R}) of the robot coordinate system (Σ_{R}).

Note that a coordinate transformation matrix ^{A}T_{B} is a matrix applied to processing of transforming ^{B}P=(x_{B}, y_{B}, z_{B}), which is the position coordinates of the point P on the coordinate system (Σ_{B}), into ^{A}P=(x_{A}, y_{A}, z_{A}), which is the position coordinates of the point P on the coordinate system (Σ_{A}).

Here, ^{A}P represents position coordinates (x_{A}, y_{A}, z_{A}) of the point P in the coordinate system A, and ^{B}P represents position coordinates (x_{B}, y_{B}, z_{B}) of the point P in the coordinate system B.

That is, the following relational equation is established.

$$( {}^{A} P ) = {(}^{A} {T}_{B} ) ( {}^{B} P )$$

$${( {x}_{A} , {y}_{A} , {z}_{A} , 1 )}^{T} = {(}^{A} {T}_{B} ) {( {x}_{B} , {y}_{B} , {z}_{B} , 1 )}^{T}$$

Here, T in the upper right represents transposition. As will be described later, the coordinate transformation matrix is a homogeneous transformation matrix of four rows and four columns. Therefore, in the calculation at the time of coordinate-transforming the position coordinates of the point P, a product is calculated in the form of homogeneous coordinates which is a four-dimensional column vector to which 1 is added as a fourth element.

Specifically, the coordinate transformation matrix ^{A}T_{B}, which is a homogeneous transformation matrix in a three-dimensional space, is a homogeneous transformation matrix of four rows and four columns shown in (Equation 1) below.

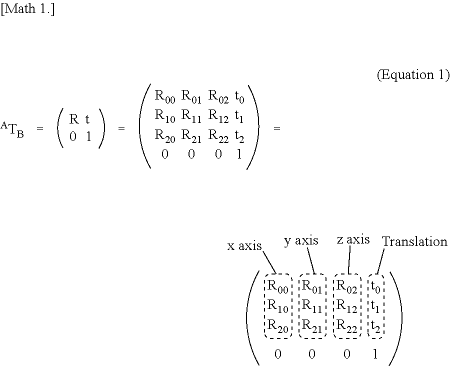

As shown in the above equation, in the matrix of four rows and four columns, the upper left three rows and three columns are a rotation matrix representing an angle, the upper right three rows and one column are a matrix representing translation, and the lower one row is a matrix including (0, 0, 0, 1).

The rotation matrix of three rows and three columns is a three-dimensional column vector in which each column represents directions of an x axis, a y axis, and a z axis from the left, and is a unit vector having a length of 1. By multiplying the homogeneous transformation matrices, coordinate transformation can be executed one after another.

An upper left subscript (A) of the coordinate transformation matrix ^{A}T_{B} is a reference coordinate system corresponding to the transformed coordinate system, and a lower right subscript (B) is a coordinate system to be transformed.

As described above, the coordinate transformation matrix ^{A}T_{B} is a matrix applied to processing of transforming (^{B}P)=(x_{B}, y_{B}, z_{B}), which is the position coordinate of the point P on the coordinate system (Σ_{B}), into (^{A}P)=(x_{A}, y_{A}, z_{A}), which is the position coordinate of the point P on the coordinate system (Σ_{A}).

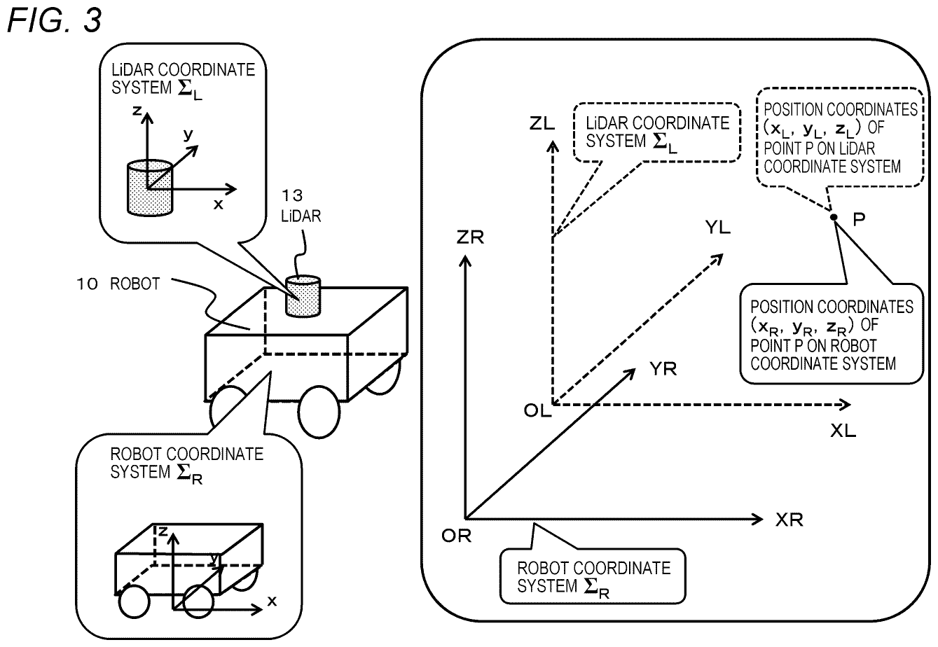

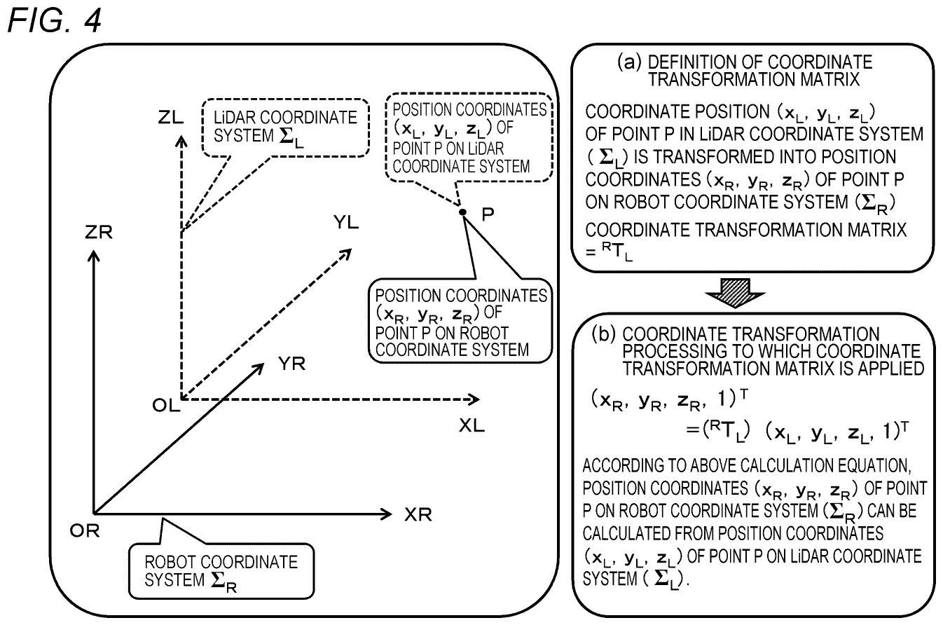

A coordinate transformation matrix for performing coordinate transformation between different coordinate systems will be described with reference to FIGS. 3 and 4.

The left side of FIG. 3 shows the robot 10 equipped with the LiDAR 13.

The robot 10 has a robot specific robot coordinate system (Σ_{R}), and the LiDAR 13 has a LiDAR specific LiDAR coordinate system (Σ_{L}).

The robot coordinate system (Σ_{R}) and the LiDAR coordinate system (Σ_{L}) are also shown on the right side of FIG. 3.

The robot coordinate system (Σ_{R}) is, for example, a coordinate system indicated by the solid line in which an intersection point between a perpendicular line from the center position of the robot 10 and the ground contact surface of the robot contact robot is set as an origin (OR). On the other hand, the LiDAR coordinate system (Σ_{L}) is a coordinate system indicated by the dotted line with the gravity center position of the LiDAR 13 as the origin (OL).

Since the center position of the robot 10 and the gravity center position of the LiDAR 13 are at different positions in space, the robot coordinate system (Σ_{R}) indicated by the solid line and the LiDAR coordinate system (Σ_{L}) indicated by the dotted line are different coordinate systems having different origins.

For example, for a certain point P in the three-dimensional space shown in the right diagram of FIG. 3, three-dimensional position coordinates (x, y, z) in the coordinate system of each of the robot coordinate system (Σ_{R}) indicated by the solid line and the LiDAR coordinate system (Σ_{L}) indicated by the dotted line are as follows as shown in the drawing.

Position coordinates (^{L}P)=(z_{L}, y_{L}, z_{L}) of the point P on the LiDAR coordinate system (Σ_{L})

Position coordinates (^{R}P)=(z_{R}, y_{R}, z_{R}) of the point P on the robot coordinate system (Σ_{R})

Next, a coordinate transformation processing to which a coordinate transformation matrix is applied will be described with reference to FIG. 4.

As shown in FIG. 4 “(a) Definition of Coordinate Transformation Matrix”, a coordinate transformation matrix for transforming
the position coordinates (^{L}P)=(z_{L}, y_{L}, z_{L}) of the point P on the LiDAR coordinate system (Σ_{L}) into
the position coordinates (^{R}P)=(z_{R}, y_{R}, z_{R}) of the point P on the robot coordinate system (Σ_{R}) is
coordinate transformation matrix=(^{R}T_{L}).

As shown in FIG. 4 “(b) Coordinate transformation processing to which coordinate transformation matrix is applied”,

$${( {z}_{R} , {y}_{R} , {z}_{R} , 1 )}^{T} = {(}^{R} {T}_{L} ) {( {z}_{L} , {y}_{L} , {z}_{L} , 1 )}^{T}$$

according to a calculation equation to which the above-described coordinate transformation matrix (^{R}T_{L}) is applied,
the position coordinates (^{R}P)=(z_{R}, y_{R}, z_{R}) of the point P on the robot coordinate system (Σ_{R}) can be calculated
from the position coordinates (^{L}P)=(z_{L}, y_{L}, z_{L}) of the point P on the LiDAR coordinate system (Σ_{L}).

Through such processing, the robot 10 can perform control to calculate the coordinate position of the obstacle in the robot coordinate system (Σ_{R}) from the coordinate position of the obstacle on the LiDAR coordinate system (Σ_{L}), acquire the distance and direction from the robot 10 to the obstacle, and select and travel a travel route on which the robot 10 does not come into contact with the obstacle.

For example, in a case where a large number of robots having the same configuration are manufactured, the coordinate transformation matrix can be determined on the basis of design information such as a mounting position and an angle of each sensor with respect to the robot. However, since there are machining accuracy of components of each robot to be manufactured, assembly accuracy at the time of assembly, individual differences unique to sensors, and the like, adjustment processing unique to each robot is required.

That is, it is necessary to determine a unique coordinate transformation matrix in units of sensors mounted to the robot for each robot.

In the processing of the present disclosure, processing of calculating a coordinate transformation matrix unique to the combination of the robot and the sensor is executed as sensor calibration processing.

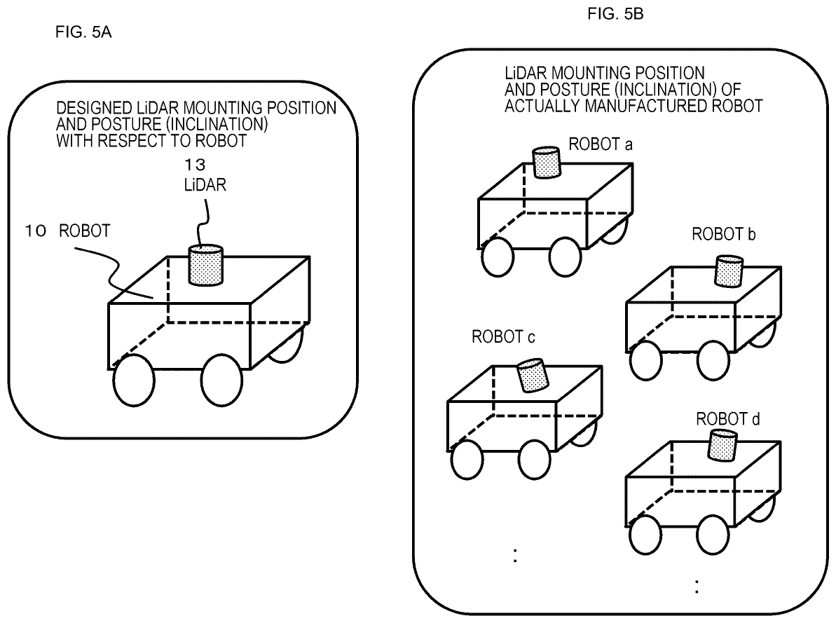

FIG. 5 is a diagram for explaining an example of an individual difference of the manufacturing robot.

FIG. 5(1) is a diagram showing an example of a designed mounting position and posture (inclination) of the LiDAR with respect to the robot.

It is assumed that the LiDAR 13 is designed to be vertically mounted to the center position of the upper surface of the robot 10.

FIG. 5(2) shows an example of the LiDAR mounting position and posture (inclination) of the actually manufactured robot.

For example, a mounting position of a LiDAR of a robot a is at a position slightly shifted to the left rear from the center of the upper surface of the robot, and the robot a is attached in a further inclined manner.

Note that, in the drawing, a difference between the design and the actual configuration is emphasized for easier understanding.

Robots b to d shown in FIG. 5(2) also have different LiDAR mounting positions and various inclinations.

As described above, since there are machining accuracy of components of each robot to be manufactured, assembly accuracy at the time of assembly, individual differences unique to sensors, and the like, it is necessary to perform sensor calibration as adjustment processing unique to each robot.

Specifically, it is necessary to determine a unique coordinate transformation matrix in units of sensors mounted to the robot for each robot.

If the processing using the coordinate transformation matrix calculated on the basis of the designed sensor mounting position and posture is performed on the robot to which the sensor is attached at a position and posture different from the design, for example, the correct relative position and direction of the obstacle P with respect to the robot cannot be calculated.

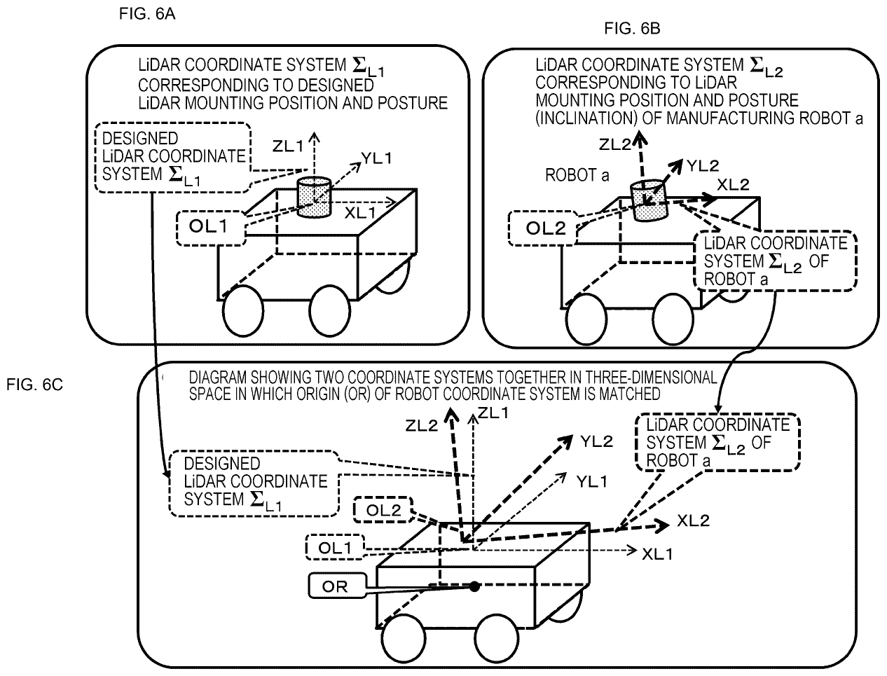

The reason why such a situation occurs will be described with reference to FIG. 6 and subsequent drawings.

FIG. 6 shows the following drawings.
(1) An LiDAR coordinate system (Σ_{L1}) corresponding to designed LiDAR mounting position and posture
(2) An LiDAR coordinate system (Σ_{L2}) corresponding to a LiDAR mounting position and posture of the manufactured robot a.
(3) A diagram showing two coordinate systems together in a three-dimensional space in which the origin (OR) of the robot coordinate system is matched.

The robot shown in FIG. 6(1) has the robot configuration in design shown in FIG. 5(1), and a LiDAR is vertically mounted to the center position of the upper surface of the robot.

On the other hand, the robot a shown in FIG. 6(2) corresponds to the robot a shown in FIG. 5. The mounting position of the LiDAR of the robot a is at a position slightly shifted to the left rear from the center of the upper surface of the robot, and the robot a is attached in a further inclined manner.

The LiDAR coordinate system is shown in the LiDER in each of FIGS. 6(1) and 6(2).

The designed LiDAR coordinate system (Σ_{L1}) shown in (1) is a coordinate system having three axes (xyz axes) corresponding to the posture (inclination) of the LiDAR, that is, the XL1 axis, the YL1 axis, and the ZL1 axis shown in the drawing, with the center of gravity of the designed LiDAR as an origin (OL1).

On the other hand, the LiDAR coordinate system (Σ_{L2}) of the robot a shown in (2) is a coordinate system having three axes (xyz axes) corresponding to the LiDAR posture (inclination) with the center of gravity of the LiDAR of the robot a as an origin (OL2), that is, the XL2 axis, the YL2 axis, and the ZL2 axis shown in the drawing.

(1) The LiDAR coordinate system (Σ_{L1} corresponding to the designed LiDAR mounting position and posture and the LiDAR coordinate system (212 corresponding to the LiDAR mounting position and posture of the robot a shown in (2) have different origin positions and further have different directions of the respective coordinate axes.

FIG. 6(3) is a diagram showing two coordinate systems together in a three-dimensional space in which the origin (OR) of the robot coordinate system is matched.

As shown in (3), the origin position is different between the designed LiDAR coordinate system (Σ_{L1}) and the LiDAR coordinate system (Σ_{L2}) of the robot a, and the direction of each coordinate axis is also different.

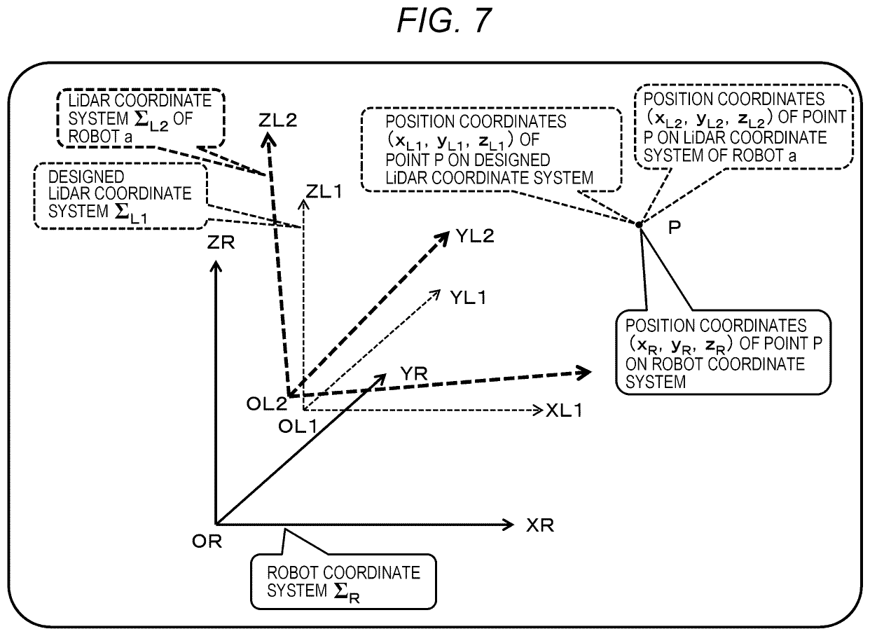

FIG. 7 is a diagram showing the robot coordinate system (Σ_{R}) of the robot 10 in addition to the designed LiDAR coordinate system (Σ_{L1}) shown in FIG. 6(3) and the LiDAR coordinate system (Σ_{L2}) of the robot a.

The robot coordinate system is, for example, a coordinate system in which an intersection of a certain point on the robot ground contact surface, for example, a perpendicular from a robot center position and the robot ground contact surface is set as an origin (OR).

For a certain point P in the three-dimensional space shown in the right diagram of FIG. 7,
the robot coordinate system (Σ_{R}) indicated by the solid line,
the designed LiDAR coordinate system (Σ_{L1}) corresponding to the designed LiDAR position and posture,
the LiDAR coordinate system (Σ_{L2}) corresponding to the LiDAR position and posture of the robot a, and
the three-dimensional position coordinates (x, y, z) in these three coordinate systems are as follows, as shown in the drawing.

Position coordinates of the point P on the robot coordinate system (Σ_{R}): (^{R}P)=(z_{R}, y_{R}, z_{R})

Position coordinates of the designed LiDAR coordinate system (Σ_{L1}): (^{L1}P)=(z_{L1}, y_{L1}, z_{L1})

Position coordinates of the robot a in the LiDAR coordinate system (Σ_{L2}): (^{L2}P)=(z_{L2}, y_{L2}, z_{L2})

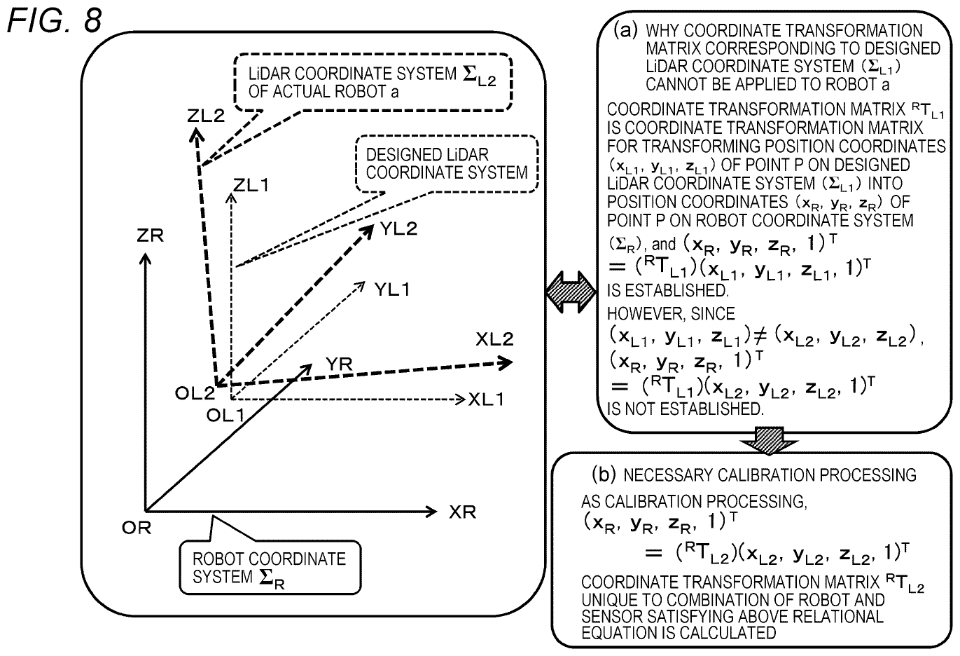

Next, with reference to FIG. 8, the reason why calibration processing for calculating a unique coordinate transformation matrix in units of sensors mounted to the robot is required for each robot will be described.

First, the reason why the coordinate transformation matrix corresponding to the designed LiDAR coordinate system (Σ_{L1}) cannot be applied to the robot a will be described with reference to FIG. 8(a).

The coordinate transformation matrix ^{R}T_{L1} corresponding to the designed LiDAR coordinate system (Σ_{L1}) is a coordinate transformation matrix for transforming the position coordinates (^{L1}P)=(z_{L1}, y_{L1}, z_{L1}) of the point P on the designed LiDAR coordinate system (Σ_{L1}) into the position coordinates of the point P on the robot coordinate system (Σ_{R}): (^{R}P)=(z_{R}, y_{R}, z_{R}), and

$${( {z}_{R} , {y}_{R} , {z}_{R} , 1 )}^{T} = {(}^{R} {T}_{L 1} ) {( {z}_{L 1} , {y}_{L 1} , {z}_{L 1} , 1 )}^{T} , that is , ( {}^{R} P ) = {(}^{R} {T}_{L 1} ) ( {}^{L 1} P )$$

the above relational equation is established.

However,
position coordinates of the designed LiDAR coordinate system (Σ_{L1}): (^{L1}P)=(z_{L1}, y_{L1}, z_{L1})
position coordinates of the LiDAR coordinate system (Σ_{L2}) of the robot a: (^{L2}P)=(z_{L2}, y_{L2}, z_{L2})
these two position coordinates are different from each other.

Therefore, even if the coordinate transformation matrix (^{R}T_{L1}) corresponding to the LiDAR coordinate system (Σ_{L1}) in design is used, the position coordinates of the point P on the robot coordinate system (Σ_{R}): (^{R}P)=(z_{L2}, y_{L2}, z_{L2}) Cannot be calculated from the position coordinates of the LiDAR coordinate system (Σ_{L2}) of the robot a: (^{L2}P)=(z_{R}, y_{R}, z_{R}).

Specifically,

$${( {z}_{R} , {y}_{R} , {z}_{R} , 1 )}^{T} = {(}^{R} {T}_{L 1} ) {( {z}_{L 2} , {y}_{L 2} , {z}_{L 2} , 1 )}^{T}$$

the above equation does not hold. That is,

$$( {}^{R} P ) = {(}^{R} {T}_{L 1} ) ( {}^{L 2} P )$$

the above relational equation does not hold.

Therefore, the calibration processing shown in FIG. 8(2), that is, the calibration processing of calculating a unique coordinate transformation matrix in units of sensors mounted to the robot is required for each robot.

The necessary calibration processing is processing of calculating a unique coordinate transformation matrix (^{R}T_{L2}) for calculating the position coordinates of the point P on the robot coordinate system (Σ_{R}): (^{R}P)=(z_{L2}, y_{L2}, z_{L2}) from the position coordinates of the LiDAR coordinate system (Σ_{L2}) of the robot a:

$$( {}^{L 2} P ) = ( {z}_{R} , {y}_{R} , {z}_{R} ) .$$

Specifically,

$${( {z}_{R} , {y}_{R} , {z}_{R} , 1 )}^{T} = {(}^{R} {T}_{L 2} ) {( {z}_{L 2} , {y}_{L 2} , {z}_{L 2} , 1 )}^{T}$$

the above equation is established. That is,

$$( {}^{R} P ) = {(}^{R} {T}_{L 2} ) ( {}^{L 2} P )$$

It is necessary to perform calibration processing of calculating a coordinate transformation matrix (^{R}T_{L2}) unique to the combination of the robot a and the sensor mounted on the robot a satisfying the above relational equation.

The calibration execution device of the present disclosure has a configuration capable of executing the calibration processing of calculating the coordinate transformation matrix unique to the combination of the robot and the sensor mounted on the robot in this manner, and further visually confirming whether or not the coordinate transformation matrix calculated as the calibration result has been correctly calculated.

Hereinafter, a configuration of a device of the present disclosure and a plurality of embodiments for executing processing will be sequentially described.

### 2. (First Embodiment) Configuration and Processing of Calibration Execution Device

Hereinafter, the configuration and processing of the calibration execution device according to a first embodiment of the present disclosure will be described.

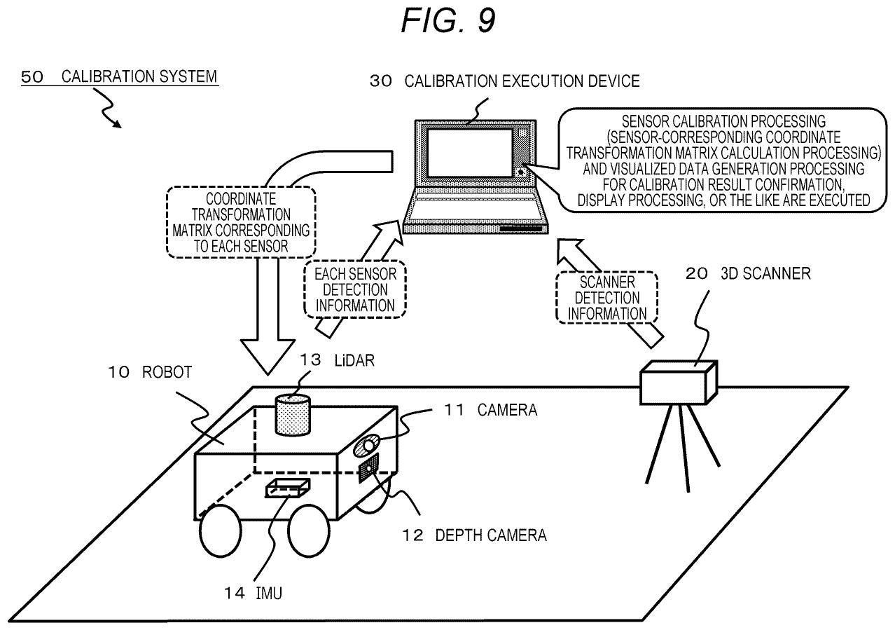

FIG. 9 is a diagram showing a configuration example of a calibration system 50 including a calibration execution device 30 of the present disclosure.

The calibration system 50 shown in FIG. 9 is a system including the robot 10, a 3D scanner 20, and the calibration execution device 30.

The robot 10 is an autonomous mobile robot, and is equipped with a plurality of sensors. Note that the robot 10 is an example of the mobile device of the present disclosure, and the mobile device of the present disclosure includes various mobile bodies such as an automated driving vehicle in addition to the robot.

The 3D scanner 20 measures a three-dimensional shape of a surrounding object. The 3D scanner 20 incorporates a color camera and can acquire color information in addition to a three-dimensional shape. The 3D scanner 20 performs scanning processing of emitting a laser beam at a circumference of 360 degrees and inputting reflected light thereof, and measures a distance of a surrounding object to acquire a three-dimensional shape of a surrounding environment.

The robot 10 is a robot similar to the robot 10 described above with reference to FIG. 1, and is a robot that analyzes the surrounding environment on the basis of the sensor detection information and performs autonomous movement.

As shown in FIG. 9, the robot 10 is mounted with a plurality of different sensors 11 to 14. That is, a camera 11, a depth camera 12, a LiDAR 13, an IMU 14, and these sensors are mounted.

The depth camera 12 is, for example, a camera that detects an object distance such as a stereo camera. The LiDAR 13 is a sensor that measures a distance to an obstacle by laser light as described above. The IMU is an inertial measurement unit, and is a sensor that detects acceleration, angular velocity, and the like of the robot 10.

Note that the robot 10 shown in FIG. 9 is mounted with the camera 11, the depth camera 12, the LiDAR 13, the IMU 14, and these sensors as a plurality of different types of sensors, but the types of sensors mounted on the robot 10 are not limited thereto, and may be configured to mount various other types of sensors.

Furthermore, the processing of the present disclosure can be applied not only to a configuration in which a plurality of types of sensors is mounted but also to a configuration in which one sensor is mounted.

As described above, each of the sensors 11 to 14 mounted to the robot 10 shown in FIG. 9 calculates a sensor detection value based on a coordinate system unique to the sensor, for example, a coordinate position of an obstacle on the basis of the coordinate system unique to the sensor.

The calibration execution device 30 can be configured by, for example, a data processing device such as a PC.

The calibration execution device 30 is configured to communicate with the robot 10 and the 3D scanner 20.

The calibration execution device 30 receives sensor detection information of each of the sensors 11 to 14 mounted to the robot 10, and further receives scanner detection information from the 3D scanner 20.

The calibration execution device 30 executes calibration processing of each of the sensors 11 to 14 mounted to the robot 10 on the basis of these pieces of input information. Specifically, processing of calculating a coordinate transformation matrix corresponding to the sensor is executed. The coordinate transformation matrix corresponding to the sensor is a coordinate transformation matrix for transforming position coordinates on the coordinate system unique to the sensor into position coordinates on the robot coordinate system.

The calibration execution device 30 further generates display data, which is visualized data for calibration result confirmation enabling visual confirmation as to whether or not the coordinate transformation matrix calculated as the calibration result has been correctly calculated, and outputs the display data to the display unit.

The visualized data for calibration result confirmation is image data that enables confirmation as to whether or not the coordinate transformation matrix corresponding to the sensor has been correctly calculated. A specific example of the image data will be described later.

As shown in FIG. 9, the calibration execution device 30 receives detection information of each sensor from the robot 10, and further receives scanner detection information (three-dimensional shape information of the surroundings) from the 3D scanner 20.

The calibration execution device 30 executes calibration processing of calculating a coordinate transformation matrix corresponding to each sensor of the robot 10 using these pieces of input information.

The coordinate transformation matrix corresponding to each sensor calculated as the calibration processing result executed by the calibration execution device 30 is transmitted to the robot 10 and stored in the storage unit in the robot 10.

When performing autonomous movement, the robot 10 transforms position coordinates on the coordinate system unique to each sensor into position coordinates on the robot coordinate system using the coordinate transformation matrix corresponding to the sensor stored in the storage unit, analyzes the relative position of the surrounding obstacle with respect to the robot 10 on the basis of the position coordinates on the robot coordinate system after the transformation, and selects a traveling route to avoid collision or contact with the obstacle to perform autonomous movement.

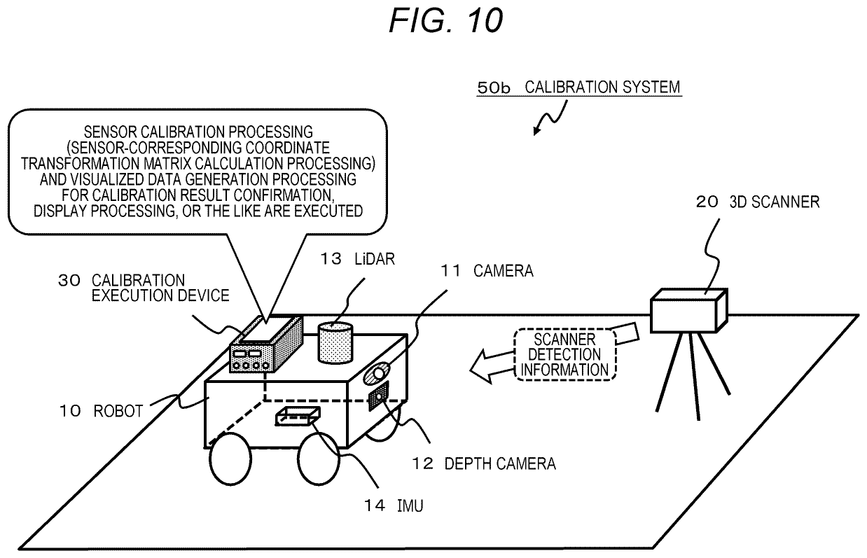

Note that the calibration system 50 shown in FIG. 9 is an example of a system in which the robot 10 and the calibration execution device 30 are configured as separate devices, but may have a configuration such as a calibration system 50b in which the robot 10 and the calibration execution device 30 are integrated as shown in FIG. 10, for example.

In the configuration shown in FIG. 10, the calibration execution device 30 in the robot 10 executes calibration processing for calculating a coordinate transformation matrix corresponding to each sensor mounted to the robot 10.

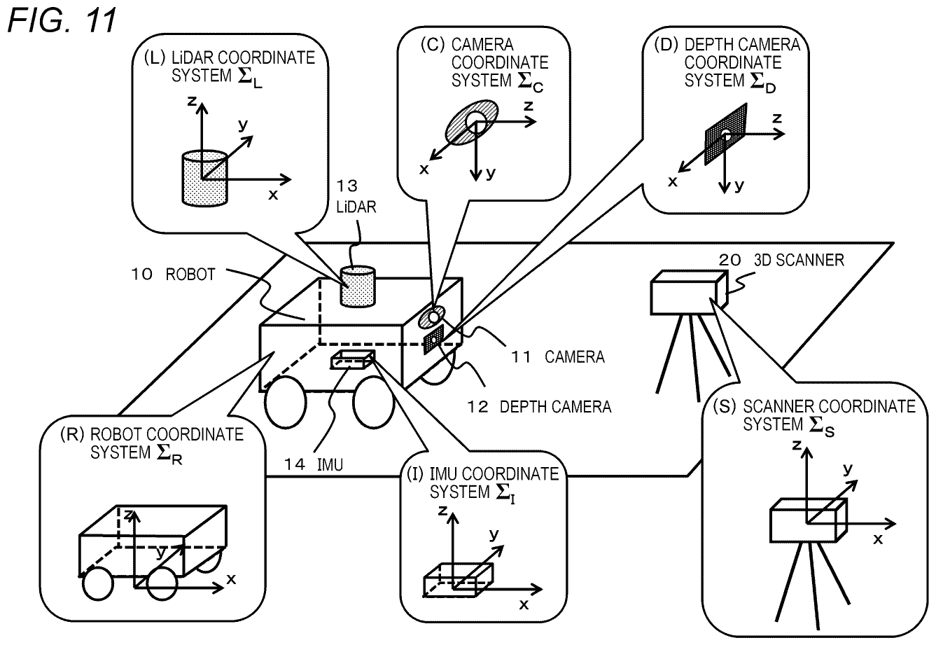

Next, the sensors mounted to the robot 10, that is, the camera 11, the depth camera 12, the LiDAR 13, the IMU 14, a sensor coordinate system which is a coordinate system of each of these sensors, a robot coordinate system of the robot 10, and a scanner coordinate system which is a coordinate system of the 3D scanner 20 will be described with reference to FIG. 11.

FIG. 11 shows the following coordinate systems.
(R) Robot coordinate system (Σ_{R})
(C) Camera coordinate system (Σ_{C})
(D) Depth camera coordinate system (Σ_{D})
(L) LiDAR coordinate system (Σ_{L})
(I) IMU coordinate system (Σ_{I})
(S) Scanner coordinate system (Σ_{S})

(R) The robot coordinate system (Σ_{R}) is, for example, a coordinate system in which an intersection point between a perpendicular line from a center position of the robot 10 and a robot ground contact surface is set as an origin, a front side of the robot 10 is set as an X axis, a left side surface direction is set as a Y axis, and an upper direction is set as a Z axis.

(C) The camera coordinate system (Σ_{C}) is, for example, a coordinate system in which a lens position of the camera 11 is set as an origin, a front optical axis direction of the camera 11 is set as a Z axis, a lower side surface direction is set as a Y axis, and a right direction is set as an X axis.

(D) The depth camera coordinate system (Σ_{D}) is, for example, a coordinate system in which a gravity center position of the depth camera 12 is set as an origin, a front optical axis direction of the depth camera 12 is set as a Z axis, a lower side direction is a Y axis, and a right direction is set as an X axis.

(L) The LiDAR coordinate system (Σ_{L}) is, for example, a coordinate system in which a gravity center position of the LIDAR 13 is set as an origin, a front side of the LiDAR10 is set as an X axis, a left side surface direction is set as a Y axis, and an upper direction is set as a Z axis.

(I) The IMU coordinate system (Σ_{I}) is, for example, a coordinate system in which a gravity center position of the IMU 14 is set as an origin, a front side of the IMU10 is set as an X axis, a left side surface direction is set as a Y axis, and an upper direction is set as a Z axis.

(S) The scanner coordinate system (Σ_{S}) is a coordinate system in which a gravity center position of the 3D scanner 20 is set as an origin, an orthogonal axis of a horizontal plane is set as an XY axis, and an axis extending vertically upward is set as a Z axis.

Note that the origin of the coordinate system of each of the robot, the sensor, and the 3D scanner shown in FIG. 11 and the direction of each coordinate axis are examples, and the origin of each coordinate system and the direction of each coordinate axis are not limited to the settings shown in FIG. 11, and various settings can be used.

As shown in FIG. 11, the robot coordinate system of the robot 10, the coordinate system of each of the sensors 11 to 14, and the coordinate system of the 3D scanner 20 are different from each other.

As described above, for example, each sensor of the robot 10 acquires the coordinate position of the obstacle using the coordinate system unique to each sensor.

For example, the depth camera 12 calculates a coordinate position of the obstacle in the depth camera coordinate system (Σ_{D}) as the position of the obstacle.

The robot 10 performs control to calculate a coordinate position of the obstacle on the robot coordinate system (Σ_{R}) on the basis of the coordinate position of the obstacle in the depth camera coordinate system (Σ_{D}), acquire a distance and a direction from the robot 10 to the obstacle, and select and travel a travel route on which the robot 10 does not come into contact with the obstacle.

That is, for example, coordinate transformation processing of transforming the position (depth camera coordinate position (x_{D}, y_{D}, z_{D})) of the obstacle P in the depth camera coordinate system (Ep) calculated using the captured image of the depth camera 12 or the position (LiDAR coordinate position (x_{L}, y_{L}, z_{L})) of the obstacle P in the LiDAR coordinate system (Σ_{L}) calculated by the LiDAR 13 into the position (robot coordinate position (x_{R}, y_{R}, z_{R})) of the obstacle P in the robot coordinate system (Σ_{R}) is performed.

As described above, the coordinate transformation matrix (T) is used for the coordinate transformation processing.

For example, a coordinate transformation matrix ^{R}T_{D} is used in a coordinate transformation processing of transforming the coordinate position (x_{D}, y_{D}, z_{D}) of a certain point P in the depth camera coordinate system (Σ_{D}) in the space into the coordinate position (x_{R}, y_{R}, z_{R}) in the robot coordinate system (Σ_{R}).

Similarly, a coordinate transformation matrix (^{R}T_{L}) is used for the coordinate transformation processing of transforming the coordinate position (x_{L}, y_{L}, z_{L}) of the point P in the LiDAR coordinate system (Σ_{L}) into the coordinate position (x_{R}, y_{R}, z_{R}) of the robot coordinate system (Σ_{R}).

As described above, the coordinate transformation matrix (^{A}T_{B}) is a matrix applied to processing of transforming (^{B}P)=(x_{B}, y_{B}, z_{B}), which is the position coordinate of the point P on the coordinate system (Σ_{B}), into (^{A}P)=(x_{A}, y_{A}, z_{A}), which is the position coordinate of the point P on the coordinate system (Σ_{A}).

Here, (^{A}P) represents position coordinates (x_{A}, y_{A}, z_{A}) Of the point P in the coordinate system A, and (^{B}P) represents position coordinates (x_{B}, y_{B}, z_{B}) of the point P in the coordinate system B.

That is, the following relational equation is established.

$$( {}^{A} P ) = ( {}^{A} {T}_{B} ) ( {}^{B} P )$$

$${( {x}_{A} , {y}_{A} , {z}_{A} , 1 )}^{T} = {(}^{A} {T}_{B} ) {( {x}_{B} , {y}_{B} , {z}_{B} , 1 )}^{T}$$

However, as described above, since the robot has machining accuracy of each component, assembly accuracy at the time of assembly, an individual difference unique to the sensor, and the like, it is necessary to determine and use a unique coordinate transformation matrix for each robot and in units of sensors mounted to the robot as the coordinate transformation matrix.

The calibration execution device 30 shown in FIGS. 9 and 10 executes processing of calculating a coordinate transformation matrix unique to the combination of the robot and the sensor as sensor calibration processing.

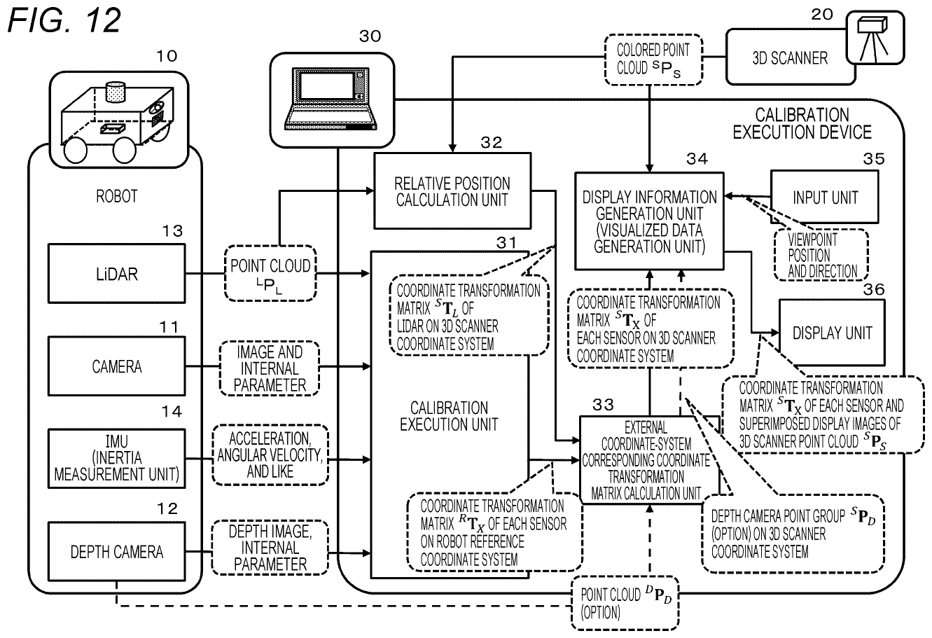

Next, a detailed configuration of the calibration execution device 30 will be described with reference to FIG. 12.

FIG. 12 shows a detailed configuration of the calibration execution device 30 and data input from the robot 10 and the 3D scanner 20 by the calibration execution device 30.

As shown in FIG. 12, the calibration execution device 30 includes a calibration execution unit 31, a relative position calculation unit 32, an external coordinate-system corresponding coordinate transformation matrix calculation unit 33, a display information generation unit (visualized data generation unit) 34, an input unit 35, and a display unit 36.

Note that FIG. 12 shown the camera 11, the depth camera 12, the LiDAR 13, and the IMU 14 as the sensors 11 to 14 mounted to the robot 10.

Note that, as described above, the types of sensors mounted to the robot 10 are not limited to these, and various other types of sensors may be mounted.

Furthermore, the processing of the present disclosure can be applied not only to a configuration in which a plurality of types of sensors is mounted but also to a configuration in which one sensor is mounted.

The calibration execution unit 31 of the calibration execution device 30 calculates a coordinate transformation matrix of each of the sensors 11 to 14 mounted to the robot 10.

That is, the calibration execution unit 31 inputs each sensor detection information and the like from each of the sensors 11 to 14 of the robot 10 and executes the calculation processing of the coordinate transformation matrix corresponding to each sensor.

As shown in FIG. 12, the calibration execution device 30 receives the following information from each of the sensors 11 to 14 of the robot 10.
the captured image of the camera 11 and the internal parameters of the camera 11 from the camera 11
a distance image (depth image) which is a photographed image of the depth camera 12 and an internal parameter of the depth camera 12 from the depth camera 12
point cloud (^{L}P_{L}) information, which is a LiDAR detection value, from the LiDAR 13
angular velocity, acceleration, and the like of the robot 10 which are IMU detection information from the IMU 14

The calibration execution device 30 receives the information from each of the sensors 11 to 14 of the robot 10.

Note that the point cloud (^{L}P_{L}) information that is a LiDAR detection value input from the LiDAR 13 is point cloud information indicating an object position in a three-dimensional space around the LiDAR 13.

(^{L}P_{L}) indicates point cloud data on the LiDAR coordinate system. A subscript (L) at the upper left of (^{L}P_{L}) means a coordinate system, and (P_{L}) means a three-dimensional point cloud of an LiDAR.

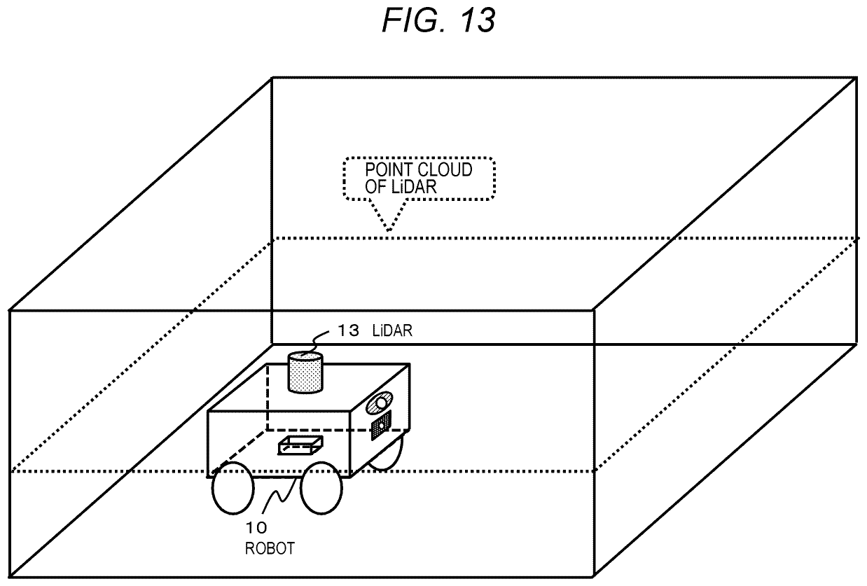

For example, as shown in FIG. 13, in a case where the robot 10 is traveling in a room having a rectangular wall, a point cloud (^{L}P_{L}) detected by the LiDAR 13 and a point cloud indicating an object position in a three-dimensional space around the LiDAR 13 are a point cloud indicating a position of a wall in four directions as shown in FIG. 13.

The LiDAR 13 is a LiDAR of a type in which one laser beam is scanned in the horizontal direction, and can acquire a point cloud as if the laser beam horizontally slices a wall surface. The shape of this sliced cross-section depends on the height and orientation in which the LiDAR 13 is installed.

The calibration execution unit 31 inputs each sensor detection information and the like from each of the sensors 11 to 14 of the robot 10, and executes the following calculation processing of a coordinate transformation matrix corresponding to each sensor.
(a) Calculation processing of camera-corresponding coordinate transformation matrix (^{R}T_{C}) for transforming camera coordinate system (Σ_{C}) of camera 11 into robot coordinate system
(b) Calculation processing of depth camera-corresponding coordinate transformation matrix (^{R}T_{D}) for transforming depth camera coordinate system (Σ_{D}) of depth camera 12 into robot coordinate system (Σ_{R})
(c) Calculation processing of LiDAR compatible coordinate transformation matrix (^{R}T_{L}) for transforming LiDAR coordinate system (Σ_{L}) of LiDAR 13 into robot coordinate system (Σ_{R})
(d) Calculation processing of IMU-corresponding coordinate transformation matrix (^{R}T_{I}) for transforming IMU coordinate system (Σ_{I}) of IMU 14 into robot coordinate system (Σ_{R})

Note that, hereinafter, a coordinate matrix for transforming the sensor coordinate system of each of the sensors 11 to 14 mounted on the robot 10 into the robot coordinate system (Σ_{R}) is represented as (^{R}T_{X}). X means identifiers of various sensors.

In this manner, the calibration execution unit 31 of the calibration execution device 30 calculates the coordinate transformation matrix (^{R}T_{X}) of each of the sensors 11 to 14 mounted to the robot 10.

Note that the calculation processing of the coordinate transformation matrix is executed using a known calibration technique.

Specifically, for example, the calculation can be performed by applying the configuration described in the following Non-Patent Document.
Non-Patent Document 2 (Dhall et al. Ankit, LiDAR-camera calibration using 3D-3D point correspondences. arXiv preprint arXiv: 1705.09785, 2017.)
Non-Patent Document 3 (Banerjee et al. Koyel, Online camera lidar fusion and object detection on hybrid data for autonomous driving. 2018 IEEE Intelligent Vehicles Symposium (IV). IEEE, 2018.)
Non-Patent Document 4 (PusztaiIvn Eichhardt, and Levente Hajder. Zoltn, Accurate calibration of multi-lidar-multi-camera systems. Proceedings of the IEEE International Conference on Computer Vision Workshops., 2017.)
Non-Patent Document 5 (Irene Fassi Legnani Giovanni. Hand to sensor calibration: A geometrical interpretation of the matrix equation AX=XB. Journal of Robotic Systems, 2005.)
Non-Patent Document 6 (Legnani Giovanni. Optimization of hand-to-camera calibration using geometrical interpretation of matrix equation AX=XB. International Journal of Robotics and Automation, 2018.)

As described above, the calibration execution unit 31 inputs the sensor detection information and the like from each of the sensors 11 to 14 of the robot 10 and executes the calculation processing of the coordinate transformation matrix (^{R}T_{X}) for transforming the coordinate system of each sensor into the robot coordinate system.

Note that, similarly to that described above using (Equation 1), the coordinate transformation matrix ^{R}T_{X}, which is a homogeneous transformation matrix in a three-dimensional space, is specifically indicated as a homogeneous transformation matrix of four rows and four columns shown in (Equation 1b) below.

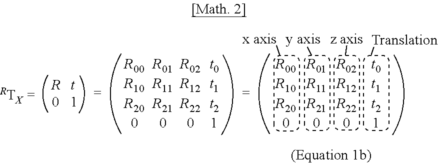

In the above matrix of four rows and four columns, the upper left three rows and three columns are a rotation matrix representing an angle, and the upper right three rows and one column are a matrix representing translation.

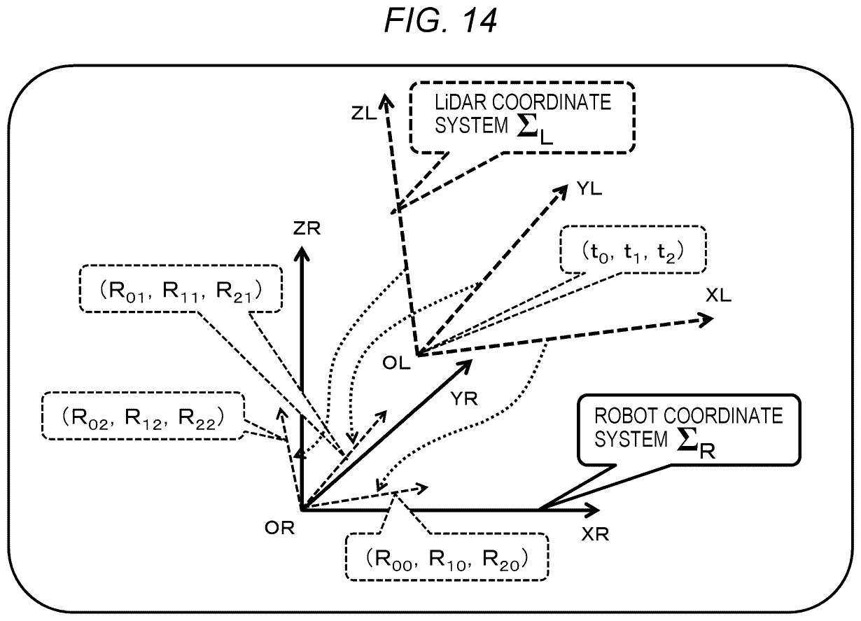

Meanings of matrix elements of the coordinate transformation matrix (^{R}T_{X}) will be described with reference to FIG. 14.

Specifically, as shown in FIG. 14, the matrix elements of the coordinate transformation matrix (^{R}T_{X}) are configured by the following axes and elements indicating the origin position.
(a) (R₀₁, R₁₀, R₂₀) indicates the X-axis direction of the sensor coordinate system (Σ_{X}) to be transformed,
(b) (R₀₁, R₁₁, R₂₁) indicates the Y-axis direction of the sensor coordinate system (Σ_{X}) to be transformed,
(c) (R₀₂, R₁₂, R₂₂) indicates the Z-axis direction of the sensor coordinate system (Σ_{X}) to be transformed, and
(d) (t₀, t₁, t₂) is an origin position coordinate of the sensor coordinate system (Σ_{X}) to be transformed,

Note that, the directions of the coordinate axes (X axis, Y axis, Z axis) shown in the above (a) to (d) and the origin position are a direction and a coordinate position in the robot coordinate system (Σ_{R}) which is the coordinate system after the coordinate transformation.

The relative position calculation unit 32 executes alignment processing between the scanner coordinate system (Σ_{S}) of the 3D scanner 20 and the robot coordinate system (Σ_{R}) of the robot 10.

The relative position calculation unit 32 inputs a colored point cloud (^{S}P_{S}) from the 3D scanner 20, inputs a point cloud (^{L}P_{L}) from the LiDAR 13 of the robot 10, and executes alignment processing of the scanner coordinate system (Σ_{S}) and the robot coordinate system (Σ_{R}) using these pieces of input point cloud information.

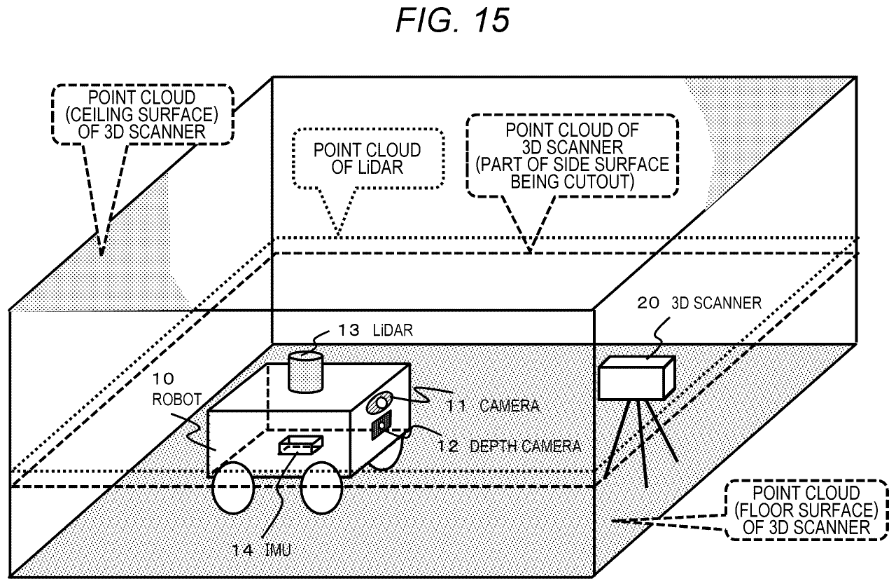

Similarly to FIG. 13 described above, FIG. 15 is a diagram showing a part of a point cloud (^{L}P_{L}) detected by the LiDAR 13 and a part of a point cloud (^{S}P_{S}) detected by the 3D scanner 20 in a case where the robot 10 is traveling in a room having a rectangular wall.

As described above, the LiDAR 13 is a LiDAR of a type in which one laser beam is scanned in the horizontal direction, and a point cloud in which the laser beam horizontally slices a wall surface can be acquired. The shape of this sliced cross-section depends on the height and orientation in which the LiDAR 13 is installed.

On the other hand, the point cloud input from the 3D scanner 20 is a point cloud indicating an object surface in a range in the horizontal direction of 360° and corresponding to almost the entire celestial sphere from the lower side to the vertically upper side except for a portion immediately below the 3D scanner 20 in the vertical direction.

Note that the point cloud (^{S}P_{S}) input from the 3D scanner 20 can be shown as (Equation 2) shown below.

$$\begin{matrix}[ Math . 3 ] & \\ \begin{matrix}{}^{S} {P}_{S} = \{ {}^{S} {p}_{si} \vert i = 1 , 2 , … , N \} \\ = \{ {( \begin{matrix}{S}^{} {x}_{Si} & {S}^{} {y}_{Si} & {S}^{} {z}_{Si}\end{matrix} )}^{T} \vert i = 1 , 2 , … , N \}\end{matrix} & ( Equation 2 )\end{matrix}$$

In the above (Equation 2), (^{s}pₛᵢ) indicates one point constituting the point cloud (^{S}P_{S}). (^{S}x_{Si}, ^{S}yₛᵢ, ^{S}zₛᵢ) is a coordinate position of the point (^{s}pₛᵢ).

Note that the point cloud coordinate transformation processing of transforming a point cloud on a certain coordinate system into a point cloud of a different coordinate system can be executed by applying the point cloud coordinate transformation equation.

For example, a point cloud coordinate transformation equation (^{S}P_{D}) for transforming the depth camera detection point cloud (^{S}P_{S}) indicated by the depth camera coordinate system (Σ_{D}) into the scanner coordinate system point cloud (^{S}P_{S}) indicated by the 3D scanner coordinate system (Σ_{S}) is expressed by (Equation 3) below. The calculation is performed as four-dimensional homogeneous coordinates.

$$\begin{matrix}[ Math . 4 ] & \\ \begin{matrix}{}^{S} {P}_{D} = \{ {}^{S} {p}_{Di} \vert i = 1 , 2 , … , N \} \\ = \{ {}^{S} {{T}_{D}}^{D} {p}_{Di} \vert i = 1 , 2 , … , N \} = {}^{S} {T}_{D} {}^{D} {P}_{D}\end{matrix} & ( Equation 3 )\end{matrix}$$

The relative position calculation unit 32 first aligns the point cloud of the LiDAR 13 with the point cloud of the 3D scanner 20.

The relative position calculation unit 32 first detects the floor surface (robot ground contact surface) from the point cloud of the 3D scanner 20 and calculates the height (H_{S}) of the 3D scanner 20 from the floor. The point cloud (^{S}P_{S}) input from the 3D scanner 20 includes a point cloud of a floor surface (robot ground plane). Since the floor surface (robot ground contact surface) has a large area and is located below the 3D scanner 20, and the normal line of the surface is substantially parallel to the z-axis direction of the coordinate system of the 3D scanner 20, the floor surface (robot ground contact surface) can be easily detected.

Note that, for example, the processing described in Non-Patent Document 8 (Trevor J B, et al. Alexander. Efficient organized point cloud segmentation with connected components. Semantic Perception Mapping and Exploration (SPME), 2012) can be applied to the floor surface (robot ground contact surface) detection processing.

Next, the relative position calculation unit 32 obtains a height (H_{L}) from the floor surface (robot ground contact surface) to the LiDAR 13. This height is a value located in 3 rows and 4 columns of a coordinate transformation matrix of four rows and four columns of the LiDAR 13 coordinate transformation matrix (^{R}T_{L}) obtained by the calibration execution unit 31.

That is, as described above with reference to FIG. 14, (t₀, t₁, t₂) in the fourth column in the coordinate transformation matrix (^{R}T_{L}) of four rows and four columns in (Equation 1b) described above indicates the origin position coordinates of the sensor coordinate system (Σ_{X}) to be transformed, and (t₂) in this indicates a value corresponding to the difference in height (Z direction) from the origin (position of the robot ground plane) of the robot coordinate system (Σ_{R}) to the origin of the LiDAR coordinate system (Σ_{L}). That is, it indicates a value corresponding to the height (H_{L}) from the floor surface (robot ground contact surface) to the LiDAR 13.

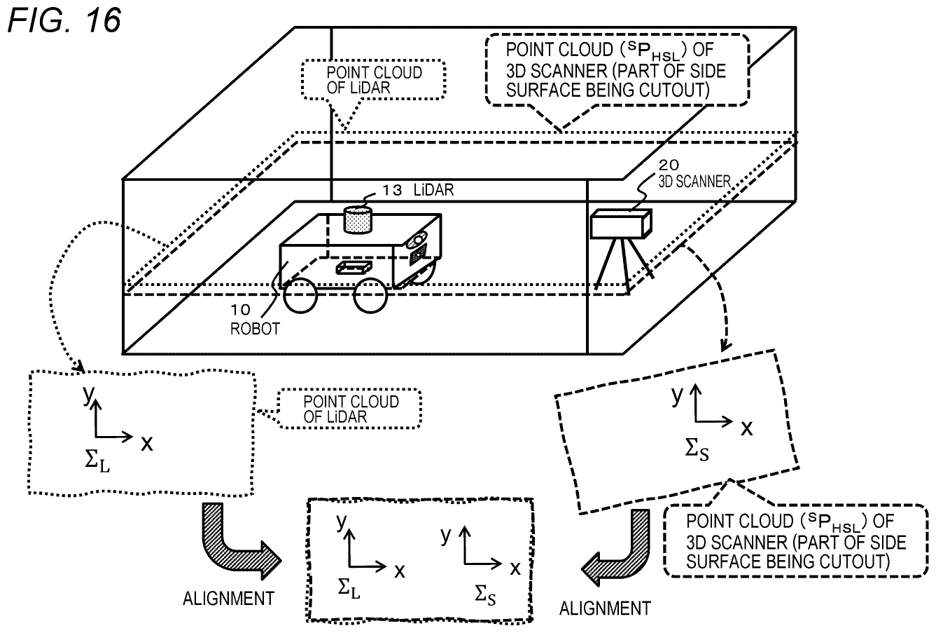

Next, the relative position calculation unit 32 uses the calculated height (H_{L}) of the LiDAR 13, that is, the height (H_{L}) from the floor surface (robot ground contact surface) to the LIDAR 13 to extract a part of the point cloud from the point cloud (^{S}P_{S}) of the omnidirectional input from the 3D scanner 20 as shown in FIG. 16. Specifically, the point cloud (^{S}P_{HSL}) located at the height (H_{SL})=(H_{S})−(H_{L}) of the origin position of the LiDAR coordinate system (Σ_{L}) from the origin of the scanner coordinate system (Σ_{S}) of the 3D scanner 20 is extracted.

In this manner, the relative position calculation unit 32 aligns a part of the point cloud (^{S}P_{HSL}) extracted from the point cloud (SPs) of the omnidirectional input from the 3D scanner 20 with the point cloud of the LiDAR 13.

The point cloud alignment processing can be executed using an iterative closest point (ICP) known as existing processing.

Next, the relative position calculation unit 32 calculates a coordinate transformation matrix (^{S}T_{L}) necessary for aligning the point cloud of the LiDAR 13 according to (Equation 4) below with a part of the point cloud (^{S}P_{HSL}) sliced and extracted from the point cloud (^{S}P_{S}) input from the 3D scanner 20 as a reference.

$$\begin{matrix}[ Math . 5 ] & \\ {}_{}^{S} {T}_{L}^{} = arg {min}_{T} \sum ‖ {}_{}^{S} {P}_{HSL}^{} - T {}_{}^{L} {P}_{L}^{} ‖ & ( Equation 4 )\end{matrix}$$

The coordinate transformation matrix (^{S}T_{L}) shown in (Equation 4) above is a transformation equation for transforming a point cloud on the LiDAR coordinate system (Σ_{L}) of the LiDAR 13 into a point cloud on the scanner coordinate system (Σ_{S}) of the 3D scanner 20.

Note that (Equation 4) above is a problem of obtaining a coordinate transformation matrix (T) that minimizes a position error between a part of the point cloud (^{S}P_{HSL}) sliced and extracted from the point cloud (SPs) input from the 3D scanner 20 and the point cloud (^{L}P_{L}) on the LiDAR coordinate system (Σ_{L}).

The coordinate transformation matrix (^{S}T_{L}) calculated by (Equation 4) above can be obtained by iterative convergence calculation of ICP.

This coordinate transformation matrix (^{S}T_{L}) is a coordinate transformation matrix for transforming the LiDAR coordinate system (Σ_{L}) of the LiDAR 13 into the scanner coordinate system (Σ_{S}) of the 3D scanner 20.

Next, processing executed by the external coordinate-system corresponding coordinate transformation matrix calculation unit 33 in the calibration execution device 30 shown in FIG. 12 will be described.

The external coordinate-system corresponding coordinate transformation matrix calculation unit 33 receives the following coordinate transformation matrix from the calibration execution unit 31.
(a) Camera-corresponding coordinate transformation matrix (^{R}T_{C}) for transforming camera coordinate system (Σ_{C}) of camera 11 into robot coordinate system (Σ_{R}).
(b) Depth camera-corresponding coordinate transformation matrix (^{R}T_{D}) for transforming depth camera coordinate system (Σ_{D}) of depth camera 12 into robot coordinate system (Σ_{R}).
(c) LiDAR compatible coordinate transformation matrix (^{R}T_{L}) for transforming LiDAR coordinate system (Σ_{L}) of LiDAR 13 into robot coordinate system (Σ_{R}).
(d) IMU-corresponding coordinate transformation matrix (^{R}T_{I}) for transforming IMU coordinate system (Σ_{I} of IMU 14 into robot coordinate system (Σ_{R})

The external coordinate-system corresponding coordinate transformation matrix calculation unit 33 further receives the following coordinate transformation matrix from the relative position calculation unit 32.
(e) Coordinate transformation matrix (^{S}T_{L}) for transforming LiDAR coordinate system (Σ_{L}) of LiDAR 13 into scanner coordinate system (Σ_{S}) of 3D scanner 20.

The external coordinate-system corresponding coordinate transformation matrix calculation unit 33 inputs the plurality of coordinate transformation matrices, and calculates a coordinate transformation matrix (^{S}T_{X}) for transforming the coordinate system (Σ_{X}) of each of the sensors 11 to 14 of the robot 10 into the scanner coordinate system (Σ_{S}).

Note that, for example, the coordinate transformation matrix (^{S}T_{C}) for transforming the camera coordinate system (Σ_{C}) corresponding to the camera 11 into the scanner coordinate system (Σ_{S}) can be calculated according to (Equation 5a) below.

$${}_{}^{S} {T}_{C}^{} = ( {}_{}^{S} {T}_{L}^{} ) {( {}_{}^{R} {T}_{L}^{} )}^{- 1} ( {}_{}^{R} {T}_{C}^{} ) \qquad ( Equation 5 a )$$

All of the coordinate transformation matrices shown on the right side of the above (Equation 5a) can be calculated on the basis of an input value from the relative position calculation unit 32 or the calibration execution unit 31 or an input value.

For example, the coordinate transformation matrix (^{S}T_{L}) is a coordinate transformation matrix (^{S}T_{L}) for transforming the LiDAR coordinate system (Σ_{L}) of the LiDAR 13 into the scanner coordinate system (Σ_{S}) of the 3D scanner 20, and is input from the relative position calculation unit 32.

Furthermore, (^{R}T_{L})⁻¹ is an inverse matrix of the coordinate transformation matrix (^{R}T_{L}), and can be calculated from the coordinate transformation matrix (^{R}T_{L}) input from the calibration execution unit 31, that is, the LiDAR correspondence coordinate transformation matrix (^{R}T_{L}) for transforming the LiDAR coordinate system (Σ_{L}) of the LiDAR 13 into the robot coordinate system (Σ_{R}).

Furthermore, the coordinate transformation matrix (^{R}T_{C}) is a camera-corresponding coordinate transformation matrix (^{R}T_{C}) for transforming the camera coordinate system (Σ_{C}) of the camera 11 into the robot coordinate system (Σ_{R}), and is input from the calibration execution unit 31.

As described above, the external coordinate-system corresponding coordinate transformation matrix calculation unit 33 calculates the coordinate transformation matrix (^{S}T_{C}) for transforming the camera coordinate system (Σ_{C}) into the scanner coordinate system (Σ_{S}) using the input value from the relative position calculation unit 32 or the calibration execution unit 31 or a matrix that can be calculated on the basis of the input value.

The external coordinate-system corresponding coordinate transformation matrix calculation unit 33 executes similar processing for each sensor mounted to the robot 10.

A coordinate transformation matrix (^{S}T_{D}) for transforming the depth camera coordinate system (Σ_{D}) corresponding to the depth camera 12 into the scanner coordinate system (Σ_{S}) is calculated according to (Equation 5b) below.

$${}_{}^{S} {T}_{D}^{} = ( {}_{}^{S} {T}_{L}^{} ) {( {}_{}^{R} {T}_{L}^{} )}^{- 1} ( {}_{}^{R} {T}_{D}^{} ) \qquad ( Equation 5 b )$$

All of the coordinate transformation matrices shown on the right side of the above (Equation 5b) can be calculated on the basis of an input value from the relative position calculation unit 32 or the calibration execution unit 31 or an input value.

The coordinate transformation matrix (^{S}T_{L}) for transforming the LiDAR coordinate system (Σ_{L}) corresponding to the LiDAR 13 into the scanner coordinate system (Σ_{S}) is input from the relative position calculation unit 32, and no new calculation processing by the external coordinate-system corresponding coordinate transformation matrix calculation unit 33 is necessary.

A coordinate transformation matrix (^{S}T_{I}) for transforming the IMU coordinate system (Σ_{I}) corresponding to the IMU 14 into the scanner coordinate system (Σ_{S}) is calculated according to (Equation 5c) below.

$${}_{}^{S} {T}_{I}^{} = ( {}_{}^{S} {T}_{L}^{} ) {( {}_{}^{R} {T}_{L}^{} )}^{- 1} ( {}_{}^{R} {T}_{I}^{} ) \qquad ( Equation 5 c )$$

All of the coordinate transformation matrices shown on the right side of the above (Equation 5c) can be calculated on the basis of an input value from the relative position calculation unit 32 or the calibration execution unit 31 or an input value.

As described above, the external coordinate-system corresponding coordinate transformation matrix calculation unit 33 calculates the coordinate transformation matrix (^{S}T_{X}) for transforming the coordinate system (Σ_{X}) of each of the sensors 11 to 14 of the robot 10 into the scanner coordinate system (Σ_{S}).

The coordinate transformation matrix (^{S}T_{X}) calculated by the external coordinate-system corresponding coordinate transformation matrix calculation unit 33, that is, the coordinate transformation matrix (^{S}T_{X}) for transforming the coordinate system (Σ_{X}) of each of the sensors 11 to 14 of the robot 10 into the scanner coordinate system (Σ_{S}) is input to the display information generation unit (visualized data generation unit) 34 of the calibration execution device 30 shown in FIG. 12.

The coordinate transformation matrix (^{S}T_{X}) calculated by the external coordinate-system corresponding coordinate transformation matrix calculation unit 33 is the following coordinate transformation matrix (^{S}T_{X}).
(a) Coordinate transformation matrix (^{S}T_{C}) for transforming camera coordinate system (Σ_{C}) of camera 11 into scanner coordinate system (Σ_{S}).
(b) Coordinate transformation matrix (^{S}T_{D}) for transforming depth camera coordinate system (Σ_{D}) of depth camera 12 into scanner coordinate system (Σ_{S}).
(c) Coordinate transformation matrix (^{S}T_{L}) for transforming LiDAR coordinate system (Σ_{L}) of LiDAR 13 into scanner coordinate system (Σ_{S}).
(d) Coordinate transformation matrix (ST) for transforming IMU coordinate system (Σ_{I}) of IMU 14 into scanner coordinate system (Σ_{S}).

These coordinate transformation matrices (^{S}T_{X}) calculated by the external coordinate-system corresponding coordinate transformation matrix calculation unit 33 are input to the display information generation unit (visualized data generation unit) 34 of the calibration execution device 30 shown in FIG. 12.

On the basis of the coordinate transformation matrices (^{S}T_{X}) calculated by the external coordinate-system corresponding coordinate transformation matrix calculation unit 33, the display information generation unit (visualized data generation unit) 34 generates a three-dimensional image showing coordinate axes (X axis, Y axis, Z axis) constituting the coordinate system (Σ_{X}) of each of the sensors 11 to 14 of the robot 10 on the scanner coordinate system (Σ_{S}), and outputs the three-dimensional image to the display unit 36 together with the three-dimensional image of the robot 10.

Note that the input unit 35 includes a mouse, a keyboard, and the like, and receives viewpoint information of a three-dimensional image drawn on the display unit 36 by the display information generation unit (visualized) data generation unit 34.

The display information generation unit (visualized data generation unit) 34 determines a viewpoint direction on the basis of the viewpoint information input from the input unit 35, and outputs three-dimensional image data of the robot 10 observed from the determined viewpoint direction to the display unit 36.

The three-dimensional image data of the robot 10 generated by the display information generation unit (visualized data generation unit) 34 and output to the display unit 36 is a three-dimensional image shown on the scanner coordinate system (Σ_{S}), and is an image in which coordinate axes (X axis, Y axis, Z axis) constituting the coordinate system (Σ_{X}) of each of the sensors 11 to 14 of the robot 10 are displayed in a superimposed manner together with the three-dimensional image of the robot 10.

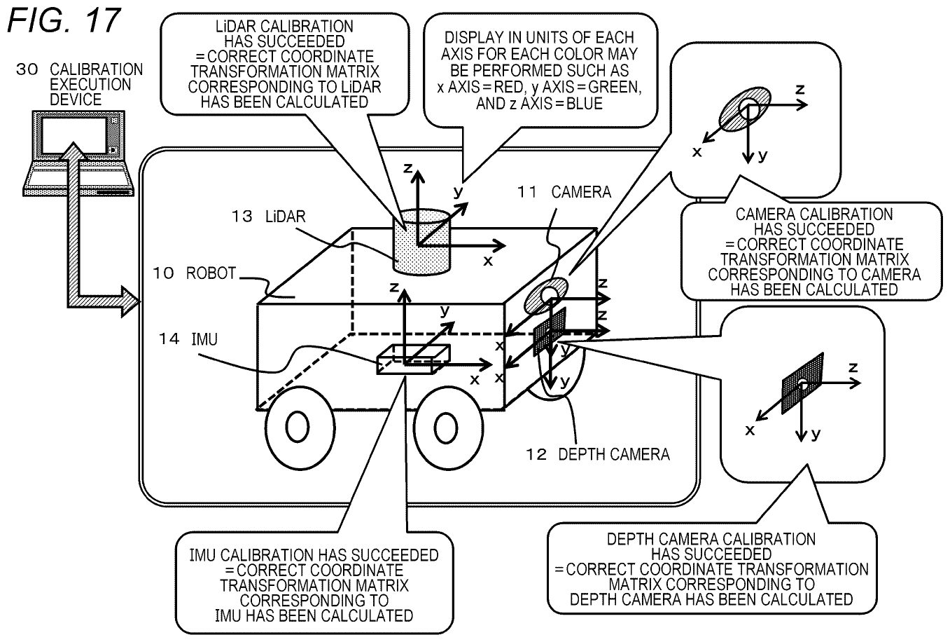

FIG. 17 shows an example of the display data generated by the display information generation unit (visualized data generation unit) 34 and output to the display unit 36.

The display unit 36 of the calibration execution device 30 displays, for example, a three-dimensional image of the robot 10 as shown in FIG. 17.

Note that the three-dimensional image of the robot 10 is configured by, for example, a point cloud indicating a three-dimensional image of an object such as the robot 10. The point cloud is a point cloud configured by detection information by the 3D scanner 20.

Note that the display data can be generated by applying a known computer graphics technology, for example, the configuration described in Non-Patent Document 7 (KamRyeol, et al. Hyeong. Rviz: a toolkit for real domain data visualization. Telecommunication Systems 60.2, 2015.).

Furthermore, as shown in FIG. 17, coordinate axes (X axis, Y axis, Z axis) constituting the coordinate system (Σ_{X}) of each of the sensors 11 to 14 of the robot 10 are displayed in a superimposed manner on the three-dimensional image of the robot 10.

The coordinate axes (X axis, Y axis, Z axis) constituting the coordinate system (Σ_{X}) of the robot 10 and each of the sensors 11 to 14 are data on the scanner coordinate system (Σ_{S}) corresponding to the 3D scanner 20.

The three-dimensional image on the scanner coordinate system (Σ_{S}) of the robot 10 is a three-dimensional image generated by scan processing (scanning processing) by the 3D scanner 20.

The three-dimensional image of the robot 10 also includes three-dimensional images of the respective sensors mounted to the robot 10, that is, the camera 11, the depth camera 12, the LIDAR 13, and the IMU 14. Note that, for the internal configuration of the robot 10 such as the IMU, for example, an IMU mounting position measured in advance by a user is input to the calibration execution device 30, and the display information generation unit 34 generates and outputs a three-dimensional image of the IMU 14 on the basis of the input information.

As shown in FIG. 17, the three-dimensional image of the robot 10 displayed on the display unit 36 also displays coordinate axes (X axis, Y axis, Z axis) constituting the sensor-corresponding coordinate system (Σ_{X}) of each sensor mounted on the robot 10, that is, the camera 11, the depth camera 12, the LiDAR 13, and the IMU 14.

Note that, for the coordinate axes (X axis, Y axis, Z axis) constituting the sensor-corresponding coordinate system (Σ_{X}), for example, identifiers indicating types of axes such as “X axis”, “Y axis”, and “Z axis” may be displayed in association with the respective axes. Furthermore, in order to make it easier to understand, a configuration in which different colors are set and displayed on each axis may be employed. For example, the X axis may be displayed in red, the Y axis may be displayed in green, and the Z axis may be displayed in blue.

The display information generation unit 34 acquires the coordinate axes (X axis, Y axis, Z axis) constituting the sensor-corresponding coordinate system (Σ_{X}) from the coordinate transformation matrix (^{S}T_{X}) calculated by the external coordinate-system corresponding coordinate transformation matrix calculation unit 33 described above.

As described above, the external coordinate-system corresponding coordinate transformation matrix calculation unit 33 calculates the following coordinate transformation matrix (^{S}T_{X}) and outputs the same to the display information generation unit 34.
(a) Coordinate transformation matrix (^{S}T_{C}) for transforming camera coordinate system (Σ_{C}) of camera 11 into scanner coordinate system (Σ_{S}).
(b) Coordinate transformation matrix (^{S}T_{D}) for transforming depth camera coordinate system (Σ_{D}) of depth camera 12 into scanner coordinate system (Σ_{S}).
(c) Coordinate transformation matrix (^{S}T_{L}) for transforming LiDAR coordinate system (Σ_{L}) of LiDAR 13 into scanner coordinate system (Σ_{S}).
(d) Coordinate transformation matrix (^{S}T_{I}) for transforming IMU coordinate system (Σ_{I}) of IMU 14 into scanner coordinate system (Σ_{S}).

For example, “(a) Coordinate transformation matrix (^{S}T_{C}) for transforming camera coordinate system (Σ_{C}) of camera 11 into scanner coordinate system (Σ_{S})”

Similarly to (Equation 1) and (Equation 1b) described above, this coordinate transformation matrix (^{S}T_{C}) can be shown as (Equation 1c) below.

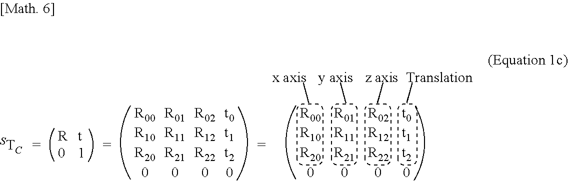

As described above with reference to (Equation 1) and (Equation 1b) and further FIG. 14,
in the above-described matrix of four rows and four columns, the upper left three rows and three columns are a rotation matrix representing an angle, and the upper right three rows and one column are a matrix representing translation.

Specifically, as described above with reference to FIG. 14,
(a) (R₀₀, R₁₀, R₂₀) is the X-axis direction of the sensor coordinate system (Σ_{X}) to be transformed,
(b) (R₀₁, R₁₁, R₂₁) indicates the Y-axis direction of the sensor coordinate system (Σ_{X}) to be transformed,
(c) (R₀₂, R₁₂, R₂₂) indicates the Z-axis direction of the sensor coordinate system (Σ_{X}) to be transformed,
(d) (t₀, t₁, t₂) is an origin position coordinate of the sensor coordinate system (Σ_{X}) to be transformed, and
note that each direction of the coordinate axes (X axis, Y axis, Z axis) shown in (a) to (d) above and the origin position are the direction and the coordinate position in the scanner coordinate system (Σ_{S}) which is the coordinate system after the coordinate transformation.

As described above, the coordinate axes (X axis, Y axis, Z axis) constituting the camera coordinate system (Σ_{C}) of the camera 11 can be acquired from the coordinate transformation matrix (^{S}T_{C}) calculated by the external coordinate-system corresponding coordinate transformation matrix calculation unit 33 described above.

The similarity applies to the other sensor-corresponding coordinate system (Σ_{X}), and the display information generation unit 34 acquires the coordinate axes (X axis, Y axis, Z axis) constituting the sensor-corresponding coordinate system (Σ_{X}) of the camera 11, the depth camera 12, the LiDAR 13, and the IMU 14 from the coordinate transformation matrix (^{S}T_{X}) calculated by the external coordinate-system corresponding coordinate transformation matrix calculation unit 33 described above.

Each direction of the coordinate axes (X axis, Y axis, Z axis) constituting the sensor-corresponding coordinate system (Σ_{X}) and the origin position are a direction and a coordinate position in the scanner coordinate system (Σ_{S}) which is the coordinate system after the coordinate transformation.

Therefore, as shown in FIG. 17, coordinate axis display of the sensor-corresponding coordinate system (Σ_{X}) becomes possible.

Note that the display example shown in FIG. 17 is a coordinate axis display example in a case where the calibration processing executed by the calibration execution unit 31 has succeeded and a correct coordinate transformation matrix has been calculated.

For example, in the camera coordinate system (Σ_{C}) of the camera 11, the origin is set at the lens position of the camera 11 mounted on the robot 10 shown in FIG. 17, and the Z axis is set in the front optical axis direction of the camera 11, the Y axis is set on the lower side, and the X axis is set in the right direction.

The origin position and the direction of each coordinate axis are a result of correctly displaying the camera coordinate system (Σ_{C}).

As described above, the fact that the camera coordinate system (Σ_{C}) is displayed at the center position of the camera 11 in the three-dimensional image means that the calibration processing executed by the calibration execution unit 31 has succeeded and a correct coordinate transformation matrix has been calculated.

As described above, the calibration execution unit 31 inputs the sensor detection information and the like from each of the sensors 11 to 14 of the robot 10, and executes the following calculation processing of the coordinate transformation matrix corresponding to each sensor. For example, the calculation processing of the camera-corresponding coordinate transformation matrix (^{R}T_{C}) for transforming the camera coordinate system (Σ_{C}) of the camera 11 into the robot coordinate system (Σ_{R}) is executed.

If the camera-corresponding coordinate transformation matrix (^{R}T_{C}) has been calculated correctly, the calculation equation of the coordinate transformation matrix (^{S}T_{C}) described above with reference to (Equation 5a), that is,

$${}_{}^{S} {T}_{C}^{} = ( {}_{}^{S} {T}_{L}^{} ) {( {}_{}^{R} {T}_{L}^{} )}^{- 1} ( {}_{}^{R} {T}_{C}^{} ) \qquad ( Equation 5 a )$$

The origin and coordinate axes (X axis, Y axis, Z axis) of the camera coordinate system (Σ_{C}) determined by the matrix elements of the coordinate transformation matrix (^{S}T_{C}) for transforming the camera coordinate system (Σ_{C}) into the scanner coordinate system (Σ_{S}) are correctly calculated.

As a result, the camera coordinate system (Σ_{C}) shown in FIG. 17 displays the correct camera coordinate system (Σ_{C}) in which the origin is set at the lens position of the camera 11 of the robot 10, the Z axis is set in the front optical axis direction of the camera 11, the Y axis is set on the lower side, and the X axis is set in the right direction.

In the other sensor coordinate systems shown in FIG. 17, that is, the depth camera coordinate system (Σ_{D}) of the depth camera 12, the LiDAR coordinate system (Σ_{L}) of the LiDAR 13, and the IMU coordinate system (Σ_{I}) of the IMU 14, the origin is set at a correct position, and the coordinate axes are set in a correct direction.

The user can confirm that the calibration processing in the calibration execution unit 31 has succeeded by confirming these display images.

That is, it is possible to confirm that the calculation processing of the coordinate transformation matrix corresponding to each of the following sensors executed by the calibration execution unit 31 has succeeded.
(a) Calculation processing of camera-corresponding coordinate transformation matrix (^{R}T_{C}) for transforming camera coordinate system (Σ_{C}) of camera 11 into robot coordinate system (Σ_{R})
(b) Calculation processing of depth camera-corresponding coordinate transformation matrix (^{R}T_{D}) for transforming depth camera coordinate system (Ep) of depth camera 12 into robot coordinate system (Σ_{R})
(c) Calculation processing of LiDAR compatible coordinate transformation matrix (^{R}T_{L}) for transforming LiDAR coordinate system (Σ_{I}) of LiDAR 13 into robot coordinate system (Σ_{R})
(d) Calculation processing of IMU-corresponding coordinate transformation matrix (^{R}T_{I}) for transforming IMU coordinate system (Er) of IMU 14 into robot coordinate system (Σ_{R})

However, for example, in a case where the calibration processing by the calibration execution unit 31, that is, the coordinate transformation matrix generation processing fails and the correct coordinate transformation matrix cannot be calculated, display different from the display of the sensor-corresponding coordinate system (Σ_{X}) as shown in FIG. 17 is performed.

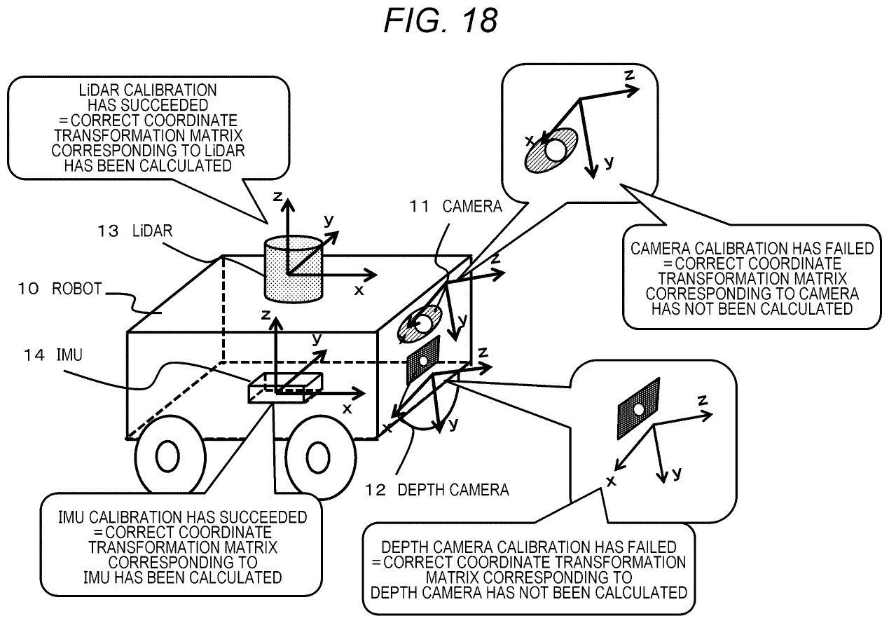

FIG. 18 shows a display example in a case where the coordinate transformation matrix generation processing by the calibration execution unit 31 fails and a correct coordinate transformation matrix cannot be calculated.

In the camera coordinate system (Σ_{C}) shown in FIG. 18, there is no origin at the lens position of the camera 11 of the robot 10, and the origin is set at a position shifted from the camera 11. In addition, coordinate axes which should originally have the Z axis set in the front optical axis direction of the camera 11, the Y axis set on the lower side, and the X axis set in the right direction are inclined.

This is a display that is clearly different from the correct camera coordinate system (Σ_{C}).

This means that the camera-corresponding coordinate transformation matrix (^{R}T_{C}) in the calibration execution unit 31 is not calculated correctly. As a result, the calculation equation of the coordinate transformation matrix (^{S}T_{C}) described above with reference to (Equation 5a), that is,

$${}_{}^{S} {T}_{C}^{} = ( {}_{}^{S} {T}_{L}^{} ) {( {}_{}^{R} {T}_{L}^{} )}^{- 1} ( {}_{}^{R} {T}_{C}^{} ) \qquad ( Equation 5 a )$$

This means that the origin and coordinate axes (X axis, Y axis, Z axis) of the camera coordinate system (Σ_{C}) determined by the matrix elements of the coordinate transformation matrix (^{S}T_{C}) for transforming the camera coordinate system (Σ_{C}) into the scanner coordinate system (Σ_{S}) are not correctly calculated.

In this way, in a case where the camera-corresponding coordinate transformation matrix (^{R}T_{C}) in the calibration execution unit 31 is not correctly calculated, the origin position of the camera coordinate system (Σ_{C}) and the direction of each coordinate axis are shifted and displayed as shown in FIG. 18.

In the display example shown in FIG. 18, the coordinate axes of the depth camera 12 are also at shifted positions, and it is confirmed that the depth camera-corresponding coordinate transformation matrix (^{R}T_{D}) in the calibration execution unit 31 is also not calculated correctly.

For the LiDAR 13 and the IMU 14, it is confirmed that the coordinate axes have correct positions and directions, and the calculation processing of the LiDAR correspondence coordinate transformation matrix (^{R}T_{L}) and the IMU correspondence coordinate transformation matrix (^{R}T_{I}) in the calibration execution unit 31 has succeeded.

As described above, the display unit 36 of the calibration execution device 30 of the present disclosure displays an image in which the coordinate system (Σ_{X}) corresponding to each sensor on the scanner coordinate system (Σ_{S}) is displayed in a superimposed manner in addition to the three-dimensional image of the robot 10 shown on the scanner coordinate system (Σ_{S}).

The user checks the origin position of the coordinate system (Σ_{X}) of each of the sensors 11 to 14 displayed together with the three-dimensional image of the robot 10 and the direction (inclination) of the seating axis, which allows the user to determine whether or not the calibration processing in the calibration execution unit 31, that is, the calculation processing of the sensor-corresponding mark transformation matrix (^{R}T_{X}) has succeeded.

Note that, as described above, the display information generation unit (visualized data generation unit) 34 determines a viewpoint direction on the basis of the viewpoint information input from the input unit 35, and outputs three-dimensional image data of the robot 10 observed from the determined viewpoint direction to the display unit 36.

The user can operate the viewpoint from the input unit 35 to observe the relative positional relationship between the point cloud indicating the three-dimensional image of the object such as the robot 10 and the sensor coordinate transformation matrix in a desired direction and at a desired enlargement ratio.

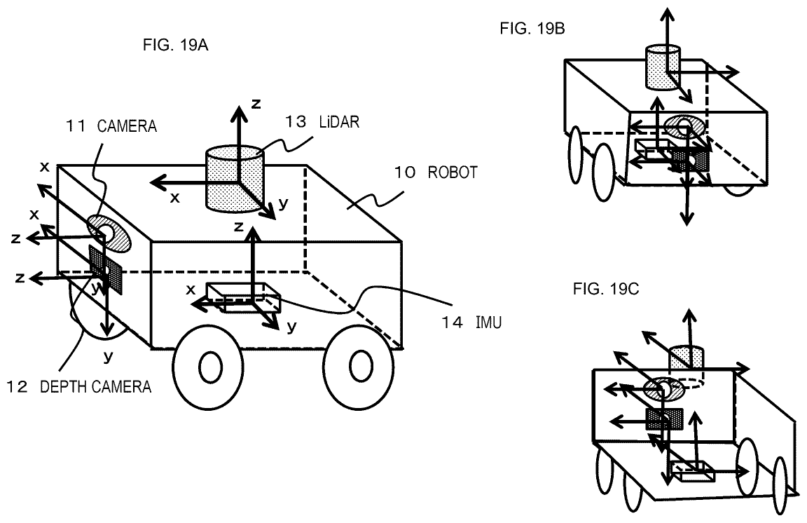

FIG. 19 shows an example of the display image of the display unit 36 in a case where the viewpoint position is changed.

FIG. 19(a) is an example of a display image of the robot 10 observed from the right side front direction.

FIG. 19(b) is an example of a display image of the robot 10 observed from the front left side surface direction.

FIG. 19(c) is an example of a display image of the robot 10 observed from the lower side of the front right side surface.

As described above, the user can observe the three-dimensional image in which the housing of the robot 10 and the coordinate transformation matrices of the sensors are superimposed from various directions, and can intuitively confirm whether or not calibration is successful, that is, whether or not a correct coordinate transformation matrix (^{R}T_{X}) has been calculated, from these images.

Note that, in the above-described embodiment, the embodiment has been described in which the external coordinate-system corresponding coordinate transformation matrix calculation unit 33 of the calibration execution device 30 shown in FIG. 12 calculates the coordinate transformation matrix (^{S}T_{X}) for transforming the coordinate system (Σ_{X}) of each of the sensors 11 to 14 of the robot 10 into the scanner coordinate system (Σ_{S}).

That is, this is an embodiment in which the display information generation unit (visualized data generation unit) 34 generates a three-dimensional image in which coordinate axes (X axis, Y axis, Z axis) constituting the coordinate system (Σ_{X}) of each of the sensors 11 to 14 of the robot 10 are shown on the scanner coordinate system (Σ_{S}) on the basis of the coordinate transformation matrix (^{S}T_{X}) calculated by the external coordinate-system corresponding coordinate transformation matrix calculation unit 33, and outputs the three-dimensional image to the display unit 36 together with the three-dimensional image of the robot 10.

As described above, in the above-described embodiment, the “coordinate transformation matrix” is used as a method of expressing the coordinate system, the position, and the posture of the sensors. However, the method of expressing the coordinate system, the position, and the posture of the sensors is not limited to the “coordinate transformation matrix”, and other methods may be applied.

For example, as a method of expressing a coordinate system, a position, and a posture of sensors, a method of expressing these in a quaternion set with three numbers of translation and rotation expressed by four numbers is known.

There is also a method using Euler angles representing three numbers of translation and rotation expressed by three numbers. The Euler angle is a method generally used in a Robot Operating System (ROS) or the like.

In addition, for example, as a method often used in the field of computer vision, there is also a method of expressing three numbers of translation and rotation with a total of six degrees of freedom represented by rotation vectors of three numbers.

Note that the quaternion, the rotation matrix of the coordinate transformation matrix, the rotation vector, and the Euler angle can be transformed with each other.

As described above, there are various methods for expressing the coordinate system, the position, and the posture of the sensors, and it is also possible to apply these other methods instead of the “coordinate transformation matrix” used in the above-described embodiment.

### 3. (Second Embodiment) Configuration and Processing of Calibration Execution Device that Executes Online Calibration

Next, as a second embodiment, a configuration and processing of a calibration execution device that executes online calibration will be described.

The first embodiment described above has been described as an embodiment in which the sensor-corresponding coordinate transformation matrix (^{R}T_{X}) unique to the robot is calculated and used because there are individual differences of the robot 10, that is, machining accuracy of components of each robot, assembly accuracy at the time of assembly, individual differences unique to the sensor, and the like.

However, when the robot 10 travels, vibration or the like associated with traveling may occur, and positional deviation or inclination may also occur in sensors mounted to the robot, that is, sensors such as the camera 11, the depth camera 12, the LiDAR 13, and the IMU 14.

As described above, when the position shift or inclination of the sensor occurs during the travel of the robot 10, even if the sensor-corresponding coordinate transformation matrix (^{R}T_{X}) unique to the robot calculated according to the first embodiment is used, correct coordinate transformation may not be executed during the travel of the robot 10.

The second embodiment described below is an embodiment in which the update processing of the sensor-corresponding coordinate transformation matrix (^{R}T_{X}) is sequentially executed online during the travel of the robot 10.

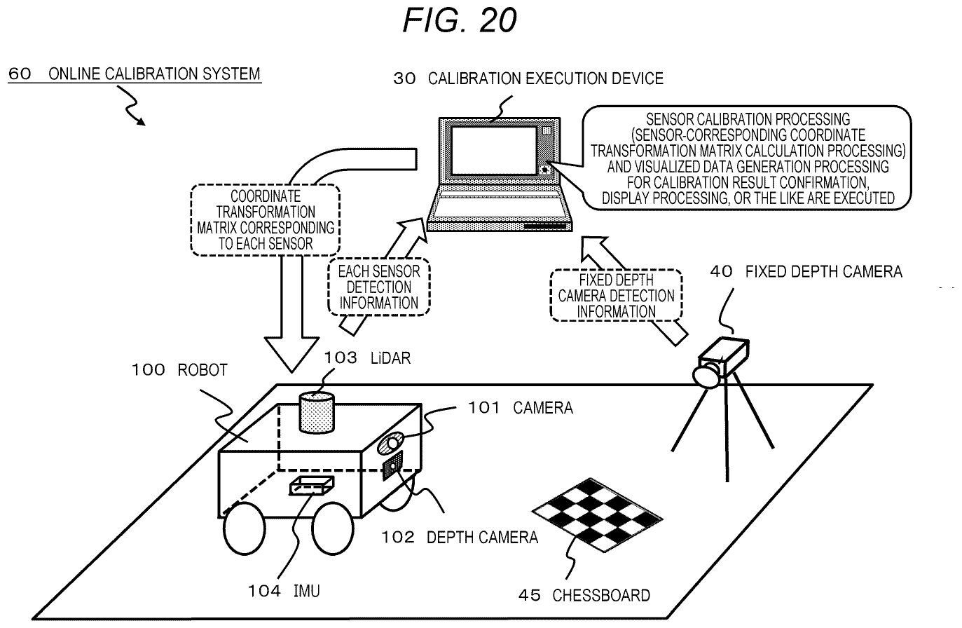

FIG. 20 shows a configuration example of an online calibration system 60 including the calibration execution device 30 of the present second embodiment.

The online calibration system 60 shown in FIG. 20 is a system including a robot 100, a fixed depth camera 40, and a calibration execution device 30.

A chessboard 45 is attached to the traveling surface of the robot 100.

The chessboard 45 is configured by a regular black-and-white pattern.

The robot 100 is an autonomous mobile robot, and is equipped with a plurality of sensors. Note that the robot 100 is an example of a mobile device of the present disclosure, and the mobile device of the present embodiment also includes various mobile bodies such as an automated driving vehicle in addition to the robot.

The fixed depth camera 40 measures a distance (depth) to surrounding objects. The fixed depth camera 40 may be configured to incorporate a color camera. In this case, color information can also be acquired in addition to the distance information. Note that a type that outputs the reflectance of the subject as an image may be used instead of the color camera.

The robot 100 is a robot similar to the robot of the first embodiment described above, and is a robot that analyzes the surrounding environment on the basis of the sensor detection information and performs autonomous movement.

As shown in FIG. 20, the robot 100 is mounted with a plurality of different sensors 101 to 104. That is, a camera 101, a depth camera 102, a LiDAR 103, an IMU 104, and these sensors are mounted.

Similarly to that described in the first embodiment, each of the sensors 101 to 104 mounted to the robot 100 shown in FIG. 20 calculates a sensor detection value based on a coordinate system unique to the sensor, for example, a coordinate position of an obstacle on the basis of the coordinate system unique to the sensor.

The calibration execution device 30 can be configured by, for example, a data processing device such as a PC.

The calibration execution device 30 has a configuration capable of communicating with the robot 100 and the fixed depth camera 40.

The calibration execution device 30 receives sensor detection information of each of the sensors 101 to 104 mounted to the robot 100, and further receives fixed depth camera detection information such as distance information from the fixed depth camera 40.

The calibration execution device 30 executes calibration processing of each of the sensors 11 to 14 mounted to the robot 100 on the basis of these pieces of input information. Specifically, processing of calculating a coordinate transformation matrix corresponding to the sensor is executed. The coordinate transformation matrix corresponding to the sensor is a coordinate transformation matrix for transforming position coordinates on the coordinate system unique to the sensor into position coordinates on the robot coordinate system.

The calibration execution device 30 further generates display data, which is visualized data for calibration result confirmation enabling visual confirmation as to whether or not the coordinate transformation matrix calculated as the calibration result has been correctly calculated, and outputs the display data to the display unit.

The visualized data for calibration result confirmation is image data that enables confirmation as to whether or not the coordinate transformation matrix corresponding to the sensor has been correctly calculated. A specific example of the image data will be described later.

As shown in FIG. 20, the calibration execution device 30 receives detection information of each sensor from the robot 100, and further receives fixed depth camera detection information (distance information of surrounding objects) from the fixed depth camera 40.

The calibration execution device 30 executes calibration processing of calculating a coordinate transformation matrix corresponding to each sensor of the robot 100 using these pieces of input information.

The coordinate transformation matrix corresponding to each sensor calculated as the calibration processing result executed by the calibration execution device 30 is transmitted to the robot 100 and stored in the storage unit in the robot 100.

When performing autonomous movement, the robot 100 transforms position coordinates on the coordinate system unique to each sensor into position coordinates on the robot coordinate system using the coordinate transformation matrix corresponding to the sensor stored in the storage unit, analyzes the relative position of the surrounding obstacle with respect to the robot 100 on the basis of the position coordinates on the robot coordinate system after the transformation, and selects a traveling route to avoid collision or contact with the obstacle to perform autonomous movement.

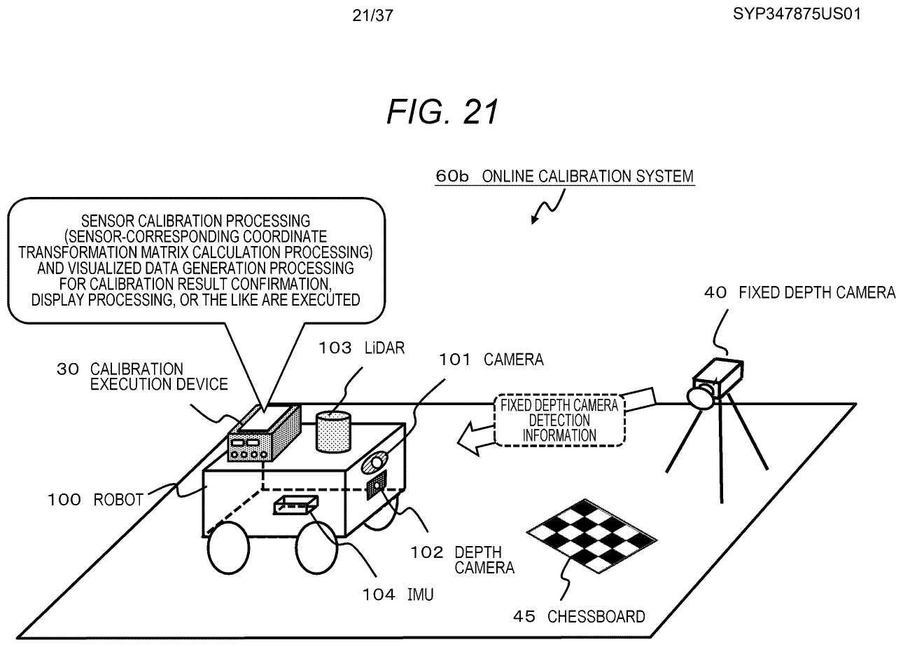

Note that, although the online calibration system 60 shown in FIG. 20 is an example of a system in which the robot 100 and the calibration execution device 30 are configured as separate devices, for example, as shown in FIG. 21, an online calibration system 60b in which the robot 100 and the calibration execution device 30 are integrated may be configured.

In the configuration shown in FIG. 21, the calibration execution device 30 in the robot 100 executes calibration processing for calculating a coordinate transformation matrix corresponding to each sensor mounted to the robot 100.

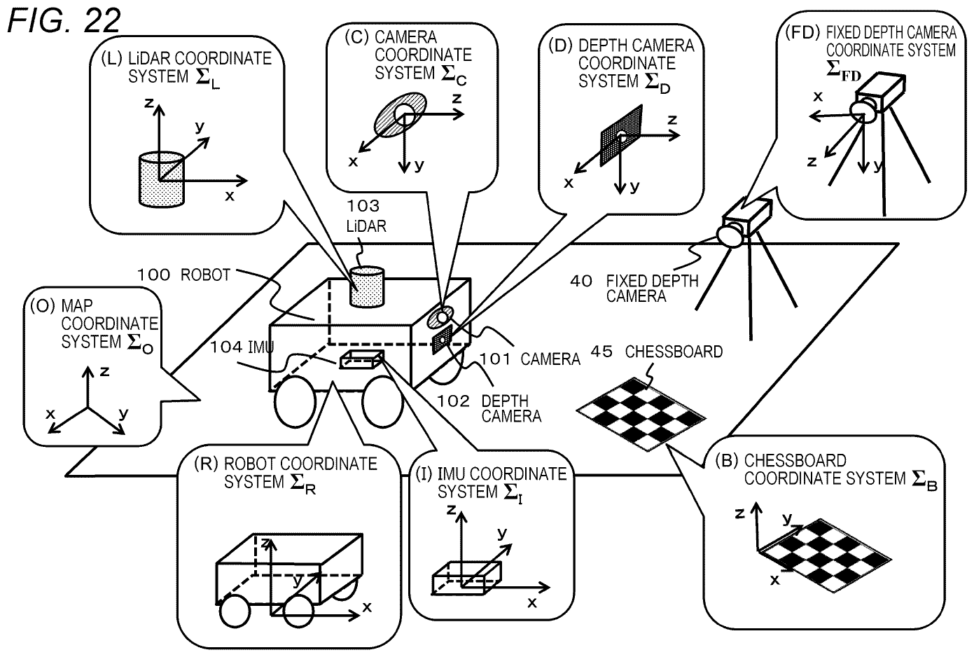

Next, sensors mounted to the robot 100, that is, the camera 101, the depth camera 102, the LiDAR 103, the IMU 104, a sensor coordinate system which is a coordinate system of each of these sensors, a robot coordinate system of the robot 100, a fixed depth camera coordinate system which is a coordinate system of the fixed depth camera 40, a chessboard coordinate system of the chessboard 45, and a map coordinate system will be described with reference to FIG. 22.

FIG. 22 shown the following coordinate systems.
(R) Robot coordinate system (Σ_{R})
(C) Camera coordinate system (Σ_{C})
(D) Depth camera coordinate system (Σ_{D})
(L) LiDAR coordinate system (Σ_{L})
(I) IMU coordinate system (Σ_{I})
(FD) Fixed depth camera coordinate system (Σ_{FD})
(B) Chessboard coordinate system (Σ_{B})
(O) Map coordinate system (Σ_{O})

(R) The robot coordinate system (Σ_{R}) is, for example, a coordinate system in which an intersection point between a perpendicular line from a center position of the robot 100 and a robot ground contact surface is set as an origin, a front side of the robot 100 is set as an X axis, a left side surface direction is set as a Y axis, and an upper direction is set as a Z axis.

(C) The camera coordinate system (Σ_{C}) is, for example, a coordinate system in which a lens position of the camera 11 is set as an origin, a front optical axis direction of the camera 11 is set as a Z axis, a lower side surface direction is set as a Y axis, and a right direction is set as an X axis.

(D) The depth camera coordinate system (Σ_{D}) is, for example, a coordinate system in which a gravity center position of the depth camera 12 is set as an origin, a front optical axis direction of the depth camera 12 is set as a Z axis, a lower side direction is a Y axis, and a right direction is set as an X axis.

(L) The LiDAR coordinate system (Σ_{L}) is, for example, a coordinate system in which a gravity center position of the LIDAR 13 is set as an origin, a front side of the LiDAR10 is set as an X axis, a left side surface direction is set as a Y axis, and an upper direction is set as a Z axis.

(I) The IMU coordinate system (Σ_{I}) is, for example, a coordinate system in which a gravity center position of the IMU 14 is set as an origin, a front side of the IMU10 is set as an X axis, a left side surface direction is set as a Y axis, and an upper direction is set as a Z axis.

(FD) The fixed depth camera coordinate system (Σ_{FD}) is a coordinate system in which a lens position of the fixed depth camera 40 is set as an origin, a front optical axis direction of the fixed depth camera 40 is set as a Z axis, a lower side surface direction is set as a Y axis, and a right direction is set as an X axis.

(B) The chessboard coordinate system (Σ_{B}) is a coordinate system in which one vertex of the chessboard 45 is set as an origin, orthogonal axes of a robot traveling surface are set as X and Y axes, and an axis extending vertically upward is set as a Z axis.

(O) The map coordinate system (Σ_{O}) is a reference coordinate used in a case where the robot 100 estimates the self-position. In the present second embodiment, the robot 100 calculates the position (self-position) of the robot 100 on the map coordinate system (Σ_{O}), and travels along a travel route set on the map coordinate system (Σ_{O}).

As shown in FIG. 22, the robot coordinate system of the robot 100, the coordinate system of each sensor, the fixed depth camera, the chessboard, and the coordinate system of the map coordinate are different from each other.

Similarly to that described in the first embodiment above, for example, each sensor of the robot 100 acquires the coordinate position of the obstacle using the coordinate system unique to each sensor.

For example, the depth camera 102 calculates a coordinate position of the obstacle in the camera coordinate system (Ep) as the position of the obstacle.

The robot 100 performs control to calculate a coordinate position of the obstacle on the robot coordinate system (Σ_{R}) and the map coordinate system (Σ_{O}) on the basis of the coordinate position of the obstacle in the depth camera coordinate system (Σ_{D}), acquire a distance and a direction from the robot 100 to the obstacle, and select and travel a travel route on which the robot 10 does not come into contact with the obstacle.

As described above, the coordinate transformation matrix (T) is used for the coordinate transformation processing.

For example, a coordinate transformation matrix ^{R}T_{D} is used in a coordinate transformation processing of transforming the coordinate position (x_{D}, y_{D}, z_{D}) of a certain point P in the depth camera coordinate system (Σ_{D}) in the space into the coordinate position (x_{R}, y_{R}, z_{R}) in the robot coordinate system (Σ_{R}).

Similarly, a coordinate transformation matrix ^{R}T_{L} is used for the coordinate transformation processing of transforming the coordinate position (x_{L}, y_{L}, z_{L}) of the point P in the LiDAR coordinate system (Σ_{L}) into the coordinate position (x_{R}, y_{R}, z_{R}) of the robot coordinate system (Σ_{R}).

However, as described above, when a positional deviation or inclination of the sensor occurs during the travel of the robot 100, a fixed coordinate transformation matrix cannot be used and needs to be sequentially corrected. The calibration execution device 30 shown in FIGS. 20 and 21 sequentially corrects such a coordinate transformation matrix, that is, executes online or vibration.

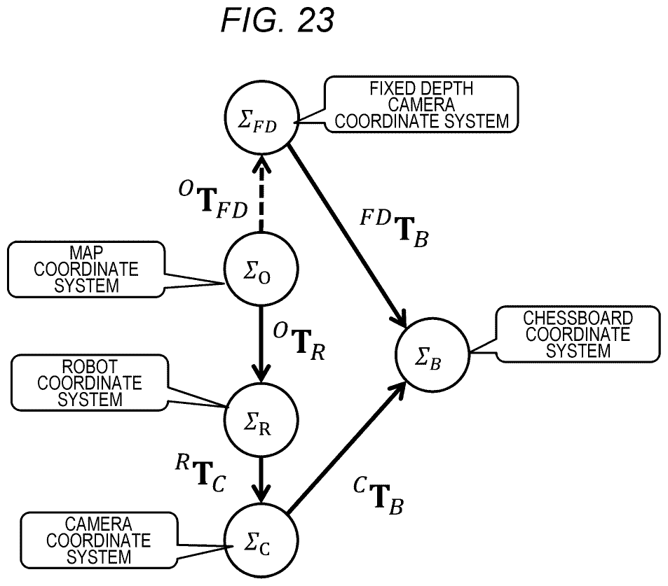

FIG. 23 shows an example of the relationship between the coordinate system and the coordinate transformation matrix used in the present second embodiment.

In the present second embodiment, a necessary coordinate transformation matrix is a coordinate transformation matrix (^{O}T_{FD}) indicated by a dashed arrow.

The coordinate transformation matrix (^{O}T_{FD}) is a coordinate transformation matrix for transforming the fixed depth camera coordinate system (Σ_{FD}) of the fixed depth camera 40 into a map coordinate system (Σ_{O}).

In order to calculate the coordinate transformation matrix (^{O}T_{FD}), the following plurality of coordinate transformation matrices is used as shown in FIG. 23. That is,
(1) Coordinate transformation matrix (^{FD}T_{B}) for transforming chessboard coordinate system (Σ_{B}) into fixed depth camera coordinate system (Σ_{FD})
(2) Coordinate transformation matrix (^{C}T_{B}) for transforming chessboard coordinate system (Σ_{B}) into camera coordinate system (Στ)
(3) Coordinate transformation matrix (^{R}T_{C}) for transforming camera coordinate system (Σ_{C}) into robot coordinate system (Σ_{R})
(4) Coordinate transformation matrix (^{O}T_{R}) for transforming robot coordinate system (Σ_{R}) into map coordinate system (Σ_{O})

Specifically, the coordinate transformation matrix (^{O}T_{FD}) for transforming the fixed depth camera coordinate system (Σ_{FD}) into a map coordinate system (Σ_{O}) can be calculated according to (Equation 6) below.

$${{(}^{O} {T}_{F D} ) = {(}^{O} {T}_{R} ) {(}^{R} {T}_{C} ) {(}^{C} {T}_{B} ) {(}^{F D} {T}_{B} )}^{- 1} \qquad ( Equation 6 )$$

According to the above equation, the coordinate transformation matrix (^{O}T_{FD}) for transforming the fixed depth camera coordinate system (Σ_{FD}) into a map coordinate system (Σ_{O}) can be calculated.

Next, the coordinate transformation matrix (^{FD}T_{R}) for transforming the robot coordinate system (Σ_{R}) into the fixed depth camera coordinate system (Σ_{FD}) is calculated according to (Equation 7) below using the coordinate transformation matrix (^{O}T_{FD}) calculated according to the (Equation 6).

$${(}^{F D} {T}_{R} ) = {(}^{F D} {T}_{O} ) {(}^{O} {T}_{R} ) \qquad ( Equation 7 )$$

Note that, in the above (Equation 7), the coordinate transformation matrix (^{O}T_{R}) is a coordinate transformation matrix for transforming the robot coordinate system (Σ_{R}) into the map coordinate system (Σ_{O}).

Note that, in order to improve the accuracy of the relative position calculation, for example, it is effective to improve the accuracy of
(1) Coordinate transformation matrix (^{FD}T_{B}) for transforming chessboard coordinate system (Σ_{B}) into fixed depth camera coordinate system (Σ_{FD}), and
(2) Coordinate transformation matrix (^{C}T_{B}) for transforming chessboard coordinate system (Σ_{B}) into camera coordinate system (Σ_{C}).

For this purpose, for example, processing of photographing the chessboard 45 by the camera 101 of the robot 100 and the fixed depth camera 40 a plurality of times, executing averaging processing of the photographed images, and the like, and calculating two types of coordinate transformation matrices (^{FD}T_{B}) and (^{C}T_{B}) is effective.

In addition, results obtained by using several chessboards having different sizes may be averaged. In addition, the reference used for alignment is not limited to a chessboard, and an existing marker such as an AR marker, a QR code (registered trademark), an ArUco marker, or a spherical marker may be used.

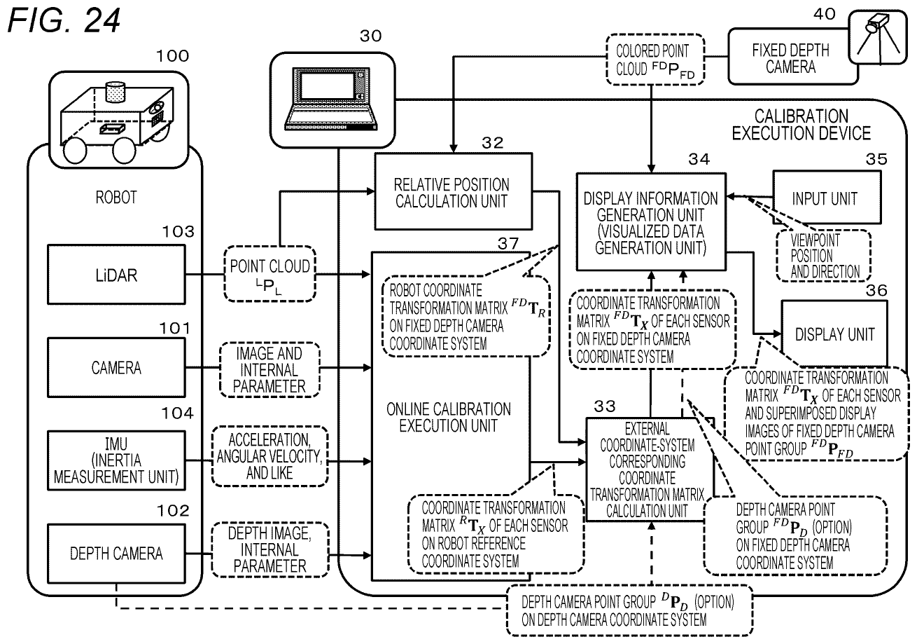

FIG. 24 is a diagram for explaining a detailed configuration of the calibration execution device 30 of the present second embodiment.

FIG. 24 shows a detailed configuration of the calibration execution device 30 and data input from the robot 100 and the fixed depth camera 40 by the calibration execution device 30.

As shown in FIG. 24, the calibration execution device 30 includes an online calibration execution unit 37, a relative position calculation unit 32, an external coordinate-system corresponding coordinate transformation matrix calculation unit 33, a display information generation unit (visualized data generation unit) 34, an input unit 35, and a display unit 36.

The calibration execution device 30 of the second embodiment has a configuration in which the calibration execution unit 31 of the calibration execution device 30 described above with reference to FIG. 12 in the first embodiment is replaced with the online calibration execution unit 37.

Note that FIG. 24 shows the camera 101, the depth camera 102, the LiDAR 103, and the IMU 104 as the sensors 101 to 104 mounted to the robot 100.

The online calibration execution unit 37 of the calibration execution device 30 calculates a coordinate transformation matrix of each of the sensors 101 to 104 mounted to the robot 100.

That is, the online calibration execution unit 37 inputs each sensor detection information and the like from each of the sensors 101 to 104 of the robot 100, and executes the calculation processing of the coordinate transformation matrix corresponding to each sensor.

The calculation processing of the coordinate transformation matrix corresponding to the sensor is similar to the processing of the first embodiment described above.

The online calibration execution unit 37 inputs each sensor detection information and the like from each of the sensors 101 to 104 of the robot 100, and executes the following calculation processing of a coordinate transformation matrix corresponding to each sensor.
(a) Calculation processing of camera-corresponding coordinate transformation matrix (^{R}T_{C}) for transforming camera coordinate system (Σ_{C}) of camera 11 into robot coordinate system (Σ_{R})
(b) Calculation processing of depth camera-corresponding coordinate transformation matrix (^{R}T_{D}) for transforming depth camera coordinate system (Σ_{D}) of depth camera 12 into robot coordinate system (Σ_{R})
(c) Calculation processing of LiDAR compatible coordinate transformation matrix (^{R}T_{L}) for transforming LiDAR coordinate system (Σ_{L}) of LiDAR 13 into robot coordinate system (Σ_{R})
(d) Calculation processing of IMU-corresponding coordinate transformation matrix (^{R}T_{I}) for transforming IMU coordinate system (Σ_{I}) of IMU 14 into robot coordinate system (Σ_{R})

The relative position calculation unit 32 executes alignment processing between the fixed depth camera coordinate system (Σ_{FD}) of the fixed depth camera 40 and the robot coordinate system (Σ_{R}) of the robot 10 to calculate a coordinate transformation matrix (^{FD}T_{R}) for transforming the robot coordinate system (CR) into the fixed depth camera coordinate system (Σ_{FD}).

The coordinate transformation matrix (^{FD}T_{R}) calculated by the relative position calculation unit 32 is input to the external coordinate-system corresponding coordinate transformation matrix calculation unit 33.

Next, processing executed by the external coordinate-system corresponding coordinate transformation matrix calculation unit 33 in the calibration execution device 30 shown in FIG. 24 will be described.

The external coordinate-system corresponding coordinate transformation matrix calculation unit 33 receives the following coordinate transformation matrix from the online calibration execution unit 37.
(a) Camera-corresponding coordinate transformation matrix (^{R}T_{C}) for transforming camera coordinate system (Σ_{C}) of camera 11 into robot coordinate system (Σ_{R}).
(b) Depth camera-corresponding coordinate transformation matrix (^{R}T_{D}) for transforming depth camera coordinate system (Σ_{D}) of depth camera 12 into robot coordinate system (Σ_{R}).
(c) LiDAR compatible coordinate transformation matrix (^{R}T_{L}) for transforming LiDAR coordinate system (Σ_{L}) of LiDAR 13 into robot coordinate system (Σ_{R}).
(d) IMU-corresponding coordinate transformation matrix (^{R}T_{I}) for transforming IMU coordinate system (Σ_{I}) of IMU 14 into robot coordinate system (Σ_{R})

The external coordinate-system corresponding coordinate transformation matrix calculation unit 33 further receives the following coordinate transformation matrix from the relative position calculation unit 32.
(e) Coordinate transformation matrix (^{FD}T_{R}) for transforming robot coordinate system (Σ_{R}) into fixed depth camera coordinate system (Σ_{FD})

The external coordinate-system corresponding coordinate transformation matrix calculation unit 33 inputs the plurality of coordinate transformation matrices, and calculates a coordinate transformation matrix (^{FD}T_{X}) for transforming the coordinate system (Σ_{X}) of each of the sensors 101 to 104 of the robot 100 into the fixed depth camera coordinate system (Σ_{FD}).

Note that, for example, the coordinate transformation matrix (^{FD}T_{C}) for transforming the camera coordinate system (Σ_{C}) corresponding to the camera 101 into the fixed depth camera coordinate system (Σ_{FD}) can be calculated according to (Equation 8) below.

$${F D}^{} {T}_{C} = {(}^{F D} {T}_{R} ) {(}^{R} {T}_{C} ) \qquad ( Equation 8 )$$

All of the coordinate transformation matrices shown on the right side of (Equation 8) above can be calculated on the basis of an input value from the relative position calculation unit 32 or the online calibration execution unit 37 or an input value.

For example, the coordinate transformation matrix (^{FD}T_{R}) is a coordinate transformation matrix (^{FD}T_{R}) for transforming the robot coordinate system (Σ_{R}) into the fixed depth camera coordinate system (Σ_{FD}), and is input from the relative position calculation unit 32.

Further, (^{R}T_{C}) is a camera-corresponding coordinate transformation matrix (^{R}T_{C}) for transforming the camera coordinate system (Σ_{C}) of the camera 11 into the robot coordinate system (Σ_{R}), and is input from the online calibration execution unit 37.

As described above, the external coordinate-system corresponding coordinate transformation matrix calculation unit 33 calculates the coordinate transformation matrix (^{FD}T_{X}) for transforming the coordinate system (Σ_{X}) of each of the sensors 101 to 104 of the robot 100 into the fixed depth camera coordinate system (Σ_{FD}) using an input value from the relative position calculation unit 32 or the online calibration execution unit 37 or a matrix that can be calculated on the basis of the input value.

The coordinate transformation matrix (^{FD}T_{X}) calculated by the external coordinate-system corresponding coordinate transformation matrix calculation unit 33, that is, the coordinate transformation matrix (^{FD}T_{X}) for transforming the coordinate system (Σ_{X}) of each of the sensors 101 to 104 of the robot 100 into the fixed depth camera coordinate system (Σ_{FD}) is input to the display information generation unit (visualized data generation unit) 34 of the calibration execution device 30 shown in FIG. 24.

Note that the coordinate transformation matrix (^{FD}T_{X}) calculated by the external coordinate-system corresponding coordinate transformation matrix calculation unit 33 is the following coordinate transformation matrix (^{FD}T_{X}).
(a) Coordinate transformation matrix (^{FD}T_{C}) for transforming camera coordinate system (Σ_{C}) of camera 101 into fixed depth camera coordinate system (Σ_{FD}).
(b) Coordinate transformation matrix (^{FD}T_{D}) for transforming depth camera coordinate system (Σ_{D}) of depth camera 102 into fixed depth camera coordinate system (Σ_{FD}).
(c) Coordinate transformation matrix (^{FD}T_{L}) for transforming LiDAR coordinate system (Σ_{L}) of LiDAR 103 into fixed depth camera coordinate system (Σ_{FD}).
(d) Coordinate transformation matrix (^{FD}T_{I}) for transforming IMU coordinate system (Σ_{I}) of IMU 104 into fixed depth camera coordinate system (Σ_{FD}).

These coordinate transformation matrices (^{FD}T_{X}) calculated by the external coordinate-system corresponding coordinate transformation matrix calculation unit 33 are input to the display information generation unit (visualized data generation unit) 34 of the calibration execution device 30 shown in FIG. 24.

On the basis of the coordinate transformation matrices (^{FD}T_{X}) calculated by the external coordinate-system corresponding coordinate transformation matrix calculation unit 33, the display information generation unit (visualized data generation unit) 34 generates a three-dimensional image showing coordinate axes (X axis, Y axis, Z axis) constituting the coordinate system (Σ_{X}) of each of the sensors 101 to 104 of the robot 100 on the fixed depth camera coordinate system (Σ_{FD}), and outputs the three-dimensional image to the display unit 36 together with the three-dimensional image of the robot 100.

Note that the input unit 35 includes a mouse, a keyboard, and the like, and receives viewpoint information of a three-dimensional image drawn on the display unit 36 by the display information generation unit (visualized) data generation unit 34.

The display information generation unit (visualized data generation unit) 34 determines a viewpoint direction on the basis of the viewpoint information input from the input unit 35, and outputs three-dimensional image data of the robot 10 observed from the determined viewpoint direction to the display unit 36.

The three-dimensional image data of the robot 100 generated by the display information generation unit (visualized data generation unit) 34 and output to the display unit 36 is a three-dimensional image shown on the fixed depth camera coordinate system (Σ_{FD}), and is an image in which coordinate axes (X axis, Y axis, Z axis) constituting the coordinate system (Σ_{X}) of each of the sensors 101 to 104 of the robot 100 are displayed in a superimposed manner together with the three-dimensional image of the robot 100.

The display image is an image similar to the images shown in FIGS. 17 to 19 described above in the first embodiment.

Also in the present second embodiment, in addition to the three-dimensional image of the robot 100 shown on the fixed depth camera coordinate system (Σ_{FD}), an image in which the coordinate system (Σ_{X}) corresponding to each sensor on the fixed depth camera coordinate system (Σ_{FD}) is displayed in a superimposed manner is displayed on the display unit 36 of the calibration execution device 30.

The user confirms the origin position of the coordinate system (Σ_{X}) of each of the sensors 101 to 104 displayed together with the three-dimensional image of the robot 100 and the direction (inclination) of the seating axis, so that the user can determine whether or not the calibration processing in the online calibration execution unit 37, that is, the calculation processing of the sensor-corresponding mark transformation matrix (^{R}T_{X}) has succeeded.

### 4. (Third Embodiment) Configuration and Processing of Calibration Execution Device that Executes Online Calibration Using Observation Information of Another Mobile Device

Next, as a third embodiment, a configuration and processing of a calibration execution device that executes online calibration using observation information of another mobile device will be described.

In the present third embodiment, for example, in an environment in which a plurality of robots operates in cooperation, one robot executes online calibration, and further verifies the correctness of a result of the online calibration using a camera of another robot.

In the present third embodiment, a coordinate transformation matrix of a camera of a certain robot for which online calibration has been performed is displayed in a superimposed manner on a point cloud (three-dimensional image) obtained from a depth camera mounted on another robot, and correctness of the coordinate transformation matrix of the camera obtained by the online calibration is verified.

Note that, in the present third embodiment, relative position information between the robots is required, but in the third embodiment, relative positions and angles between a plurality of robots are calculated using self-position estimation information executed by each robot. For example, when a plurality of robots performs position estimation on a map of the same coordinate system, the position information is used.

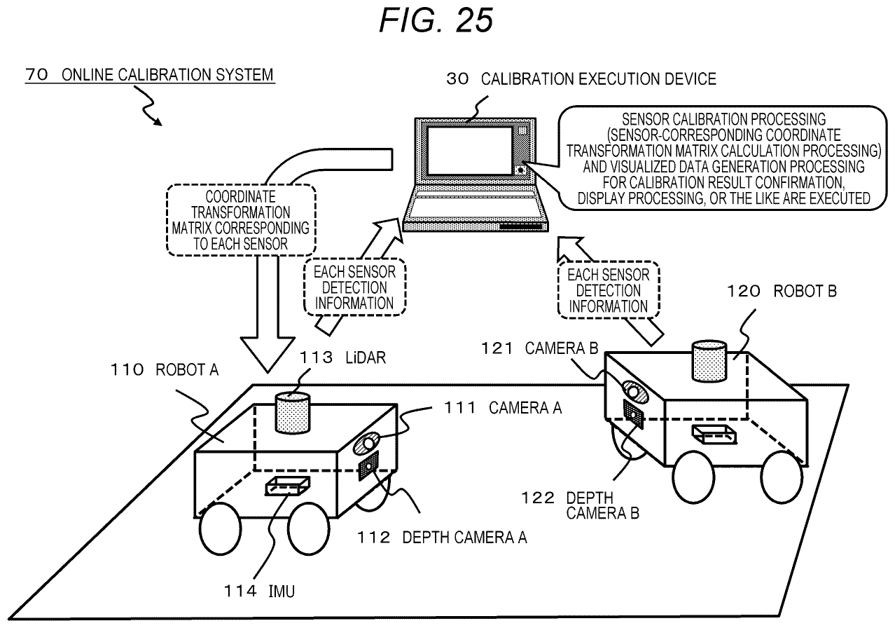

FIG. 25 shows a configuration example of an online calibration system 70 including the calibration execution device 30 of the present third embodiment.

The online calibration system 70 shown in FIG. 25 is a system including a robot A 110, a robot B 120, and the calibration execution device 30.

Each of the robot A 110 and the robot B 120 is an autonomous mobile robot, and is equipped with a plurality of sensors.

The robot A 110 and the robot B 120 are robots similar to the robot of the first embodiment described above, and are robots that analyze the surrounding environment on the basis of sensor detection information and perform autonomous movement.

As shown in FIG. 25, the robot A 110 is mounted with a plurality of different sensors 111 to 114. That is, a camera A 111, a depth camera A 112, a LiDAR 113, an IMU 114, and these sensors are mounted.

The robot B 120 is mounted with a camera B 121 and a depth camera B 122.

Similarly to that described in the first embodiment, each of the sensors mounted to the robot A 110 and the robot B 120 shown in FIG. 25 calculates a sensor detection value based on a coordinate system unique to the sensor, for example, a coordinate position of an obstacle on the basis of the coordinate system unique to the sensor.

The calibration execution device 30 can be configured by, for example, a data processing device such as a PC.

The calibration execution device 30 has a configuration capable of communicating with the robot A 110 and the robot B 120.

The calibration execution device 30 receives sensor detection information of each sensor mounted to the robot A 110 and the robot B 120.

The calibration execution device 30 executes calibration processing of each of the sensors 111 to 114 mounted to the robot A 110 on the basis of these pieces of input information. Specifically, processing of calculating a coordinate transformation matrix corresponding to the sensor is executed. The coordinate transformation matrix corresponding to the sensor is a coordinate transformation matrix for transforming position coordinates on the coordinate system unique to the sensor into position coordinates on the robot coordinate system.

The calibration execution device 30 further generates display data, which is visualized data for calibration result confirmation enabling visual confirmation as to whether or not the coordinate transformation matrix calculated as the calibration result has been correctly calculated, and outputs the display data to the display unit.

The visualized data for calibration result confirmation is image data that enables confirmation as to whether or not the coordinate transformation matrix corresponding to the sensor has been correctly calculated. A specific example of the image data will be described later.

As shown in FIG. 25, the calibration execution device 30 receives detection information of each sensor from the robot A 110 and the robot B 120.

The calibration execution device 30 executes calibration processing of calculating a coordinate transformation matrix corresponding to each sensor of the robot A 110 using these pieces of input information.

The coordinate transformation matrix corresponding to each sensor calculated as the calibration processing result executed by the calibration execution device 30 is stored in the storage unit in the robot A 110.

When performing autonomous movement, the robot A 110 transforms position coordinates on the coordinate system unique to each sensor into position coordinates on the robot coordinate system using the coordinate transformation matrix corresponding to the sensor stored in the storage unit, analyzes the relative position of the surrounding obstacle with respect to the robot A 110 on the basis of the position coordinates on the robot coordinate system after the transformation, and selects a traveling route to avoid collision or contact with the obstacle to perform autonomous movement.

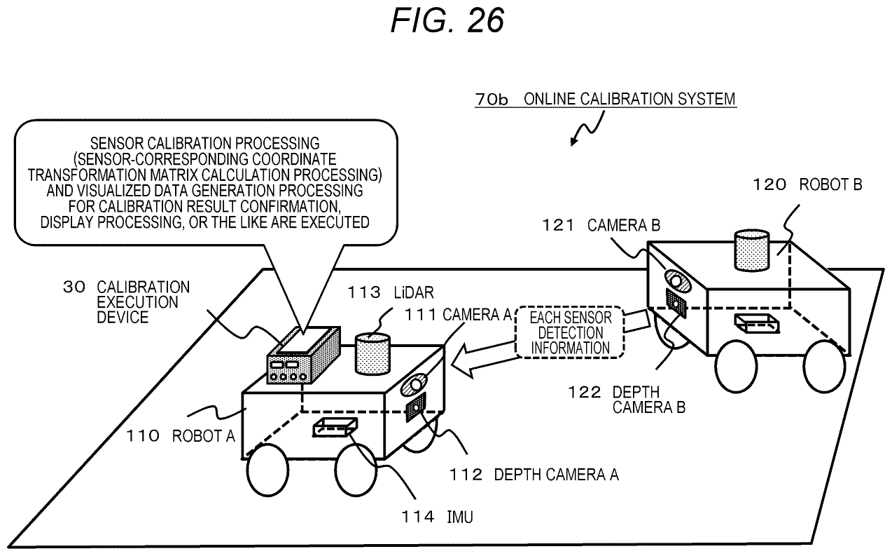

Note that, although the online calibration system 70 shown in FIG. 25 is an example of a system in which the robot A 110 and the calibration execution device 30 are configured as separate devices, for example, as shown in FIG. 26, an online calibration system 70b in which the robot A 110 and the calibration execution device 30 are integrated may be configured.

In the configuration shown in FIG. 26, the calibration execution device 30 in the robot A 110 executes calibration processing for calculating a coordinate transformation matrix corresponding to each sensor mounted to the robot A 110.

The sensors mounted to the robot A 110, that is, the camera A 111, the depth camera A 112, the LiDAR 113, the IMU 114, the sensor coordinate system which is the coordinate system of each of these sensors, and the robot coordinate system and the coordinate system of the robot A 110 are coordinate systems similar to the coordinate system described above with reference to FIG. 22 in the second embodiment.

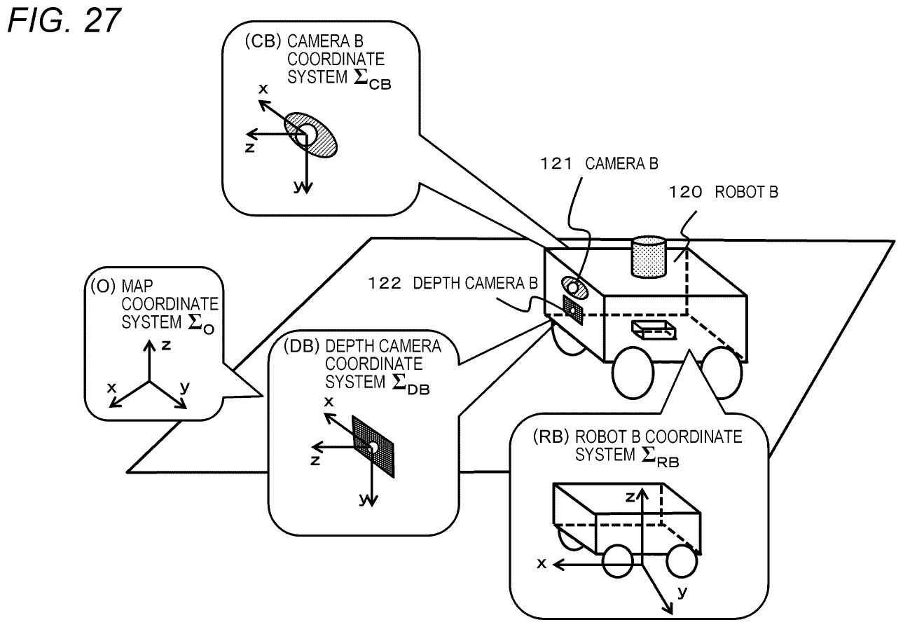

FIG. 27 shows the camera B 121 and the depth camera B 122 mounted on the robot B 120, a sensor coordinate system which is a coordinate system of each of these sensors, a robot B coordinate system of the robot B 120, and a map coordinate system.

(RB) The robot B coordinate system (Σ_{RB}) is, for example, a coordinate system in which an intersection of a perpendicular line from a center position of the robot B 120 and a robot ground contact surface is set as an origin, a front side of the robot B 120 is set as an X axis, a left side surface direction is set as a Y axis, and an upper direction is set as a Z axis.

(CB) The camera B coordinate system (Σ_{CB}) is, for example, a coordinate system in which a lens position of the camera B 121 is set as an origin, a front optical axis direction of the camera B 121 is set as a Z axis, a lower side direction is set as a Y axis, and a right direction is set as an X axis.

(DB) The depth camera B coordinate system (Σ_{DB}) is, for example, a coordinate system in which a gravity center position of the depth camera B 122 is set as an origin, a front optical axis direction of the depth camera B 122 is set as a Z axis, a lower side surface direction is set as a Y axis, and a right direction is set as an X axis.

(O) The map coordinate system (Σ_{O}) is a reference coordinate used in a case where the robot 100 estimates the self-position. In the present third embodiment, the robot 100 calculates the position (self-position) of the robot 100 on the map coordinate system (Σ_{O}), and travels along a travel route set on the map coordinate system (Σ_{O}).

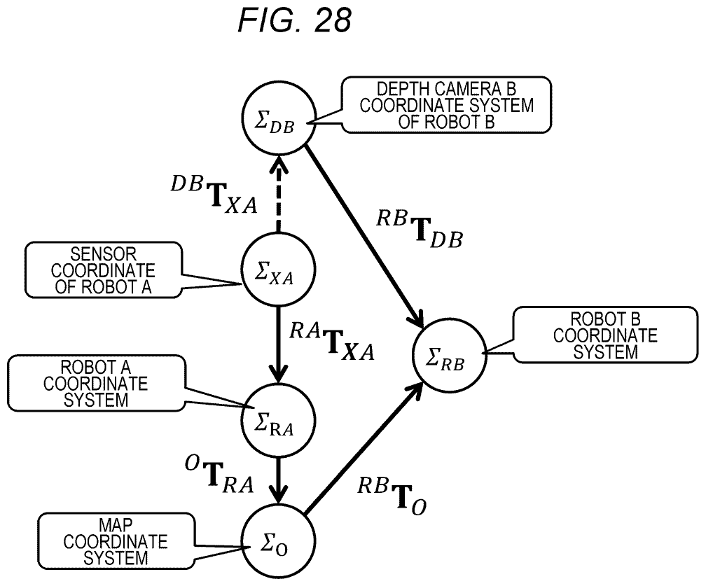

FIG. 28 shows an example of the relationship between the coordinate system and the coordinate transformation matrix used in the present third embodiment.

In the present third embodiment, a processing example using the depth camera B 122 of the robot B and a processing example using the camera B 121 of the robot B can be executed.

A coordinate transformation matrix necessary in the processing example using the depth camera B 122 of the robot B 120 is a coordinate transformation matrix (^{DB}T_{XA}) indicated by a dashed arrow.

The coordinate transformation matrix (^{DB}T_{XA}) is a coordinate transformation matrix for transforming the sensor coordinate system (Σ_{XA}) of the robot A into the depth camera B coordinate system (Σ_{DB}) of the robot B.

In order to calculate the coordinate transformation matrix (^{DB}T_{XA}), the following plurality of coordinate transformation matrices is used as shown in FIG. 28. That is,
(1) Coordinate transformation matrix (^{RB}T_{DB}) for transforming depth camera B coordinate system (Σ_{DB}) of robot B into robot B coordinate system (Σ_{RB})
(2) Coordinate transformation matrix (^{RB}T_{O}) for transforming map coordinate system (Σ_{O}) into robot B coordinate system (Σ_{RB})
(3) Coordinate transformation matrix (^{O}T_{RA}) for transforming robot A coordinate system (Σ_{RA}) into map coordinate system (Σ_{O})
(4) Coordinate transformation matrix (^{RA}T_{XA}) for transforming sensor coordinate system (Σ_{XA}) of robot A into robot A coordinate system (Σ_{RA})

Specifically, the coordinate transformation matrix (^{DB}T_{XA}) for transforming the sensor coordinate system (Σ_{XA}) of the robot A into the depth camera B coordinate system (Σ_{DB}) of the robot B can be calculated according to (Equation 9) below.

$${{{(}^{D B} {T}_{XA} ) = {(}^{R B} {T}_{D B} )}^{- 1} {(}^{O} {T}_{R B} )}^{- 1} {(}^{O} {T}_{RA} ) {(}^{RA} {T}_{XA} ) \qquad ( Equation 9 )$$

According to the above equation, the coordinate transformation matrix (^{DB}T_{XA}) for transforming the sensor coordinate system (Σ_{XA}) of the robot A into the depth camera B coordinate system (Σ_{DB}) of the robot B 120 can be calculated.

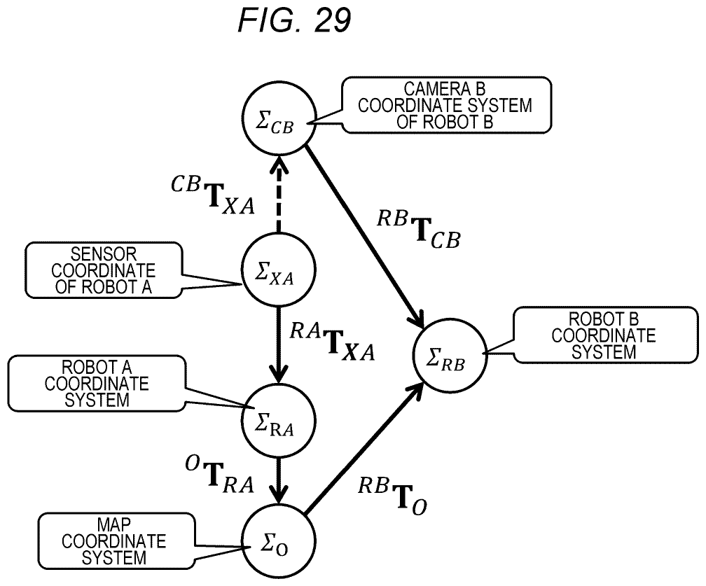

On the other hand, a coordinate transformation matrix required in the processing example using the camera B 121 of the robot B 120 is a coordinate transformation matrix (^{CB}T_{XA}) indicated by a dashed arrow shown in FIG. 29.

The coordinate transformation matrix (^{CB}T_{XA}) is a coordinate transformation matrix for transforming the sensor coordinate system (Σ_{XA}) of the robot A into the camera B coordinate system (Σ_{CB}) of the robot B.

In order to calculate the coordinate transformation matrix (^{CB}T_{XA}), the following plurality of coordinate transformation matrices is used as shown in FIG. 29. That is,
(1) Coordinate transformation matrix (^{RB}T_{CB}) for transforming camera B coordinate system (Σ_{CB}) of robot B into robot B coordinate system (Σ_{RB}).
(2) Coordinate transformation matrix (^{RB}T_{O}) for transforming map coordinate system (Σ_{O}) into robot B coordinate system (Σ_{RB})
(3) Coordinate transformation matrix (^{O}T_{RA}) for transforming robot A coordinate system (Σ_{RA}) into map coordinate system (Σ_{O})
(4) Coordinate transformation matrix (^{RA}T_{XA}) for transforming sensor coordinate system (Σ_{XA}) of robot A into robot A coordinate system (Σ_{RA})

Specifically, the coordinate transformation matrix (^{CB}T_{XA}) for transforming the sensor coordinate system (Σ_{XA}) of the robot A into the camera B coordinate system (Σ_{CB}) of the robot B can be calculated according to (Equation 10) below.

$${{{(}^{C B} {T}_{XA} ) = {(}^{R B} {T}_{C B} )}^{- 1} {(}^{O} {T}_{R B} )}^{- 1} {(}^{O} {T}_{RA} ) {(}^{RA} {T}_{XA} ) \qquad ( Equation 10 )$$

According to the above equation, the coordinate transformation matrix (^{CB}T_{XA}) for transforming the sensor coordinate system (Σ_{XA}) of the robot A into the camera B coordinate system (Σ_{CB}) of the robot B 120 can be calculated.

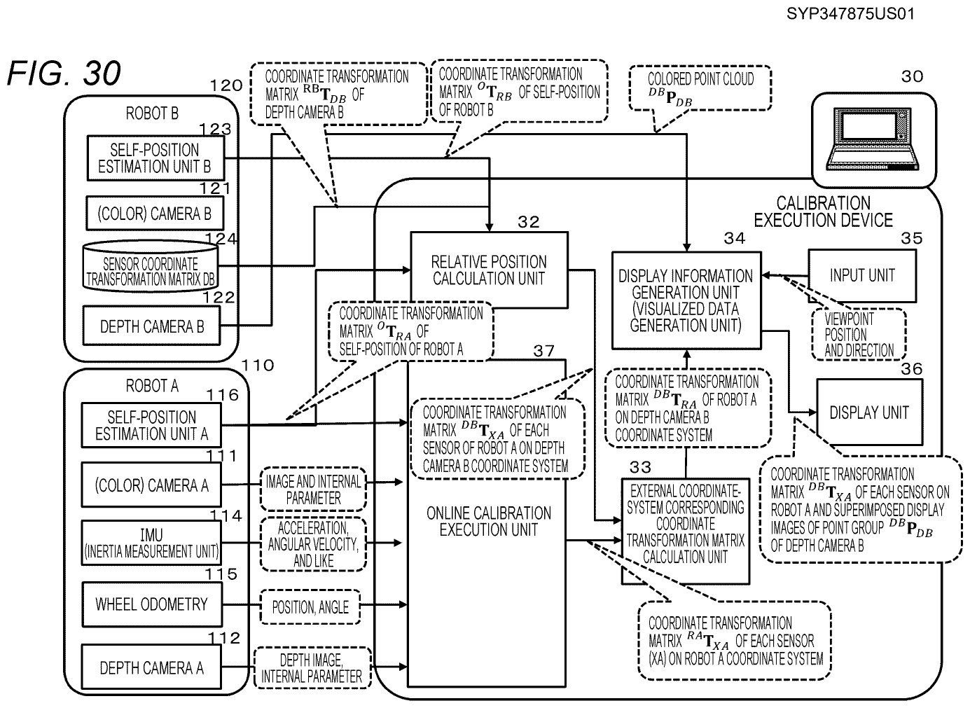

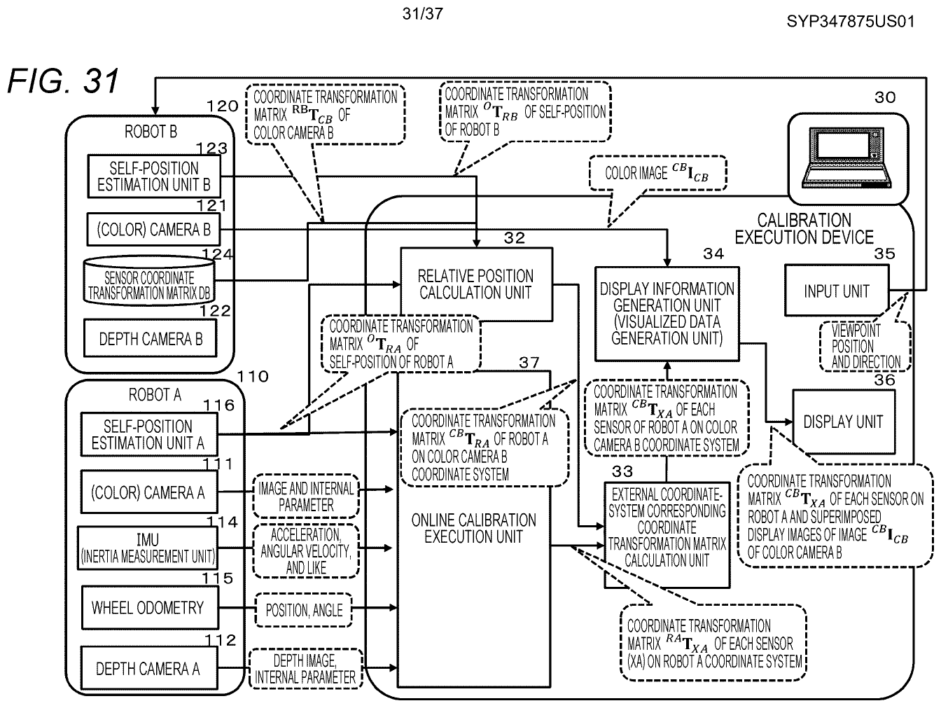

Next, a detailed configuration of the calibration execution device 30 of the present third embodiment will be described with reference to FIGS. 30 and 31.

Note that FIG. 30 is a diagram for explaining a processing example using the depth camera B 122 of the robot B 120.

FIG. 31 is a diagram for explaining a processing example using the camera B 121 of the robot B 120.

First, a processing example using the depth camera B 122 of the robot B 120 will be described with reference to FIG. 30.

FIG. 30 shows a detailed configuration of the calibration execution device 30 and data input from the robot A 110 and the robot B 120 by the calibration execution device 30.

As shown in FIG. 30, the calibration execution device 30 includes an online calibration execution unit 37, a relative position calculation unit 32, an external coordinate-system corresponding coordinate transformation matrix calculation unit 33, a display information generation unit (visualized data generation unit) 34, an input unit 35, and a display unit 36.

The calibration execution device 30 of the third embodiment has a configuration similar to the calibration execution device 30 described above with reference to FIG. 24 in the second embodiment.

Note that FIG. 30 shows a (color) camera A 111, a depth camera A 112, an IMU 114, a wheel odometry 115, and a self-position estimation unit 116 as the configuration of the robot A 110.

Furthermore, as the configuration of the robot B 120, a (color) camera B 121, a depth camera B 122, a self-position estimation unit 123, and a sensor coordinate transformation matrix DB (database) 124 are shown.

The self-position estimation unit 116 of the robot A 110 calculates a coordinate transformation matrix (^{O}T_{RA}) necessary for calculating the self-position of the robot A 110 on the map coordinate system (Σ_{O}), that is, a coordinate transformation matrix (^{O}T_{RA}) for transforming the robot A coordinate system (Σ_{RA}) into the map coordinate system (Σ_{O}), and outputs the calculated coordinate transformation matrix (^{O}T_{RA}) to the online calibration execution unit 37 and the relative position calculation unit 32 of the calibration execution device 30.

Similarly, the self-position estimation unit 123 of the robot B 120 calculates a coordinate transformation matrix (^{O}T_{RB}) necessary for calculating the self-position of the robot B 120 on the map coordinate system (Σ_{O}), that is, a coordinate transformation matrix (^{O}T_{RB}) for transforming the robot B coordinate system (Σ_{RB}) into the map coordinate system (Σ_{O}), and outputs the calculated coordinate transformation matrix (^{O}T_{RB}) to the relative position calculation unit 32 of the calibration execution device 30.

The sensor coordinate transformation matrix DB (database) 124 of the robot B 120 stores the coordinate transformation matrix (^{RB}T_{DB}) for transforming the depth camera B coordinate system (Σ_{DB}) of the robot B 120 into the robot B coordinate system (Σ_{RB}), and outputs the coordinate transformation matrix (^{RB}T_{DB}) to the relative position calculation unit 32 of the calibration execution device 30.

The online calibration execution unit 37 of the calibration execution device 30 calculates a coordinate transformation matrix (^{RA}T_{XA}) of each of the sensors (AX) mounted to the robot A 110.

The processing of calculating the coordinate transformation matrix corresponding to the sensor (^{RA}T_{XA}) is similar to the processing of the first embodiment described above.

The relative position calculation unit 32 receives each of pieces of data below.
(1) Coordinate transformation matrix (^{O}T_{RA}) from self-position estimation unit 116 of robot A 110, that is, coordinate transformation matrix (^{O}T_{RA}) for transforming robot A coordinate system (Σ_{RA}) into map coordinate system (Σ_{O}).
(2) Coordinate transformation matrix (^{O}T_{RB}) from self-position estimation unit 123 of robot B 120, that is, coordinate transformation matrix (^{O}T_{RB}) for transforming robot B coordinate system (Σ_{RB}) into map coordinate system (Σ_{O}).
(3) Coordinate transformation matrix (^{RB}T_{DB}) from sensor coordinate transformation matrix DB (database) 124 of robot B 120, that is, coordinate transformation matrix (^{RB}T_{DB}) for transforming depth camera B coordinate system (Σ_{DB}) of robot B 120 into robot B coordinate system (Σ_{RB}).

The relative position calculation unit 32 inputs each of pieces of data below and calculates a coordinate transformation matrix (^{DB}T_{XA}) for transforming the sensor coordinate system (Σ_{XA}) of the robot A into the depth camera B coordinate system (Σ_{DB}) of the robot B.

The calculation processing of the coordinate transformation matrix (^{DB}T_{XA}) is executed according to (Equation 9) described above.

The coordinate transformation matrix (^{DB}T_{XA}) calculated by the relative position calculation unit 32, that is, the coordinate transformation matrix (^{DB}T_{XA}) for transforming the sensor coordinate system (Σ_{XA}) of the robot A into the depth camera B coordinate system (Σ_{DB}) of the robot B is input to the external coordinate-system corresponding coordinate transformation matrix calculation unit 33.

Next, processing executed by the external coordinate-system corresponding coordinate transformation matrix calculation unit 33 in the calibration execution device 30 shown in FIG. 30 will be described.

The external coordinate-system corresponding coordinate transformation matrix calculation unit 33 receives, from the online calibration execution unit 37, the coordinate transformation matrix (^{RA}T_{XA}) for transforming the sensor coordinate system (Σ_{XA}) of each sensor (XA) of the robot A 110 into the robot A coordinate system (Σ_{RA}).

Furthermore, the external coordinate-system corresponding coordinate transformation matrix calculation unit 33 receives, from the relative position calculation unit 32, the coordinate transformation matrix (^{DB}T_{XA}) for transforming the sensor coordinate system (Σ_{XA}) of each sensor (XA) of the robot A 110 into the depth camera B coordinate system (Σ_{DB}) of the robot B 120.

The external coordinate-system corresponding coordinate transformation matrix calculation unit 33 inputs the plurality of coordinate transformation matrices, and calculates a coordinate transformation matrix (^{DB}T_{RA}) for transforming the robot coordinate system (Σ_{RA}) of the robot A 110 into the depth camera B coordinate system (Σ_{DB}) of the robot B 120.

Note that the coordinate transformation matrix (^{DB}T_{RA}) for transforming the robot coordinate system (Σ_{RA}) of the robot A 110 into the depth camera B coordinate system (Σ_{DB}) of the robot B 120 can be calculated according to (Equation 11) below.

$${{(}^{D B} {T}_{RA} ) = {(}^{D B} {T}_{XA} ) {(}^{RA} {T}_{XA} )}^{- 1} \qquad ( Equation 11 )$$

All of the coordinate transformation matrices shown on the right side of (Equation 11) above can be calculated on the basis of an input value from the relative position calculation unit 32 or the online calibration execution unit 37 or an input value.

As described above, the external coordinate-system corresponding coordinate transformation matrix calculation unit 33 calculates a coordinate transformation matrix (^{DB}T_{RA}) for transforming the robot coordinate system (Σ_{RA}) of the robot A 110 into the depth camera B coordinate system (Σ_{DB}) of the robot B 120 using an input value from the relative position calculation unit 32 or the online calibration execution unit 37 or a matrix that can be calculated on the basis of the input value.

The coordinate transformation matrix (^{DB}T_{RA}) calculated by the external coordinate-system corresponding coordinate transformation matrix calculation unit 33, that is, the coordinate transformation matrix (^{DB}T_{RA}) for transforming the robot coordinate system (Σ_{RA}) of the robot A 110 into the depth camera B coordinate system (Σ_{DB}) of the robot B 120 is input to the display information generation unit (visualized data generation unit) 34 of the calibration execution device 30 shown in FIG. 30.

On the basis of the coordinate transformation matrix (^{DB}T_{RA}) calculated by the external coordinate-system corresponding coordinate transformation matrix calculation unit 33, that is, the coordinate transformation matrix (^{DB}T_{RA}) for transforming the robot coordinate system (Σ_{RA}) of the robot A 110 into the depth camera B coordinate system (Σ_{DB}) of the robot B 120, the display information generation unit (visualized data generation unit) 34 generates a three-dimensional image in which coordinate axes (X axis, Y axis, Z axis) constituting the coordinate system (Σ_{XA}) of each sensor of the robot A 110 are shown on the depth camera B coordinate system (Σ_{DB}) of the robot B 120, and outputs the three-dimensional image to the display unit 36 together with the three-dimensional image of the robot A 110.

Note that the input unit 35 includes a mouse, a keyboard, and the like, and receives viewpoint information of a three-dimensional image drawn on the display unit 36 by the display information generation unit (visualized) data generation unit 34.

The display information generation unit (visualized data generation unit) 34 determines a viewpoint direction on the basis of the viewpoint information input from the input unit 35, and outputs three-dimensional image data of the robot 10 observed from the determined viewpoint direction to the display unit 36.

The three-dimensional image data of the robot A 110 generated by the display information generation unit (visualized data generation unit) 34 and output to the display unit 36 is a three-dimensional image shown on the depth camera B coordinate system (Σ_{DB}) of the robot B 120, and is an image in which coordinate axes (X axis, Y axis, Z axis) constituting the coordinate system (Σ_{XA}) of each sensor of the robot A 110 are displayed in a superimposed manner together with the three-dimensional image of the robot A 110.

The display image is an image similar to the images shown in FIGS. 17 to 19 described above in the first embodiment.

Also in the present third embodiment, the display unit 36 of the calibration execution device 30 displays an image in which the coordinate system (Σ_{XA}) corresponding to each sensor on the depth camera B coordinate system (Σ_{DB}) of the robot B 120 is displayed in a superimposed manner together with the three-dimensional image of the robot A 110 shown on the depth camera B coordinate system (Σ_{DB}) of the robot B 120.

The user confirms the origin position of the coordinate system (Σ_{XA}) of each of the sensors displayed together with the three-dimensional image of the robot A 110 and the direction (inclination) of the seating axis, so that the user can determine whether or not the calibration processing in the online calibration execution unit 37, that is, the calculation processing of the sensor-corresponding mark transformation matrix (^{RA}T_{XA}) has succeeded.

Next, a processing example using the camera B 121 of the robot B 120 will be described with reference to FIG. 31.

FIG. 31 shows a detailed configuration of the calibration execution device 30 and data input from the robot A 110 and the robot B 120 by the calibration execution device 30.

As shown in FIG. 31, the calibration execution device 30 includes an online calibration execution unit 37, a relative position calculation unit 32, an external coordinate-system corresponding coordinate transformation matrix calculation unit 33, a display information generation unit (visualized data generation unit) 34, an input unit 35, and a display unit 36.

Similarly to FIG. 30, FIG. 31 also shows the (color) camera A 111, the depth camera A 112, the IMU 114, the wheel odometry 115, and the self-position estimation unit 116 as the configuration of the robot A 110.

Furthermore, as the configuration of the robot B 120, the (color) camera B 121, the camera B 121, the self-position estimation unit 123, and the sensor coordinate transformation matrix DB (database) 124 are shown.

The self-position estimation unit 116 of the robot A 110 calculates a coordinate transformation matrix (^{O}T_{RA}) necessary for calculating the self-position of the robot A 110 on the map coordinate system (Σ_{O}), that is, a coordinate transformation matrix (^{O}T_{RA}) for transforming the robot A coordinate system (Σ_{RA}) into the map coordinate system (Σ_{O}), and outputs the calculated coordinate transformation matrix (^{O}T_{RA}) to the online calibration execution unit 37 and the relative position calculation unit 32 of the calibration execution device 30.

Similarly, the self-position estimation unit 123 of the robot B 120 calculates a coordinate transformation matrix (^{O}T_{RB}) necessary for calculating the self-position of the robot B 120 on the map coordinate system (Σ_{O}), that is, a coordinate transformation matrix (^{O}T_{RB}) for transforming the robot B coordinate system (Σ_{RB}) into the map coordinate system (Σ_{O}), and outputs the calculated coordinate transformation matrix (^{O}T_{RB}) to the relative position calculation unit 32 of the calibration execution device 30.

The sensor coordinate transformation matrix DB (database) 124 of the robot B 120 stores the coordinate transformation matrix (^{RB}T_{CB}) for transforming the camera B coordinate system (Σ_{CB}) of the robot B 120 into the robot B coordinate system (Σ_{RB}), and outputs the coordinate transformation matrix (^{RB}T_{CB}) to the relative position calculation unit 32 of the calibration execution device 30.

The online calibration execution unit 37 of the calibration execution device 30 calculates a coordinate transformation matrix (^{RA}T_{XA}) of each of the sensors (AX) mounted to the robot A 110.

The processing of calculating the coordinate transformation matrix corresponding to the sensor (^{RA}T_{XA}) is similar to the processing of the first embodiment described above.

The relative position calculation unit 32 receives each of pieces of data below.
(1) Coordinate transformation matrix (^{O}T_{RA}) from self-position estimation unit 116 of robot A 110, that is, coordinate transformation matrix (^{O}T_{RA}) for transforming robot A coordinate system (Σ_{RA}) into map coordinate system (Σ_{O}).
(2) Coordinate transformation matrix (^{O}T_{RB}) from self-position estimation unit 123 of robot B 120, that is, coordinate transformation matrix (^{O}T_{RB}) for transforming robot B coordinate system (Σ_{RB}) into map coordinate system (Σ_{O}).
(3) Coordinate transformation matrix (^{RB}T_{CB}) from sensor coordinate transformation matrix DB (database) 124 of robot B 120, that is, coordinate transformation matrix (^{RB}T_{CB}) for transforming camera B coordinate system (Σ_{CB}) of robot B 120 into robot B coordinate system (Σ_{RB}).

The relative position calculation unit 32 inputs each of pieces of data and calculates a coordinate transformation matrix (^{CB}T_{XA}) for transforming the sensor coordinate system (Σ_{XA}) of the robot A into the camera B coordinate system (Σ_{CB}) of the robot B.

The calculation processing of the coordinate transformation matrix (^{CB}T_{XA}) is executed according to (Equation 10) described above.

The coordinate transformation matrix (^{CB}T_{XA}) calculated by the relative position calculation unit 32, that is, the coordinate transformation matrix (^{CB}T_{XA}) for transforming the sensor coordinate system (Σ_{XA}) of the robot A into the camera B coordinate system (Σ_{CB}) of the robot B is input to the external coordinate-system corresponding coordinate transformation matrix calculation unit 33.

Next, processing executed by the external coordinate-system corresponding coordinate transformation matrix calculation unit 33 in the calibration execution device 30 shown in FIG. 31 will be described.

The external coordinate-system corresponding coordinate transformation matrix calculation unit 33 receives, from the online calibration execution unit 37, the coordinate transformation matrix (^{RA}T_{XA}) for transforming the sensor coordinate system (Σ_{XA}) of each sensor (XA) of the robot A 110 into the robot A coordinate system (Σ_{RA}).

Furthermore, the external coordinate-system corresponding coordinate transformation matrix calculation unit 33 receives, from the relative position calculation unit 32, the coordinate transformation matrix (^{CB}T_{XA}) for transforming the sensor coordinate system (Σ_{XA}) of each sensor (XA) of the robot A 110 into the camera B coordinate system (Σ_{CB}) of the robot B 120.

The external coordinate-system corresponding coordinate transformation matrix calculation unit 33 inputs the plurality of coordinate transformation matrices, and calculates a coordinate transformation matrix (^{CB}T_{RA}) for transforming the robot coordinate system (Σ_{RA}) of the robot A 110 into the camera B coordinate system (Σ_{CB}) of the robot B 120.

Note that the coordinate transformation matrix (^{CB}T_{RA}) for transforming the robot coordinate system (Σ_{RA}) of the robot A 110 into the camera B coordinate system (ECB) of the robot B 120 can be calculated according to (Equation 12) below.

$${{(}^{C B} {T}_{RA} ) = {(}^{C B} {T}_{XA} ) {(}^{RA} {T}_{XA} )}^{- 1} \qquad ( Equation 12 )$$

All of the coordinate transformation matrices shown on the right side of (Equation 12) above can be calculated on the basis of an input value from the relative position calculation unit 32 or the online calibration execution unit 37 or an input value.

As described above, the external coordinate-system corresponding coordinate transformation matrix calculation unit 33 calculates the coordinate transformation matrix (^{CB}T_{RA}) for transforming the robot coordinate system (Σ_{RA}) of the robot A 110 into the camera B coordinate system (Σ_{CB}) of the robot B 120 using the relative position calculation unit 32 or the online calibration execution unit 37 or a matrix that can be calculated on the basis of the input value.

The coordinate transformation matrix (^{CB}T_{RA}) calculated by the external coordinate-system corresponding coordinate transformation matrix calculation unit 33, that is, the coordinate transformation matrix (^{CB}T_{RA}) for transforming the robot coordinate system (Σ_{RA}) of the robot A 110 into the camera B coordinate system (Σ_{CB}) of the robot B 120 is input to the display information generation unit (visualized data generation unit) 34 of the calibration execution device 30 shown in FIG. 31.

On the basis of the coordinate transformation matrix (^{CB}T_{RA}) calculated by the external coordinate-system corresponding coordinate transformation matrix calculation unit 33, that is, the coordinate transformation matrix (^{CB}T_{RA}) for transforming the robot coordinate system (Σ_{RA}) of the robot A 110 into the camera B coordinate system (Σ_{CB}) of the robot B 120, the display information generation unit (visualized data generation unit) 34 generates a three-dimensional image in which coordinate axes (X axis, Y axis, Z axis) constituting the coordinate system (Σ_{XA}) of each sensor of the robot A 110 are shown on the camera B coordinate system (Σ_{CB}) of the robot B 120, and outputs the three-dimensional image to the display unit 36 together with the (color) image of the robot A 110.

Note that the input unit 35 includes a mouse, a keyboard, and the like, and receives a movement instruction including position and direction information to the robot B 120.

The robot B 120 determines the position and direction of the viewpoint on the basis of the viewpoint information input from the input unit 35, moves in the determined position and direction of the viewpoint, and outputs (color) image data of the robot B 120 to the display unit 36.

Specifically, the viewpoint direction of the (color) camera 121 is changed by moving the robot B 120 according to the viewpoint position and direction given from the input unit 35, and a three-dimensional image in which the coordinate system EXA of each sensor of the robot A 110 is displayed on the (color) image data observed therefrom is displayed on the display unit 36 in a superimposed manner.

The three-dimensional image data of the robot A 110 generated by the display information generation unit (visualized data generation unit) 34 and output to the display unit 36 is a three-dimensional image shown on the camera B coordinate system (Σ_{CB}) of the robot B 120, and is an image in which coordinate axes (X axis, Y axis, Z axis) constituting the coordinate system (Σ_{XA}) of each sensor of the robot A 110 are displayed in a superimposed manner together with the (color) image of the robot A 110.

The display image is an image similar to the images shown in FIGS. 17 to 19 described above in the first embodiment.

Also in Processing Example 2 of the present third embodiment, the display unit 36 of the calibration execution device 30 displays an image in which the coordinate system (Σ_{XA}) corresponding to each sensor on the camera B coordinate system (Σ_{CB}) of the robot B 120 is displayed in a superimposed manner together with the (color) image of the robot A 110 shown on the camera B coordinate system (Σ_{CB}) of the robot B 120.

The user confirms the origin position of the coordinate system (Σ_{XA}) of each of the sensors displayed together with the (color) image of the robot A 110 and the direction (inclination) of the seating axis, so that the user can determine whether or not the calibration processing in the online calibration execution unit 37, that is, the calculation processing of the sensor-corresponding mark transformation matrix (^{RA}T_{XA}) has succeeded.

### 5. (Fourth Embodiment) Embodiment of Executing Calibration of Plurality of Fixed Cameras

Next, as a fourth embodiment, an embodiment in which calibration of a plurality of fixed cameras is executed will be described.

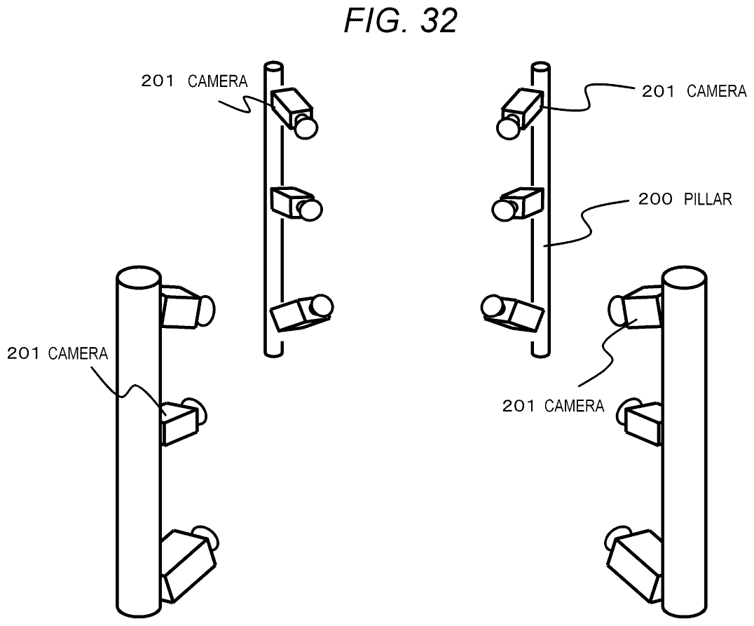

The present fourth embodiment is an embodiment in which, for example, as shown in FIG. 32, in a configuration in which a plurality of cameras is fixed, calibration processing of these fixed cameras is performed.

The example shown in FIG. 32 is a configuration including a plurality of pillars 200 on which a plurality of cameras 201 is mounted. Typical examples of applications using such a plurality of cameras include volumetric capture processing for simultaneously acquiring a three-dimensional shape and a surface color of an object, three-dimensional measurement processing of a joint position of a person, and the like.

In these various processing, in order to acquire the three-dimensional information with sufficient accuracy, it is necessary that the optical axis directions of the plurality of cameras face a prescribed direction. For this purpose, it is necessary to confirm the setting state of each camera coordinate system using a certain reference coordinate system. For this purpose, it is necessary to perform calibration processing for generating a highly accurate coordinate transformation matrix for transforming each camera coordinate system into one reference coordinate system.

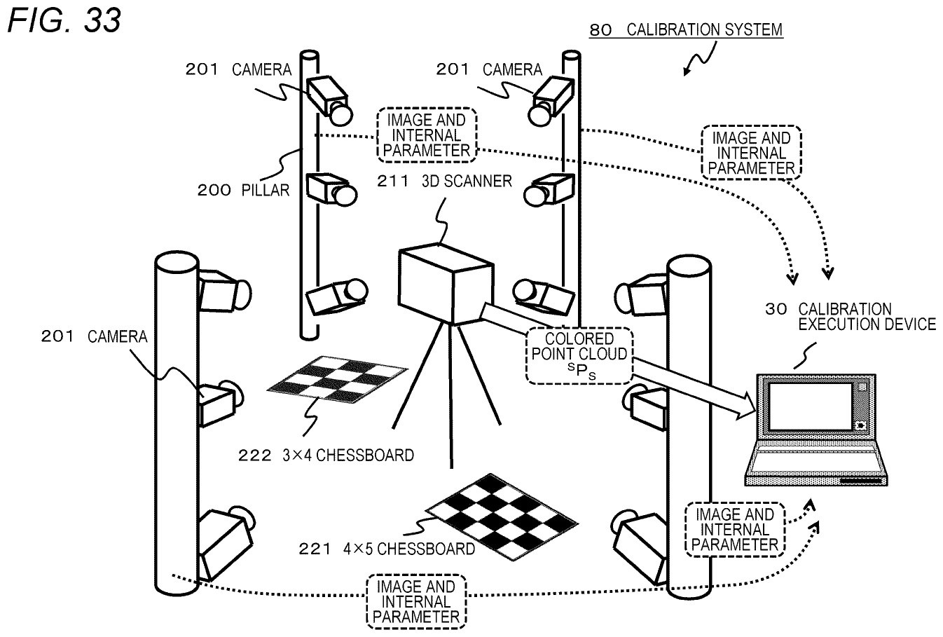

FIG. 33 shows an example of a calibration system 80 of the present fourth embodiment.

As shown in FIG. 33, the calibration system 80 includes the plurality of cameras 201 to be calibrated, a 3D scanner 211, and a calibration execution device 30 that executes calibration processing.

Further, chessboards 221 and 222 that can be imaged by the plurality of cameras 201 are attached to the floor surface.

The chessboards 221 and 222 are configured by a regular black-and-white pattern.

Images and internal parameters of the plurality of cameras 201 are transmitted to the calibration execution device 30.

Colored point cloud information (SPs) that is detection data of the 3D scanner 211 is also transmitted to the calibration execution device 30.

The calibration execution device 30 executes the calibration processing for each of the plurality of cameras 201 using these input data. Specifically, processing of calculating the coordinate transformation matrix of each of the plurality of cameras 201 is executed. The coordinate transformation matrix to be calculated is a coordinate transformation matrix for transforming the coordinate system of each camera into a calibration coordinate system that is one reference coordinate system.

The calibration execution device 30 further generates display data, which is visualized data for calibration result confirmation enabling visual confirmation as to whether or not the coordinate transformation matrix calculated as the calibration result has been correctly calculated, and outputs the display data to the display unit.

The visualized data for calibration result confirmation is image data that enables confirmation as to whether or not the coordinate transformation matrix corresponding to each camera has been correctly calculated. A specific example of the image data will be described later.

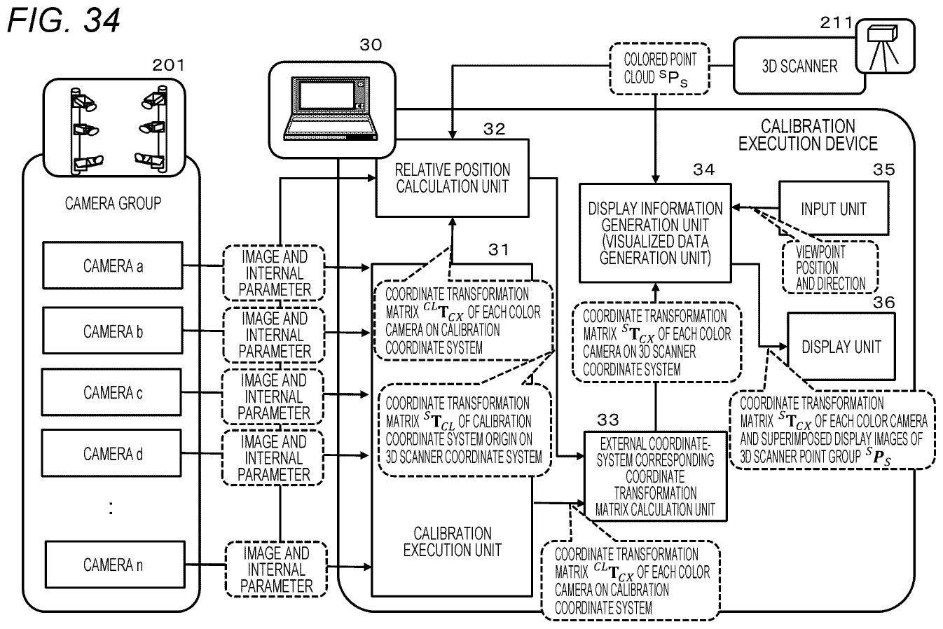

A detailed configuration of the calibration execution device 30 of the present fourth embodiment will be described with reference to FIG. 34.

FIG. 34 shows a detailed configuration of the calibration execution device 30 and data input from the camera 201 and the 3D scanner 211 by the calibration execution device 30. The camera 201 is configured by a plurality of cameras a to n.

As shown in FIG. 34, the calibration execution device 30 includes a calibration execution unit 31, a relative position calculation unit 32, an external coordinate-system corresponding coordinate transformation matrix calculation unit 33, a display information generation unit (visualized data generation unit) 34, an input unit 35, and a display unit 36.

The calibration execution device 30 of the fourth embodiment has a configuration similar to the calibration execution device 30 described above with reference to FIG. 12 in the first embodiment.

The calibration execution unit 31 of the calibration execution device 30 calculates a coordinate transformation matrix of each of the plurality of cameras (cameras a to n).

The calibration execution unit 31 inputs the photographed image and the internal parameter of each camera from the plurality of cameras (cameras a to n), and executes the calculation processing of the coordinate transformation matrix corresponding to each camera.

Specifically, a camera-corresponding coordinate transformation matrix (^{CL}T_{CX}) for transforming the camera coordinate system (Σ_{Cx}) of each camera into a calibration coordinate system (Σ_{CL}) that is a predefined reference coordinate system is calculated. Note that x of cx indicated in the camera coordinate system (Σ_{Cx}) and the camera-corresponding coordinate transformation matrix (^{CL}T_{Cx}) is the camera identifiers=a to n, ca represents the camera a, cb represents the camera b, and cn represents the camera cn.

The camera-corresponding coordinate transformation matrix (^{CL}T_{Cx}) calculated by the calibration execution unit 31 is output to the relative position calculation unit 32 and the external coordinate-system corresponding coordinate transformation matrix calculation unit 33.

The relative position calculation unit 32 executes alignment processing between the scanner coordinate system (Σ_{S}) of the 3D scanner 211 and the calibration coordinate system (Σ_{CL}) that is the reference coordinate system used by the calibration execution unit 31 to calculate a coordinate transformation matrix (^{S}T_{CL}) for transforming the calibration coordinate system (Σ_{CL}) into the scanner coordinate system (Σ_{S}).

The coordinate transformation matrix (^{S}T_{CL}) calculated by the relative position calculation unit 32 is input to the external coordinate-system corresponding coordinate transformation matrix calculation unit 33.

Next, processing executed by the external coordinate-system corresponding coordinate transformation matrix calculation unit 33 in the calibration execution device 30 shown in FIG. 34 will be described.

The external coordinate-system corresponding coordinate transformation matrix calculation unit 33 receives the following coordinate transformation matrix from the calibration execution unit 31.
(a) Camera-corresponding coordinate transformation matrix (^{CL}T_{CX}) for transforming camera coordinate system (Σ_{Cx}) of each of cameras a to n into calibration coordinate system (Σ_{CL}) that is predefined reference coordinate system.

The external coordinate-system corresponding coordinate transformation matrix calculation unit 33 further receives the following coordinate transformation matrix from the relative position calculation unit 32.
(b) Coordinate transformation matrix (^{S}T_{CL}) for transforming calibration coordinate system (Σ_{CL}) into scanner coordinate system (Σ_{S}).

The external coordinate-system corresponding coordinate transformation matrix calculation unit 33 inputs the plurality of coordinate transformation matrices, and calculates a coordinate transformation matrix (^{S}T_{CX}) for transforming the coordinate system (Σ_{Cx}) of each of the cameras a to n into the scanner coordinate system (Σ_{S}).

Note that the coordinate transformation matrix (^{S}T_{CX}) for transforming the coordinate system (Σ_{Cx}) of each of the cameras a to n into the scanner coordinate system (Σ_{S}) can be calculated according to (Equation 13) below.

$${}_{}^{S} {T}_{CX}^{} = ( {}_{}^{S} {T}_{CL}^{} ) ( {}_{}^{CL} {T}_{CX}^{} ) \qquad ( Equation 13 )$$

The coordinate transformation matrix shown on the right side of (Equation 13) above is an input value from the relative position calculation unit 32 and the calibration execution unit 31.

As described above, the external coordinate-system corresponding coordinate transformation matrix calculation unit 33 calculates the coordinate transformation matrix (^{S}T_{CX}) for transforming the coordinate system (Σ_{Cx}) of each of the cameras a to n into the scanner coordinate system (Σ_{S}) on the basis of the input values from the relative position calculation unit 32 and the calibration execution unit 31.

The coordinate transformation matrix (^{S}T_{CX}) calculated by the external coordinate-system corresponding coordinate transformation matrix calculation unit 33, that is, the coordinate transformation matrix (^{S}T_{CX}) for transforming the coordinate system (Σ_{CX}) of each of the cameras a to n into the scanner coordinate system (Σ_{S}) is input to the display information generation unit (visualized data generation unit) 34 of the calibration execution device 30 shown in FIG. 34.

These coordinate transformation matrices (^{S}T_{CX}) calculated by the external coordinate-system corresponding coordinate transformation matrix calculation unit 33 are input to the display information generation unit (visualized data generation unit) 34 of the calibration execution device 30 shown in FIG. 34.

On the basis of the coordinate transformation matrix (^{S}T_{CX}) calculated by the external coordinate-system corresponding coordinate transformation matrix calculation unit 33, the display information generation unit (visualized data generation unit) 34 generates a three-dimensional image showing coordinate axes (X axis, Y axis, Z axis) constituting the coordinate system (Σ_{CX}) of each of the cameras a to n on the scanner coordinate system (Σ_{S}), and outputs the three-dimensional image to the display unit 36 together with the three-dimensional images of the cameras a to n.

Note that the input unit 35 includes a mouse, a keyboard, and the like, and receives viewpoint information of a three-dimensional image drawn on the display unit 36 by the display information generation unit (visualized) data generation unit 34.

The display information generation unit (visualized data generation unit) 34 determines a viewpoint direction on the basis of the viewpoint information input from the input unit 35, and outputs three-dimensional image data of each of the cameras a to n observed from the determined viewpoint direction to the display unit 36.

The three-dimensional image data of each of the cameras a to n generated by the display information generation unit (visualized data generation unit) 34 and output to the display unit 36 is a three-dimensional image shown on the scanner coordinate system (Σ_{S}), and is an image in which coordinate axes (X axis, Y axis, Z axis) constituting the coordinate system (Σ_{CX}) of each of the cameras a to n are displayed in a superimposed manner together with the three-dimensional images of the cameras a to n.

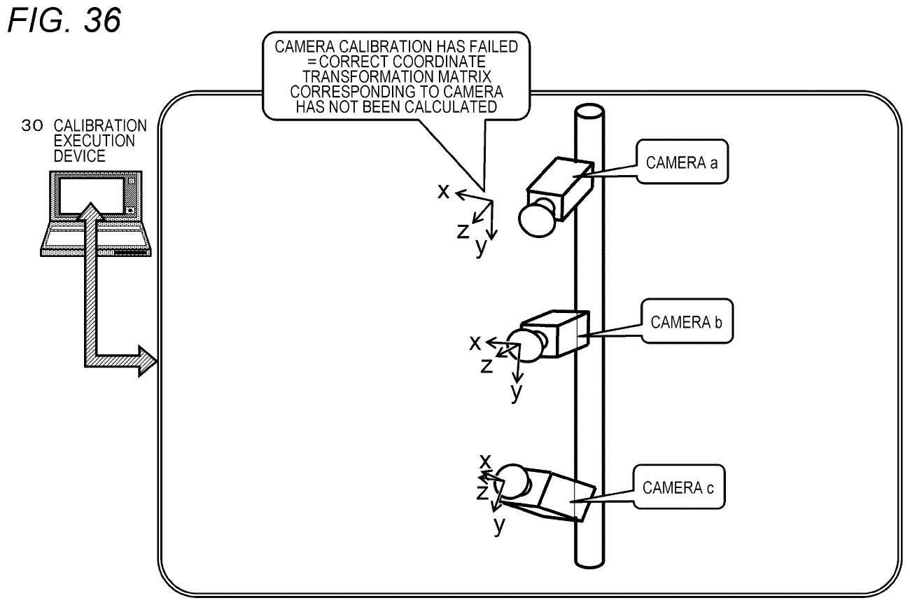

An example of the display image is shown in FIG. 36.

As shown in FIG. 36, in addition to the three-dimensional image data of each of the cameras a to n, superimposed display images of coordinate axes (X axis, Y axis, Z axis) constituting the coordinate system (Σ_{CX}) of each of the cameras a to n are output to the display unit 36 of the calibration execution device 30.

Note that, in the example of the display data shown in FIG. 36, in all the coordinate systems (Σ_{CX}) of the cameras a to n, the lens of each camera is set as the origin, the optical axis direction in front of the camera is set as the Z axis, the Y axis is set in the downward direction perpendicular to the Z axis, and the X axis is set in the orthogonal right direction of the Z axis. This means that the calibration execution unit 31 has calculated a correct camera-corresponding coordinate transformation matrix (^{CL}T_{CX}).

That is, the display data enables the calibration execution unit 31 to confirm that the camera-corresponding coordinate transformation matrix (^{CL}T_{CX}) for transforming the camera coordinate system (Σ_{CX}) of each camera into the calibration coordinate system (Σ_{CL}), which is a predefined reference coordinate system, has been calculated correctly.

Note that, as described above with reference to FIG. 17 in the first embodiment, for the coordinate axes (X axis, Y axis, Z axis) constituting the camera coordinate system (Σ_{CX}), for example, identifiers indicating the types of axes such as “X axis”, “Y axis”, and “Z axis” may be displayed together in association with the respective axes. Furthermore, in order to make it easier to understand, a configuration in which different colors are set and displayed on each axis may be employed. For example, the X axis may be displayed in red, the Y axis may be displayed in green, and the Z axis may be displayed in blue.

FIG. 36 shows an example of display data in a case where a correct camera-corresponding coordinate transformation matrix (^{CL}T_{CX}) has not been calculated in the calibration execution unit 31.

In the display data shown in FIG. 36, the origin of the camera coordinate system (Σ_{Ca}) of the camera a is set at a position away from the lens position of the camera a.

This means that the correct camera-corresponding coordinate transformation matrix (^{CL}T_{Ca}) of the camera a is not calculated in the calibration execution unit 31.

In this manner, the user confirms the origin position of each camera coordinate system (Σ_{CX}) and the direction (inclination) of the seating axis displayed together with the three-dimensional images of the cameras a to n, so that the user can determine whether or not the calibration processing in the calibration execution unit 31, that is, the calculation processing of the camera-corresponding coordinate transformation matrix (^{CL}T_{CX}) has succeeded.

### 6. Hardware Configuration Example of Calibration Execution Device

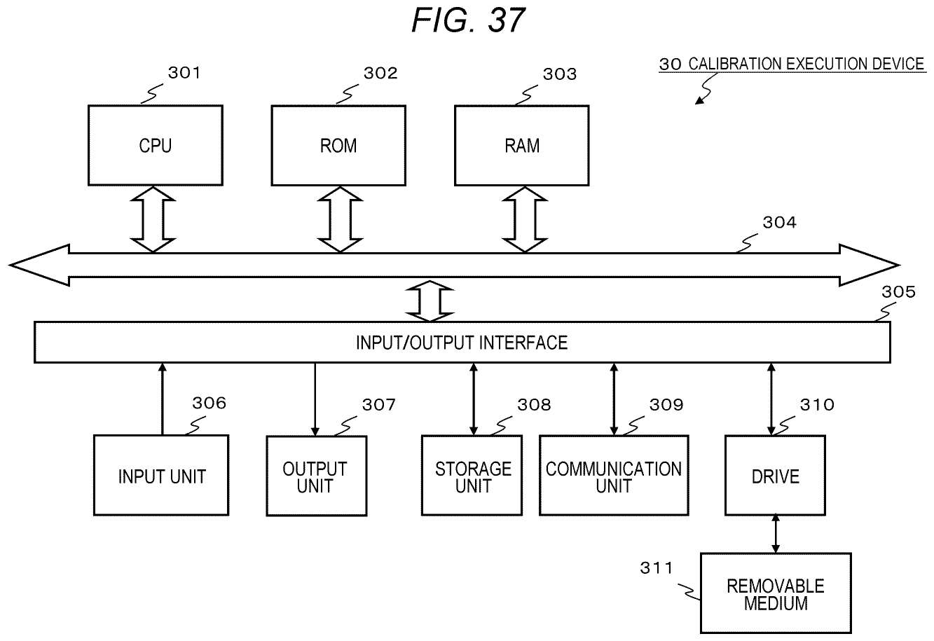

Next, a hardware configuration example of the calibration execution device 30 of the present disclosure will be described with reference to FIG. 37.

Note that, as described above, the calibration execution device 30 can be configured as an independent device different from the robot 10, or may be configured integrally with the robot 10.

A configuration example of the calibration execution device 30 will be described with reference to FIG. 37.

A central processing unit (CPU) 301 functions as a data processing unit that executes various types of processing in accordance with a program stored in a read only memory (ROM) 302 or a storage unit 308. For example, the CPU 301 executes the processing according to the sequence described in the above-described embodiment. A random access memory (RAM) 303 stores programs, data, or the like to be performed by the CPU 301. The CPU 301, the ROM 302, and the RAM 303 are connected to one another by a bus 304.

The CPU301 is connected to an input/output interface 305 via the bus 304, and an input unit 306 including various switches, a keyboard, a touch panel, a mouse, a microphone, a user input unit, a camera, a detection data acquisition unit of various sensors such as LiDAR GPS, and the like, and an output unit 307 including a display, a speaker, and the like are connected to the input/output interface 305.

The CPU 301 inputs commands, status data, and the like input from the input unit 306, executes various types of processing, and outputs processing results to, for example, the output unit 307.

The storage unit 308 connected to the input/output interface 305 includes, for example, a hard disk, or the like and stores programs executed by the CPU 301 and various types of data. A communication unit 309 functions as a transmitter and receiver for data communication via a network such as the Internet or a local area network, and communicates with an external device.

A drive 310 connected to the input/output interface 305 drives a removable medium 311 such as a magnetic disk, an optical disk, a magneto-optical disk, or a semiconductor memory such as a memory card, and records or reads data.

### 7. Summary of Configurations of the Present Disclosure

The embodiments of the present disclosure have been described above in detail with reference to specific embodiments. However, it is obvious that those skilled in the art can modify or substitute the embodiment without departing from the gist of the present disclosure. That is, the present invention has been disclosed in the form of exemplification, and should not be interpreted in a limited manner. In order to determine the gist of the present disclosure, the claims should be considered.

Note that the technology disclosed herein can have the following configurations.
(1) A calibration execution device including:
a calibration execution unit that executes calibration processing of a sensor; and
a display information generation unit that generates image data capable of confirming whether or not the calibration processing in the calibration execution unit has succeeded, in which
the calibration execution unit executes, as the calibration processing, processing of calculating a coordinate transformation matrix for transforming a sensor coordinate system corresponding to a sensor into another second coordinate system, and
the display information generation unit generates image data capable of visually confirming whether or not the coordinate transformation matrix calculated by the calibration execution unit is a correct coordinate transformation matrix.
(2) The calibration execution device according to (1), in which the second coordinate system is a mobile device coordinate system corresponding to a mobile device equipped with the sensor.
(3) The calibration execution device according to (1) or (2), in which the image data generated by the display information generation unit is image data in which an origin and coordinate axes constituting the sensor coordinate system are displayed in a superimposed manner on a three-dimensional image of the sensor.
(4) The calibration execution device according to any one of (1) to (3), in which the image data generated by the display information generation unit is image data in which an origin and coordinate axes constituting the sensor coordinate system are displayed in a superimposed manner on a three-dimensional image of a mobile device to which the sensor is mounted.
(5) The calibration execution device according to any one of (1) to (4), in which the image data generated by the display information generation unit is image data in which both an origin position and a coordinate axis direction of a sensor coordinate system with respect to a sensor image in the image data coincide with an original sensor coordinate system in a case where the coordinate transformation matrix calculated by the calibration execution unit is correct, and image data in which at least either the origin position or the coordinate axis direction of the sensor coordinate system with respect to the sensor image in the image data does not coincide with the original sensor coordinate system in a case where the coordinate transformation matrix calculated by the calibration execution unit is incorrect.
(6) The calibration execution device according to any one of (1) to (5), in which the image data generated by the display information generation unit is image data in which a three-dimensional image of the sensor or a three-dimensional image of a mobile device equipped with the sensor is drawn on an external coordinate system different from both the sensor coordinate system and the second coordinate system.
(7) The calibration execution device according to any one of (1) to (6), further including an external coordinate-system corresponding coordinate transformation matrix calculation unit that transforms the sensor coordinate system into an external coordinate system different from both the sensor coordinate system and the second coordinate system.
(8) The calibration execution device according to (7), in which the external coordinate-system corresponding coordinate transformation matrix calculation unit inputs a coordinate transformation matrix for transforming the sensor coordinate system generated by the calibration execution unit into a second coordinate system, and transforms the sensor coordinate system into the external coordinate system using the coordinate transformation matrix.
(9) The calibration execution device according to (7) or (8), in which
the calibration execution device includes an external device that generates an image on the external coordinate system or point cloud information, and
the display information generation unit generates the image data by inputting the image on the external coordinate system or the point cloud information from the external device.
(10) The calibration execution device according to (9), in which the external device is a device that generates an image of the sensor or a mobile device equipped with the sensor, or point cloud information.
(11) The calibration execution device according to (9) or (10), in which the external device is a 3D scanner, a camera, or a depth camera.
(12) The calibration execution device according to any one of (6) to (11), further including a relative position calculation unit that calculates a coordinate transformation matrix for transforming the second coordinate system into the external coordinate system.
(13) The calibration execution device according to (12), in which the external coordinate-system corresponding coordinate transformation matrix calculation unit inputs:
a coordinate transformation matrix for transforming the sensor coordinate system corresponding to the sensor generated by the calibration execution unit into a second coordinate system; and
a coordinate transformation matrix for transforming the second coordinate system calculated by the relative position calculation unit into the external coordinate system, and
calculates a coordinate transformation matrix for transforming the sensor coordinate system into the external coordinate system using the two input coordinate transformation matrices.
(14) The calibration execution device according to (13), in which the display information generation unit generates image data in which coordinate axes constituting the sensor coordinate system are displayed in a superimposed manner on a three-dimensional image of the sensor or a three-dimensional image of a mobile device to which the sensor is mounted, using a coordinate transformation for transforming the sensor coordinate system calculated by the external coordinate-system corresponding coordinate transformation matrix calculation unit into the external coordinate system.
(15) The calibration execution device according to any one of (1) to (14), in which the image data generated by the display information generation unit is image data in which axes of coordinate axes constituting the sensor coordinate system are displayed in a superimposed manner as coordinate axes of different colors on a three-dimensional image of the sensor.
(16) The calibration execution device according to any one of (1) to (15), in which the calibration execution unit executes online calibration processing of sequentially calculating the coordinate transformation matrix.
(17) A calibration system including: a mobile device equipped with a sensor; and a calibration execution device, in which
the calibration execution device inputs sensor detection information from the mobile device, calculates a coordinate transformation matrix for transforming a sensor coordinate system corresponding to a sensor into another second coordinate system, and outputs the calculated coordinate transformation matrix to the mobile device,
the mobile device executes autonomous movement to which the coordinate transformation matrix input from the calibration execution device is applied, and
the calibration execution device further includes a display information generation unit that generates image data capable of confirming whether or not the coordinate transformation matrix has been correctly calculated.
(18) A calibration execution method executed by a calibration execution device, the calibration execution method including:
a calibration execution step of, by a calibration execution unit, inputting detection information of a sensor and calculating a coordinate transformation matrix for transforming a sensor coordinate system corresponding to the sensor into another second coordinate system; and
an image data generation step of, by a display information generation unit, generating image data with which it is possible to visually confirm whether or not the coordinate transformation matrix calculated in the calibration execution step is a correct coordinate transformation matrix.
(19) A calibration execution method executed in a calibration system including a mobile device equipped with a sensor and a calibration execution device, in which
the calibration execution device executes a coordinate transformation matrix generation step of inputting sensor detection information from the mobile device, calculating a coordinate transformation matrix for transforming a sensor coordinate system corresponding to the sensor into another second coordinate system, and outputting the calculated coordinate transformation matrix to the mobile device,
the mobile device executes an autonomous movement execution step of executing autonomous movement to which the coordinate transformation matrix input from the calibration execution device is applied, and
the calibration execution device further executes a display information generation step of generating image data capable of confirming whether or not the coordinate transformation matrix has been correctly calculated in the coordinate transformation matrix generation step.
(20) A program for causing a calibration execution device to execute calibration, the program causing:
a calibration execution unit to execute calibration processing for inputting detection information of a sensor and calculating a coordinate transformation matrix for transforming a sensor coordinate system corresponding to the sensor into another second coordinate system; and
a display information generation unit to generate image data capable of visually confirming whether or not the coordinate transformation matrix is a correct coordinate transformation matrix.

Note that a series of processing herein described can be executed by hardware, software, or a combined configuration of the both. In a case where processing by software is executed, a program in which a processing sequence is recorded can be installed and performed in a memory in a computer incorporated in dedicated hardware, or the program can be installed and performed in a general-purpose computer capable of executing various types of processing. For example, the program can be recorded in advance in a recording medium. In addition to being installed into a computer from a recording medium, the program can be received via a network such as a local area network (LAN) or the Internet, and installed into a recording medium such as an internal hard disk or the like.

Furthermore, the various types of processing herein described may be performed not only in time series as described, but also in parallel or individually in accordance with the processing capability of the device that performs the processing or as necessary. Furthermore, a system in the present specification is a logical assembly of a plurality of devices, and is not limited to a system in which devices of the respective configurations are in the same housing.

### INDUSTRIAL APPLICABILITY

As described above, according to the configuration of an embodiment of the present disclosure, a configuration of generating and displaying an image that allows visual confirmation as to whether or not the coordinate transformation matrix calculated in the sensor calibration is correct is realized.

Specifically, for example, a calibration execution unit that executes calibration of a sensor, and a display information generation unit that generates image data capable of confirming whether or not calibration processing in the calibration execution unit has succeeded are included. The calibration execution unit calculates a coordinate transformation for transforming a sensor coordinate system corresponding to the sensor into another second coordinate system, and the display information generation unit generates and displays image data capable of visually confirming whether or not the calculated coordinate transformation matrix is a correct coordinate transformation matrix, for example, image data in which an origin and coordinate axes constituting the sensor coordinate system are displayed in a superimposed manner on a three-dimensional image of the sensor.

With this configuration, the configuration is realized in which an image capable of visually confirming whether or not a coordinate transformation matrix calculated in sensor calibration is correct is generated and displayed.

### REFERENCE SIGNS LIST

10 Robot
11 Camera
12 Depth camera
13 LiDAR
14 IMU
20 3D scanner
30 Calibration execution device
31 Calibration execution unit
32 Relative position calculation unit
33 External coordinate-system corresponding coordinate transformation matrix calculation unit
34 Display information generation unit (visualized data generation unit)
35 Input unit
36 Display unit
37 Online calibration execution unit
40 Fixed depth camera
50 Calibration system
60 Online calibration system
100 Robot
101 Camera
102 Depth camera
103 LiDAR
104 IMU
110 Robot A
111 Camera A
112 Depth camera A
113 LiDAR
114 IMU
115 Wheel odometry
116 Self-position estimation unit
120 Robot B
121 Camera B
122 Depth camera B
123 Self-position estimation unit
124 Sensor coordinate transformation matrix DB
200 Pillar
201 Camera
211 3D scanner
301 CPU
302 ROM
303 RAM
304 Bus
305 Input/output interface
306 Input unit
307 Output unit
308 Storage unit
309 Communication unit
310 Drive
311 Removable medium

1. A calibration execution device comprising:
a calibration execution unit that executes calibration processing of a sensor; and
a display information generation unit that generates image data capable of confirming whether or not the calibration processing in the calibration execution unit has succeeded, wherein
the calibration execution unit executes, as the calibration processing, processing of calculating a coordinate transformation matrix for transforming a sensor coordinate system corresponding to a sensor into another second coordinate system, and
the display information generation unit generates image data capable of visually confirming whether or not the coordinate transformation matrix calculated by the calibration execution unit is a correct coordinate transformation matrix.

2. The calibration execution device according to claim 1, wherein the second coordinate system is a mobile device coordinate system corresponding to a mobile device equipped with the sensor.

3. The calibration execution device according to claim 1, wherein the image data generated by the display information generation unit is image data in which an origin and coordinate axes constituting the sensor coordinate system are displayed in a superimposed manner on a three-dimensional image of the sensor.

4. The calibration execution device according to claim 1, wherein the image data generated by the display information generation unit is image data in which an origin and coordinate axes constituting the sensor coordinate system are displayed in a superimposed manner on a three-dimensional image of a mobile device to which the sensor is mounted.

5. The calibration execution device according to claim 1, wherein the image data generated by the display information generation unit is image data in which both an origin position and a coordinate axis direction of a sensor coordinate system with respect to a sensor image in the image data coincide with an original sensor coordinate system in a case where the coordinate transformation matrix calculated by the calibration execution unit is correct, and image data in which at least either the origin position or the coordinate axis direction of the sensor coordinate system with respect to the sensor image in the image data does not coincide with the original sensor coordinate system in a case where the coordinate transformation matrix calculated by the calibration execution unit is incorrect.

6. The calibration execution device according to claim 1, wherein the image data generated by the display information generation unit is image data in which a three-dimensional image of the sensor or a three-dimensional image of a mobile device equipped with the sensor is drawn on an external coordinate system different from both the sensor coordinate system and the second coordinate system.

7. The calibration execution device according to claim 1, further comprising an external coordinate-system corresponding coordinate transformation matrix calculation unit that transforms the sensor coordinate system into an external coordinate system different from both the sensor coordinate system and the second coordinate system.

8. The calibration execution device according to claim 7, wherein the external coordinate-system corresponding coordinate transformation matrix calculation unit inputs a coordinate transformation matrix for transforming the sensor coordinate system generated by the calibration execution unit into a second coordinate system, and transforms the sensor coordinate system into the external coordinate system using the coordinate transformation matrix.

9. The calibration execution device according to claim 7, wherein
the calibration execution device includes an external device that generates an image on the external coordinate system or point cloud information, and
the display information generation unit generates the image data by inputting the image on the external coordinate system or the point cloud information from the external device.

10. The calibration execution device according to claim 9, wherein the external device is a device that generates an image of the sensor or a mobile device equipped with the sensor, or point cloud information.

11. The calibration execution device according to claim 9, wherein the external device is a 3D scanner, a camera, or a depth camera.

12. The calibration execution device according to claim 6, further comprising a relative position calculation unit that calculates a coordinate transformation matrix for transforming the second coordinate system into the external coordinate system.

13. The calibration execution device according to claim 12, wherein the external coordinate-system corresponding coordinate transformation matrix calculation unit inputs:
a coordinate transformation matrix for transforming the sensor coordinate system corresponding to the sensor generated by the calibration execution unit into a second coordinate system; and
a coordinate transformation matrix for transforming the second coordinate system calculated by the relative position calculation unit into the external coordinate system, and
calculates a coordinate transformation matrix for transforming the sensor coordinate system into the external coordinate system using the two input coordinate transformation matrices.

14. The calibration execution device according to claim 13, wherein the display information generation unit generates image data in which coordinate axes constituting the sensor coordinate system are displayed in a superimposed manner on a three-dimensional image of the sensor or a three-dimensional image of a mobile device to which the sensor is mounted, using a coordinate transformation matrix for transforming the sensor coordinate system calculated by the external coordinate-system corresponding coordinate transformation matrix calculation unit into the external coordinate system.

15. The calibration execution device according to claim 1, wherein the image data generated by the display information generation unit is image data in which axes of coordinate axes constituting the sensor coordinate system are displayed in a superimposed manner as coordinate axes of different colors on a three-dimensional image of the sensor.

16. The calibration execution device according to claim 1, wherein the calibration execution unit executes online calibration processing of sequentially calculating the coordinate transformation matrix.

17. A calibration system comprising: a mobile device equipped with a sensor; and a calibration execution device, wherein
the calibration execution device inputs sensor detection information from the mobile device, calculates a coordinate transformation matrix for transforming a sensor coordinate system corresponding to a sensor into another second coordinate system, and outputs the calculated coordinate transformation matrix to the mobile device,
the mobile device executes autonomous movement to which the coordinate transformation matrix input from the calibration execution device is applied, and
the calibration execution device further includes a display information generation unit that generates image data capable of confirming whether or not the coordinate transformation matrix has been correctly calculated.

18. A calibration execution method executed by a calibration execution device, the calibration execution method comprising:
a calibration execution step of, by a calibration execution unit, inputting detection information of a sensor and calculating a coordinate transformation matrix for transforming a sensor coordinate system corresponding to the sensor into another second coordinate system; and
an image data generation step of, by a display information generation unit, generating image data with which it is possible to visually confirm whether or not the coordinate transformation matrix calculated in the calibration execution step is a correct coordinate transformation matrix.

19. A calibration execution method executed in a calibration system including a mobile device equipped with a sensor and a calibration execution device, wherein
the calibration execution device executes a coordinate transformation matrix generation step of inputting sensor detection information from the mobile device, calculating a coordinate transformation matrix for transforming a sensor coordinate system corresponding to the sensor into another second coordinate system, and outputting the calculated coordinate transformation matrix to the mobile device,
the mobile device executes an autonomous movement execution step of executing autonomous movement to which the coordinate transformation matrix input from the calibration execution device is applied, and
the calibration execution device further executes a display information generation step of generating image data capable of confirming whether or not the coordinate transformation matrix has been correctly calculated in the coordinate transformation matrix generation step.

20. A program for causing a calibration execution device to execute calibration, the program causing:
a calibration execution unit to execute calibration processing for inputting detection information of a sensor and calculating a coordinate transformation matrix for transforming a sensor coordinate system corresponding to the sensor into another second coordinate system; and
a display information generation unit to generate image data capable of visually confirming whether or not the coordinate transformation matrix is a correct coordinate transformation matrix.
